(19) United States
(12) Patent Application Publication
(10) Pub. No.: US 2025/0168041 A1
(43) Pub. Date: May 22, 2025

(54) METHODS AND APPARATUS FOR ENHANCEMENT OF SRS

(71) Applicant: Huawei Technologies Co., Ltd., Shenzhen (CN)

(72) Inventors: Jialing Liu, Palatine, IL (US); Qian Cheng, Naperville, IL (US); Weimin Xiao, Hoffman Estates, IL (US)

(21) Appl. No.: 19/029,494

(22) Filed: Jan. 17, 2025

Related U.S. Application Data
(63) Continuation of application No. PCT/US2023/030007, filed on Aug. 10, 2023.
(60) Provisional application No. 63/371,188, filed on Aug. 11, 2022.
(60) Provisional application No. 63/411,472, filed on Sep. 29, 2022.
(60) Provisional application No. 63/422,738, filed on Nov. 4, 2022.
(60) Provisional application No. 63/485,394, filed on Feb. 16, 2023.

(51) Int. Cl. H04L 25/02; H04L 27/26

(52) U.S. Cl. CPC H04L 25/0226; H04L 27/2605; H04L 27/261

(57) ABSTRACT

According to embodiments, a UE receives, from a network device, a configuration of a sounding reference signals (SRS) resource with 8 antenna ports, a transmission comb configuration for the SRS resource, and a cyclic shift (CS) configuration for the SRS resource. The transmission comb configuration indicates a comb value K. K is one of 2, 4, or 8. The transmission comb configuration further indicates a configured comb offset (k). k is an integer between 0 and K−1. The CS configuration indicates CS positions. The UE maps each port of the 8 antenna ports to corresponding resource elements (REs) in the frequency domain and a corresponding CS. The corresponding REs are a subset of a plurality of REs and on every K-th RE with an offset based on the configured comb offset (k) within an SRS transmission bandwidth. The UE transmits SRSs using the 8 antenna ports based on the mapping.

### PRIORITY CLAIM AND CROSS-REFERENCE

This patent application is a continuation of International Application No. PCT/US2023/030007 filed on Aug. 10, 2023 and entitled “Methods and Apparatus for Enhancements of SRS,” which claims the benefit of U.S. Provisional Application No. 63/485,394, filed on Feb. 16, 2023 and entitled “Methods and Apparatus for Advanced SRS Configurations and Operations,” U.S. Provisional Application 63/422,738, filed on Nov. 4, 2022 and entitled “Methods and Apparatus for Enhancements of SRS Interference Randomization in Frequency/Code Domains,” U.S. Provisional Application No. 63/411,472, filed on Sep. 29, 2022 and entitled “Methods and Apparatus for Enhancements of SRS Interference Randomization,” and U.S. Provisional Application No. 63/371,188, filed on Aug. 11, 2022 and entitled “Methods and Apparatus for Enhancements of SRS,” applications of which are hereby incorporated by reference herein as if reproduced in their entireties.

### TECHNICAL FIELD

The present disclosure relates generally to wireless communications, and, in particular embodiments, to methods and apparatus for resource configuration.

### BACKGROUND

Sounding reference signals (SRSs) are reference signals transmitted by user equipment (UE) in the uplink for the purpose of enabling uplink channel estimation over a wide bandwidth. As such, the network may be able to perform communication with the UEs based on the uplink channel estimation. Moreover, due to channel reciprocity between the uplink and the downlink present in a time division duplex (TDD) communication system, the network may utilize the SRSs to perform dynamic scheduling. That is, the network may exploit channel-dependent scheduling. In this case, the time-frequency resources are dynamically scheduled, taking into account the different traffic priorities and quality of services requirements. Typically, the UEs monitor several Physical Downlink Control Channels (PDCCHs) to acquire the scheduling decisions, which are signaled to the UEs by the network. Upon the detection of a valid PDCCH, the UE follows the scheduling decision and receives (or transmits) data.

### SUMMARY

Technical advantages are generally achieved, by embodiments of this disclosure which describe methods and apparatus for resource hopping.

According to embodiments, a network device configures for a first sounding reference signal (SRS) resource. The first SRS resource is associated with a first transmission parameter defined on a set of values. The network device configures for the first SRS resource, hopping of the first transmission parameter on a first subset of values of the set of values. The network device receives first SRSs on the first SRS resource. The first SRSs have the first transmission parameter hopping according to the first subset of values.

In some embodiments, the set of values includes a second subset of values for resource hopping for a second SRS resource. The network device may configure for the second SRS resource. The second SRS resource may be associated with a second transmission parameter defined on the set of values. The network device may configure for the second SRS resource, hopping of the second transmission parameter on second subset of values of the set of values. The network device may receive second SRSs on the second SRS resource. The second SRSs have the second transmission parameter hopping according to the second subset of values. The first SRS resource and the second SRS resource may at least partially overlap in the time domain or in the frequency domain.

In some embodiments, the resource hopping may include cyclic shift (CS) hopping. The first subset of values may be a first subset of a set of CS values for CS hopping. The second subset of values may be a second subset of the set of CS values for CS hopping.

In some embodiments, the resource hopping may include comb offset hopping. The first subset of values may be a first subset of a set of comb offset values for comb offset hopping. The second subset of values may be a second subset of the set of comb offset values for comb offset hopping. The first subset of values may include first comb offset values, and the second subset of values may include second comb offset values.

In some embodiments, the first SRS resource may be configured for a first user equipment (UE). The second SRS resource may be configured for a second UE different from the first UE.

In some embodiments, the resource hopping may include CS hopping. The first subset of values may be a first subset of a set of CS values for CS hopping.

In some embodiments, the resource hopping may include comb offset hopping. The first subset of values may be a first subset of a set of comb offset values for comb offset hopping.

In some embodiments, the first subset of values for the first SRSs may hop on the first subset of values on multiple SRS transmission occasions based on an SRS hopping randomization identifier (ID), a pseudo-random integer sequence on the multiple SRS transmission occasions, a configured first resource value, a number of values in the first subset of values, and a time-domain index for the multiple SRS transmission occasions.

In some embodiments, the first SRS resource may be configured with multiple ports. The multiple ports may perform hopping based on a same pseudo-random integer sequence on the multiple SRS transmission occasions. In each of the multiple SRS transmission occasions, a same pseudo-random integer value may be used for all the multiple ports.

In some embodiments, the time-domain index may be based on a system frame number (SFN), a slot number within the SFN, and an orthogonal frequency-division multiplexing (OFDM) symbol index within a slot.

In some embodiments, a first number of values in the first subset may be 1, or a second number of values in the second subset may be 1.

According to embodiments, a UE receives, from a network device, a first resource configuration. The first resource configuration configures a first sounding reference signal (SRS) resource. The first SRS resource is associated with a first transmission parameter defined on a set of values. The UE receives, from the network device, a first hopping configuration for the first SRS resource. The first hopping configuration configures hopping of the first transmission parameter on a first subset of values of the set of values. The UE transmits, to the network device, first SRSs on the first SRS resource. The first SRSs have the first transmission parameter hopping according to the first subset of values.

In some embodiments, the UE may receive, from the network device, a second resource configuration. The second resource configuration may configure the second SRS resource. The second SRS resource may be associated with a second transmission parameter defined on the set of values. The UE may receive, from the network device, a second hopping configuration for the second SRS resource. The second resource configuration configuring hopping of the second transmission parameter on second subset of values of the set of values. The UE may transmit, to the network device, second SRSs on the second SRS resource. The second SRSs may have the second transmission parameter hopping according to the second subset of values. The first SRS resource and the second SRS resource may at least partially overlap in the time domain or in the frequency domain.

In some embodiments, the resource hopping may include cyclic shift (CS) hopping. The first subset of values may be a first subset of a set of CS values for CS hopping. The second subset of values may be a second subset of the set of CS values for CS hopping.

In some embodiments, the resource hopping may include comb offset hopping. The first subset of values may be a first subset of a set of comb offset values for comb offset hopping. The second subset of values may be a second subset of the set of comb offset values for comb offset hopping. The first subset of values may include first comb offset values, and the second subset of values may include second comb offset values.

In some embodiments, the resource hopping may include CS hopping. The first subset of values may be a first subset of a set of CS values for CS hopping.

In some embodiments, the resource hopping may include comb offset hopping. The first subset of values may be a first subset of a set of comb offset values for comb offset hopping.

In some embodiments, the first subset of values for the first SRSs may hop on the first subset of values on multiple SRS transmission occasions based on an SRS hopping randomization identifier (ID), a pseudo-random integer sequence on the multiple SRS transmission occasions, a configured first resource value, a number of values in the first subset of values, and a time-domain index for the multiple SRS transmission occasions.

In some embodiments, the first SRS resource may be configured with multiple ports. The multiple ports may perform hopping based on a same pseudo-random integer sequence on the multiple SRS transmission occasions. In each of the multiple SRS transmission occasions, a same pseudo-random integer value may be used for all the multiple ports.

In some embodiments, the time-domain index may be based on a system frame number (SFN), a slot number within the SFN, and an orthogonal frequency-division multiplexing (OFDM) symbol index within a slot.

In some embodiments, a first number of values in the first subset may be 1, or a second number of values in the second subset may be 1.

According to embodiments, a UE receives, from a network device, a configuration of a sounding reference signals (SRS) resource with 8 antenna ports, a transmission comb configuration for the SRS resource, and a cyclic shift (CS) configuration for the SRS resource. The transmission comb configuration indicates a comb value K. K is one of 2, 4, or 8. The transmission comb configuration further indicates a configured comb offset (k). k is an integer between 0 and K−1. The CS configuration indicates CS positions. The UE maps each port of the 8 antenna ports to corresponding resource elements (REs) in the frequency domain and a corresponding CS. The corresponding REs are a subset of a plurality of REs and on every K-th RE with an offset based on the configured comb offset (k) within an SRS transmission bandwidth. The UE transmits, to the network device, SRSs using the 8 antenna ports based on the mapping.

In some embodiments, the plurality of REs may be in an orthogonal frequency division multiplexing (OFDM) symbol.

In some embodiments, the SRS resource may be for usage set to ‘codebook’ or ‘antennaSwitching’.

In some embodiments, the comb value K may be 2. The UE may map the 8 antenna ports on every K-th RE with the configured comb offset (k) within the SRS transmission bandwidth. Or, the UE may map a first antenna port, a third antenna port, a fifth antenna port, and a seventh antenna port of the 8 antenna ports on every K-th RE with the configured comb offset (k), and a second antenna port, a fourth antenna port, a sixth antenna port, and an eighth antenna port of the 8 antenna ports on every K-th RE with a comb offset (k+1)modulo K, within the SRS transmission bandwidth.

In some embodiments, the comb value K may be 4. The UE may map a first antenna port, a third antenna port, a fifth antenna port, and a seventh antenna port of the 8 antenna ports on every K-th RE with the configured comb offset (k), and a second antenna port, a fourth antenna port, a sixth antenna port, and an eighth antenna port of the 8 antenna ports on every K-th RE with a comb offset (k+2)modulo K, within the SRS transmission bandwidth.

In some embodiments, the comb value K may be 8. The UE may map a first antenna port and a fifth antenna port of the 8 antenna ports on every K-th RE with the configured comb offset (k), a second antenna port and a sixth antenna port of the 8 antenna ports on every K-th RE with a first comb offset (k+2)modulo K, a third antenna port and a seventh antenna port of the 8 antenna ports on every K-th RE with a second comb offset (k+4)modulo K, and a fourth antenna port and an eighth antenna port of the 8 antenna ports on every K-th RE with a third comb offset (k+6)modulo K.

According to embodiments, a UE receives, from a network device, a configuration of a sounding reference signals (SRS) resource with 8 antenna ports and with a time division multiplexing (TDM) parameter, a transmission comb configuration for the SRS resource, and a cyclic shift (CS) configuration for the SRS resource. The transmission comb configuration indicates a comb value K. K is one of 2, 4, or 8. The transmission comb configuration further indicates a comb offset k. k is an integer between 0 and K−1. The CS configuration indicates CS positions. The SRS resource is mapped to a number m of consecutive orthogonal frequency division multiplexing (OFDM) symbols within a same slot. m is greater than or equal to 1. The UE maps each OFDM symbol of the consecutive OFDM symbols to a corresponding subset of the 8 antenna ports based on m and s. s is determined based on the TDM parameter and is a number of subsets of the 8 antenna ports. The UE transmits, to the network device, SRSs using the 8 antenna ports based on the mapping.

In some embodiments, the UE may map an i-th subset of 8/s antenna ports of the 8 antenna ports to every s-th OFDM symbol within the consecutive OFDM symbols starting from an i-th OFDM symbol of the consecutive OFDM symbols. i is from 1 to s.

In some embodiments, SRS transmissions on the consecutive OFDM symbols may be mapped with a same comb offset allocation and same CS positions.

In some embodiments, SRS transmissions on the consecutive OFDM symbols may be mapped with a same physical resource block (PRB) allocation.

In some embodiments, SRS transmissions on the consecutive OFDM symbols may be periodic, semi-persistent, or aperiodic. The SRS transmissions may be based on an SRS counter determined by s*R. R is a configured repetition factor for the SRS resource.

In some embodiments, m may be a multiple of s.

According to embodiments, a network device transmits, to a user equipment (UE), a configuration of a sounding reference signals (SRS) resource with 8 antenna ports, a transmission comb configuration for the SRS resource, and a cyclic shift (CS) configuration for the SRS resource. The transmission comb configuration indicating a comb value K. K is one of 2, 4, or 8. The transmission comb configuration further indicates a configured comb offset (k). k is an integer between 0 and K−1. The CS configuration indicates CS positions. Each port of the 8 antenna ports is mapped to corresponding resource elements (REs) in the frequency domain and a corresponding CS. The corresponding REs are a subset of a plurality of REs and on every K-th RE with an offset based on the configured comb offset (k) within an SRS transmission bandwidth. The network device receives, from the UE, SRSs.

In some embodiments, the plurality of REs may be in an orthogonal frequency division multiplexing (OFDM) symbol.

In some embodiments, the SRS resource may be for usage set to ‘codebook’ or ‘antennaSwitching’.

In some embodiments, the comb value K is 2. the 8 antenna ports may be mapped on every K-th RE with the configured comb offset (k) within the SRS transmission bandwidth. Or, a first antenna port, a third antenna port, a fifth antenna port, and a seventh antenna port of the 8 antenna ports may be mapped on every K-th RE with the configured comb offset (k), and a second antenna port, a fourth antenna port, a sixth antenna port, and an eighth antenna port of the 8 antenna ports may be mapped on every K-th RE with a comb offset (k+1)modulo K, within the SRS transmission bandwidth.

In some embodiments, the comb value K is 4. A first antenna port, a third antenna port, a fifth antenna port, and a seventh antenna port of the 8 antenna ports may be mapped on every K-th RE with the configured comb offset (k). A second antenna port, a fourth antenna port, a sixth antenna port, and an eighth antenna port of the 8 antenna ports may be mapped on every K-th RE with a comb offset (k+2)modulo K, within the SRS transmission bandwidth.

In some embodiments, the comb value K is 8. A first antenna port and a fifth antenna port of the 8 antenna ports may be mapped on every K-th RE with the configured comb offset (k). A second antenna port and a sixth antenna port of the 8 antenna ports may be mapped on every K-th RE with a first comb offset (k+2)modulo K. A third antenna port and a seventh antenna port of the 8 antenna ports may be mapped on every K-th RE with a second comb offset (k+4)modulo K. A fourth antenna port and an eighth antenna port of the 8 antenna ports may be mapped on every K-th RE with a third comb offset (k+6)modulo K.

According to embodiments, a network device transmits, to a user equipment (UE), a configuration of a sounding reference signals (SRS) resource with 8 antenna ports and with a time division multiplexing (TDM) parameter, a transmission comb configuration for the SRS resource, and a cyclic shift (CS) configuration for the SRS resource. The transmission comb configuration indicates a comb value K. K is one of 2, 4, or 8. The transmission comb configuration further indicates a comb offset k. k is an integer between 0 and K−1. The CS configuration indicates CS positions. The SRS resource is mapped to a number m of consecutive orthogonal frequency division multiplexing (OFDM) symbols within a same slot. m is greater than or equal to 1. Each OFDM symbol of the consecutive OFDM symbols is mapped to a corresponding subset of the 8 antenna ports based on m and s. s is determined based on the TDM parameter and is a number of subsets of the 8 antenna ports. The network device receives, from the UE, SRSs.

In some embodiments, the UE may map an i-th subset of 8/s antenna ports of the 8 antenna ports to every s-th OFDM symbol within the consecutive OFDM symbols starting from an i-th OFDM symbol of the consecutive OFDM symbols. i is from 1 to s.

In some embodiments, SRS transmissions on the consecutive OFDM symbols may be mapped with a same comb offset allocation and same CS positions.

In some embodiments, SRS transmissions on the consecutive OFDM symbols may be mapped with a same physical resource block (PRB) allocation.

In some embodiments, SRS transmissions on the consecutive OFDM symbols may be periodic, semi-persistent, or aperiodic. The SRS transmissions may be based on an SRS counter determined by s*R. R is a configured repetition factor for the SRS resource.

In some embodiments, m may be a multiple of s.

In some embodiments, m may be one of 2, 4, 8, 10, 12, or 14. s may be 2.

### BRIEF DESCRIPTION OF THE DRAWINGS

The structure and use of disclosed embodiments are discussed in detail below. It should be appreciated

For a more complete understanding of the present disclosure, and the advantages thereof, reference is now made to the following descriptions taken in conjunction with the accompanying drawings, in which:

FIG. 1 illustrates an example communications system, according to some embodiments;

FIG. 2 illustrates an example communications system, according to some embodiments;

FIG. 3 illustrates an example of RE/PRB skipping within a hop;

FIG. 4A shows an example of hopping for SRS orthogonality and SRS collision;

FIG. 4B shows an example of hopping for SRS orthogonality;

FIG. 4C shows an example effect of complementary CS hopping;

FIGS. 5A and 5B illustrate TRP-common SRS and TRP-specific SRS approaches, according to some embodiments;

FIG. 6 illustrates an embodiment communication system;

FIGS. 7A and 7B illustrate example devices that may implement the methods and teachings according to this disclosure; and

FIG. 8 shows a block diagram of a computing system that may be used for implementing the devices and methods disclosed herein, according to some embodiments;

FIG. 9 illustrates a use of carrier aggregation (CA), according to some embodiments;

FIG. 10A illustrates example physical layer channels and signals, according to some embodiments;

FIG. 10B illustrates signals/channels multiplexed for more than one PDSCH, according to some embodiments;

FIG. 10C illustrates examples of non-zero power (NZP) CSI-RS used for channel estimation, interference measurement, according to some embodiments;

FIG. 11A illustrates a flow chart of a method performed by a network device, according to some embodiments;

FIG. 11B illustrates a flow chart of a method performed by a UE, according to some embodiments;

FIG. 11C illustrates a flow chart of a method performed by a UE, according to some embodiments;

FIG. 11D illustrates a flow chart of a method performed by a UE, according to some embodiments;

FIG. 11E illustrates a flow chart of a method performed by a network device, according to some embodiments;

FIG. 11F illustrates a flow chart of a method performed by a network device, according to some embodiments;

FIG. 12A shows CDF of pathloss differences;

FIG. 12B shows channel estimation performance with received power imbalance and orthogonal/non-orthogonal SRSs;

FIG. 13 shows SRS performance with the same SRS sequence (with cyclic shift spacing of 1 or 2) or with different SRS sequences (with cyclic shift spacing of 0 or 2);

FIG. 14 shows SRS performance of CDMed SRS ports with CDL-C 300 ns channels and cyclic shift spacing of 1, 2, or 3;

FIG. 15 shows SRS performance of orthogonal ports, full-collision ports, and partial collision with a weaker interfering port;

FIG. 16 shows SRS performance of cyclic shift hopping for CDMed SRS ports with CDL-C 300 ns channels;

FIG. 17 shows SRS performance with cyclic shift hopping of weaker interfering ports; and

FIG. 18 shows performance evaluations of one UE with CS 0 and the other UE with CS 1/f.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

The configuration of SRS related parameters of an SRS to be transmitted in the uplink (such as SRS transmission ports, SRS transmission bandwidth, SRS resources sets, transmission comb and cyclic shift, etc.) are semi-static in nature and may be provided through higher layer signaling, such as radio resource control (RRC) signaling. A more dynamic technique to signal the configuration is needed to better associate the SRS parameters (such as the SRS transmission bandwidth and/or ports) with the Physical Data Shared Channel (PDSCH) parameters. Moreover, the association between the downlink reference signals, such as Channel State Information Reference Signals (CSI-RS) or demodulation reference signals (DMRS), and the uplink SRS should be conveyed to the UE to accurately reflect the interference situation and perform optimal beamforming. Thus, there is a need for apparatus and methods for signaling control information that accurately indicates a more dynamic configuration (e.g., not semi-static) of the aforementioned parameters, such as, for example, a portion of the transmission bandwidth required to transmit a subset of the SRS resource set (thereby implicitly indicating a transmission comb and cyclic shift) using a subset of the transmission ports associated with a particular set of downlink reference signals. The signaling of the control information may be closely tied to an actual data transmission. The transmission of the SRS may be periodic (e.g., periodic SRS (P-SRS or P SRS)) as configured by Layer 3 RRC configuration signaling, semi-persistent (e.g., semi-persistent SRS (SP-SRS or SP SRS)) activated/deactivated via Layer 2 medium access control (MAC) control element (CE), or aperiodic (i.e., aperiodic SRS (A-SRS, AP-SRS, A SRS, or AP SRS)) indicated by Layer 1 downlink control information (DCI) in the PDCCH.

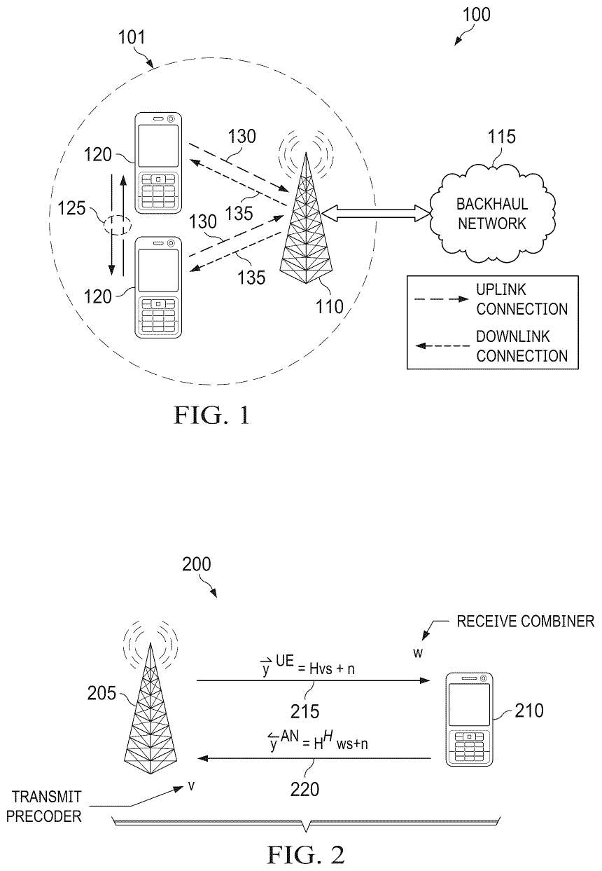

FIG. 1 illustrates an example communications system 100, according to embodiments. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc.

A cell may include one or more bandwidth parts (BWPs) for UL or DL allocated for a UE. Each BWP may have its own BWP-specific numerology and configuration, such as the BWP's bandwidth. It is noted that not all BWPs need to be active at the same time for the UE. A cell may correspond to one carrier, and in some cases, multiple carriers. Typically, one cell (a primary cell (PCell) or a secondary cell (SCell), for example) is a component carrier (a primary component carrier (PCC) or a secondary CC (SCC), for example). For some cells, each cell may include multiple carriers in UL, one carrier may be referred to as an UL carrier or non-supplementary UL (non-SUL, or simply UL) carrier which has an associated DL, and other carriers are called supplementary UL (SUL) carriers which do not have an associated DL. A cell, or a carrier, may be configured with slot or subframe formats comprising DL and UL symbols, and that cell or carrier may be seen as operating in a time division duplexed (TDD) mode. In general, for unpaired spectrum, the cells or carriers are in TDD mode, and for paired spectrum, the cells or carrier are in a frequency division duplexed (FDD) mode. A transmission time interval (TTI) generally corresponds to a subframe (in LTE) or a slot (in NR). Access nodes may provide wireless access in accordance with one or more wireless communication protocols, e.g., long term evolution (LTE), LTE advanced (LTE-A), 5G, 5G LTE, 5G NR, future 5G NR releases, 6G, High Speed Packet Access (HSPA), Wi-Fi 802.11a/b/g/n/ac, etc. While it is understood that communication systems may employ multiple access nodes (or base stations) capable of communicating with a number of UEs, only one access node, and two UEs are illustrated in FIG. 1 for simplicity.

In standard antenna element to element channel estimation, a channel between two devices is estimated by having a first device transmit a known signal on a known time or frequency resource (s) to a second device, the received signal at the second device is expressible as:

$$y = Hx + n \qquad ( 1 )$$

where y is the received signal at the second device, x is the known signal (which may be a reference signal, a pilot, or a pilot signal), H is the channel model or response, and n is the noise (and interference for some communication channels). Because x is known by the second device, it is possible for the second device to determine or estimate H from y.

It is noted that the concept of antenna, antenna element, and antenna port may be generally interchangeable, but in some specific scenarios, they can mean different but related subjects. For example, one transmit (Tx) antenna port may be formed (or virtualized) by multiple antenna elements or antennas, and the receiver sees only the one Tx antenna port but not each of the multiple antenna elements or antennas. The virtualization may be achieved via beamforming, for example.

FIG. 2 illustrates an example communications system 200, providing mathematical expressions of signals transmitted in the communications system. Communications system 200 includes an access node 205 communicating with UE 210. As shown in FIG. 2, access node 205 is using a transmit filter v and UE 210 is using a receive filter w. Both access node 205 and UE 210 use linear precoding or combining. Assuming H is Nᵣₓ×Nₜₓ matrix of a multiple-input, multiple-output (MIMO) system, i.e., there are Nₜₓ transmit antennas and Nᵣₓ receive antennas. The transmit filter v of dimension Nₜₓ×Ns enables the transmitter to precode or beamform the transmitted signal, where Ns is the number of layers, streams, symbols, pilots, messages, or known sequences transmitted. The receive filter w of multi-antenna systems is of dimension Nᵣₓ×Ns and represents the combining matrix. It is noted that the above description is for a transmission from access node 205 to UE 210, i.e., a downlink transmission. The transmission may also occur at the reverse direction (an uplink transmission), for which the channel matrix becomes H^{H}, which is the Hermitian of channel model H, and w may be seen as the transmit filter and v as the receiver filter. The w for transmission and the w for reception may or may not be the same, and likewise for v.

A downlink (or forward) channel 215 between access node 205 and UE 210 has channel model or response H, while an uplink (or backward, or reverse) channel 220 between UE 210 and access node 205 has channel model or response H^{H}, which is the Hermitian of channel model H. Although FIG. 2 depicts only one access node and one UE, it is not limited to this case. Multiple UEs may be served by the access node, on different time-frequency resources (such as frequency division multiplexing (FDM)-TDM, as in typical cellular systems) or on the same time-frequency resources (such as multi-user (MU)-MIMO, wherein multiple UEs are paired together and each UE is individually precoded). Among the paired UEs, there is intra-cell interference. Also, multiple access nodes may exist in the network, some of which may be cooperatively serving UE 210 in a joint transmission (JT) fashion (such as coherent joint transmission (CJT), non-coherent joint transmission (NCJT), coordinated multipoint transmission, etc.), dynamic point switching fashion, and so on. Some other access nodes may not serve UE 210 and their transmissions to their UEs cause inter-cell interference to UE 210. The scenario of multiple access nodes and multiple UEs, with access node cooperation to serve a UE and with MU-MIMO, is a scenario considered and analyzed herein, and the example embodiments of bi-directional training applies to this scenario.

UEs transmit SRS for purposes of downlink (DL) channel state information (CSI) acquisition (with usage “antennaSwitching” to support DL CJT/NCJT/single-TRP transmissions) and uplink (UL) CSI acquisition (with usage ‘codebook’ or ‘noncodebook’), and sometimes also for timing advance (TA)/UL PC adjustments. (Beam management can also be included for frequency range 2 (FR2) but not applicable for FR1 in some optional embodiments). In general, a UE may need to send the SRS to each TRP serving the UE. Given the limited UL slots/orthogonal frequency-division multiplexing (OFDM) symbols in time division duplex (TDD) networks, this can lead to severe SRS interference issues (if some SRSs are not orthogonal) and/or SRS capacity issues (if some SRSs are orthogonal). Therefore, one objective is to manage inter-TRP cross-SRS interference via SRS capacity enhancement and/or reducing the impact of interference by interference randomization.

A number of potential SRS enhancements have been captured in the agreement in RAN1 #109-e. Some of them were proposed or discussed in earlier 3GPP contributions, including some in Rel-18 RAN plenary discussions and some in Rel-17 Enhancements on SRS flexibility, coverage and capacity in Rel-17 further enhanced MIMO (FeMIMO). In this disclosure, the potential enhancements in the agreement are discussed one by one.

Before going to the details, a general issue may be discussed. Some of the potential enhancements aim for SRS interference randomization, and it could occur that, if not designed/implemented properly, existing orthogonality between different SRSs may be lost due to randomization. For example, SRS1 and SRS2 are orthogonal based on the current mechanism (e.g., code-division multiplexed (CDMed) or frequency-division multiplexed (FDMed)), but with additional code-domain and/or frequency-domain randomization, they may collide on some resources. In this disclosure, such collision can be avoided by proper design (e.g., hop in the same way) and/or proper implementation (e.g., gNB coordination). That is, enhancements for SRS interference randomization should not prevent gNB configuring orthogonal SRSs. The enhancements are described in further details below.

Depending on the design/implementation, some SRS interference randomization enhancements may lead to collision/loss of orthogonality to otherwise orthogonal SRSs multiplexed via FDM/CDM.

In some embodiments, enhancements for SRS interference randomization do not prevent gNB configuring orthogonal SRSs.

Randomized frequency-domain resource mapping for SRS transmission was proposed, and some examples were captured in the agreement (e.g., further enhancements to frequency hopping (FH), comb hopping).

SRS FH has been defined since Rel-15 and also enhanced in Rel-17 with resource block (RB)-based partial frequency sounding (RPFS). Some embodiment enhancements are discussed below, and further enhancements to FH along the line of RPFS will be described in the part of RPFS in this disclosure.

SRS FH may be based on a set of parameters including C_{SRS}, B_{SRS}, bₕₒₚ, n_{shift}, and n_{RRC} together with a set of equations associated with them. The FH design may be delicate, and, in some embodiments, it may be preferred that any FH enhancements only add on top of the existing FH patterns but not to alter the existing parameters/equations/patterns. For example, changing the equations depending on N_{b} values or definition of m_{SRS,b} by changing the number of PRBs in a hop may not be desirable, but adding more rows to Table 6.4.1.4.3-1 (SRS bandwidth configuration) in TS 38.211 to support more N_{b} values may be considered, and reducing the number of physical RBs (PRBs) or resource elements (REs) based on the existing m_{SRS,b} value for a hop may be considered.

Table 6.4.1.4.3-1 (SRS bandwidth configuration) in TS 38.211 with (C_{SRS}, B_{SRS}, m_{SRS,b}, N_{b}) may be appended with more rows, such that with the same maximum sounding bandwidth m_{SRS,0}, more N_{b} values are supported and the gNB can choose from them for better randomization outcomes. For example, for m_{SRS,0}=40, for now there is only one row and hence one N₁ value (N₁=2), but more rows can be added with C_{SRS}>63 for this maximum sounding bandwidth to support N₁={4, 5, 10} and so on, and correspondingly new N₂ values and N₃ values can be defined. Similarly, the table may be appended with more columns to the right with N_{b}>3, mainly for the appended new rows. The existing definitions of parameters and equations do not need to be changed.

Extending Table 6.4.1.4.3-1 is fully backwards compatible, relatively straightforward, and easy to be supported with existing framework of signaling and operations.

Within the current sounding bandwidth of a hop, some REs or PRBs may be skipped, and over different hops, the skipping may be different to increase the degree of randomization. To prevent increasing peak-to-average power ratio (PAPR), the REs skipped may be uniformly distributed in frequency (essentially using a new comb value; to be described below) or on the edges of the FH bandwidth, and the PRBs skipped should be on the edges of the FH bandwidth. For example, on a hop, the gNB may signal the UE to skip the bottom edge x PRBs, and on the next hop, the gNB may signal the UE to skip the top edge y PRBs and bottom edge y PRBs, etc. The gNB may also signal the UE to skip half of the PRBs and so on, which is similar to RPFS described later in the part for RPFS.

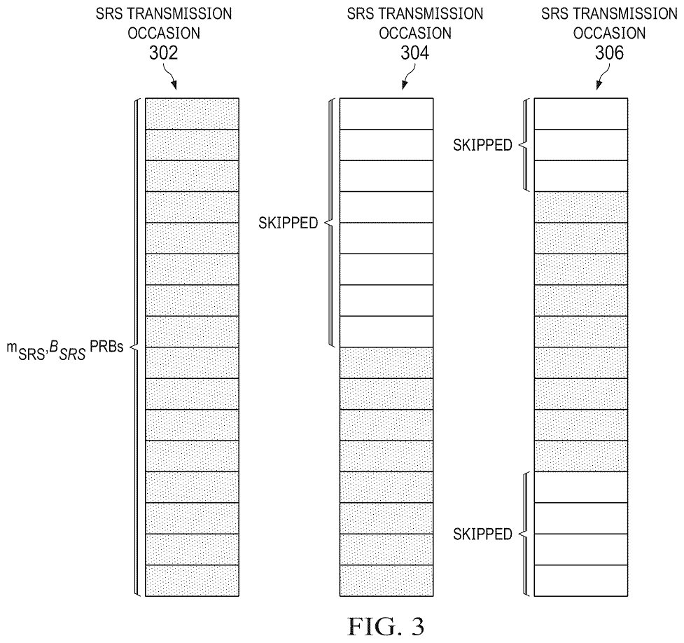

An implication of RE/PRB skipping is that the channel estimation based on SRS cannot assume a uniform pattern in time/frequency domains (i.e., at some times, SRS samples are not available on some REs carrying SRS according to previous mechanisms). FIG. 3 illustrates an example of RE/PRB skipping within a hop (for an example of 3 transmission occasions 302, 304, and 306), showing that SRS samples are not available on some REs in some transmission occasions. This skipping may affect the channel estimation filter design and the performance. However, with narrower per-hop bandwidth from the RE/PRB skipping, the per-RE SRS power may be boosted to compensate the performance loss. In addition, with RE/PRB skipping, the SRS sequence becomes shorter, which may have some impact on code-domain resource orthogonality and can be further studied. When SRS on some REs/PRBs is skipped, the SRS sequence may still use the portion of the sequence according to the previous mechanism rather than using a sequence with shorter length, which can help multiplex with SRSs potentially overlapping with this SRS.

Comb hopping was previously proposed. Enhancements to comb hopping and comb offset hopping are described in this disclosure.

Comb hopping could mean that on a first SRS transmission occasion of an SRS resource, a comb (e.g., 2) is used, and on a second SRS transmission occasion, a different comb is used (e.g., 8). Then over time, the SRS interference is presented on some REs in some OFDM symbols but not persistently in all the SRS OFDM symbols, thus achieving (pseudo-) randomization in frequency-domain.

To support comb hopping, a comb hopping sequence can be defined (e.g., {2, 4, 8, 2, 4, 8, . . . }). An existing pseudo-random sequence with integer values may be reused, such as by the transformation of 2^{mod(x,3)+}1 applied on each integer value of the sequence.

To ensure that CDMed SRS transmissions are still orthogonal among them, it may be necessary to configure the CDMed SRSs with the same comb hopping sequence. Other means to maintain CDM orthogonality with comb hopping can also be utilized.

Similar to pseudo-random RE/PRB skipping within a hop, with comb hopping, the receiver performing the channel estimation based on SRS cannot assume a uniform pattern in time/frequency domains (i.e., at some times, SRS samples are not available on some REs). This may affect the channel estimation filter design and the performance.

Comb offset hopping could mean that on a first SRS transmission occasion of an SRS resource, a comb offset (e.g., 0) is used, and on a second SRS transmission occasion, a different comb offset is used (e.g., 1). Then over time, the SRS interference is shifted across the K_{TC} REs (K_{TC} is the configured transmission comb) and achieves (pseudo-) randomization in frequency-domain.

To achieve this objective, a comb offset hopping sequence may be used. For an SRS resource configured for positioning purposes (with IE SRS-PosResource), a comb offset hopping over multiple OFDM symbols within a slot is enabled via a comb offset hopping sequence k_{offset}^{l′} (see below table from TS 38.211 which defines offset k_{offset}^{l′} for comb offset hopping for a positioning SRS resource), but the mechanism is not available for an SRS resource not configured for positioning purposes.

TABLE 6.4.1.4.3-2
The offset k_{offset}^{l′} for SRS as a function of K_{TC} and l′.
TS 38.211, 6.4.1.4.3
If the SRS is configured by the IE SRS-PosResource, the quantity
k_{offset}^{l′} is given by Table 6.4.1.4.3-2, otherwise k_{offset}^{l′} = 0.

| | k_{offset}⁰, ... , k_{offset}^{N}^{_{symb}}^{^{SRS}}⁻¹ | | | | |
|---|---|---|---|---|---|
| | N_{symb}^{SRS} = | N_{symb}^{SRS} = | N_{symb}^{SRS} = | N_{symb}^{SRS} = | N_{symb}^{SRS} = |
| K_{TC} | 1 | 2 | 4 | 8 | 12 |
| 2 | 0 | 0, 1 | 0, 1, 0, 1 | — | — |
| 4 | — | 0, 2 | 0, 2, 1, 3 | 0, 2, 1, | 0, 2, 1, 3, |
| | | | | 3, 0, | 0, 2, 1, 3, |
| | | | | 2, 1, 3 | 0, 2, 1, 3 |
| 8 | — | — | 0, 4, 2, 6 | 0, 4, 2, | 0, 4, 2, 6, |
| | | | | 6, 1, | 1, 5, 3, 7, |
| | | | | 5, 3, 7 | 0, 4, 2, 6 |

This embodiment mechanism may be standardized and/or configured to an SRS resource not configured for positioning purposes. However, if supported, this embodiment mechanism may be enabled by the gNB with careful planning across multiple multiplexed SRS transmissions to avoid SRS collisions on the same REs on some OFDM symbols. For example, some 2-symbol 4-port SRS may be multiplexed with a 4-symbol 4-port SRS, and the SRSs overlap on the last 2 OFDM symbols of a slot via FDM based on different comb offsets. Then, with the 2-symbol 4-port SRS hops with the pattern {0,2} whereas the 4-symbol 4-port SRS hops with the pattern {0, 2, 1, 3}, the SRSs may sometimes occupy the same comb offset on some OFDM symbols and lead to collision with strong interference. This collision can be anticipated by the gNB and the gNB can configure parameters appropriately to prevent collision from occurring (e.g., the SRSs occupy the same OFDM symbols and PRBs), though with some loss of configuration flexibility. A design to avoid this technical problem can be to allocate the hopping sequence backwards in time in OFDM symbols as most SRSs occupy the last OFDM symbols of a slot. Alternatively, the offset value sequence can be based on the absolute symbol position, which is common for all UEs. Alternatively, the gNB may configure some skipping pattern to the same pseudo-random sequence so that different SRSs are aligned with their offsets.

Similarly, comb offset hopping sequence may also be defined over multiple slots. More details and several embodiments are provided.

a. The Hopping Pattern (e.g., the Pseudo-Random Sequence, Time-Domain Granularity for Hopping)

The hopping pattern for additional comb offset values (in addition to the RRC configured comb offset value combOffset) may be based on a comb offset hopping sequence {k_{offset}^{l′}} which can reuse the positioning SRS hopping sequences (e.g., {0, 2, 1, 3, 0, 2, 1, 3, 0, 2, 1, 3}) for 12 OFDM symbols and comb 4 as in Table 6.4.1.4.3-2 of TS 38.211. A limitation of this approach is that more OFDM symbol allocations are supported than those in the table, e.g., N_{symb}^{SRS} can be 10 or 14. So, some generalization may be needed (e.g., the sequence may be obtained by truncation of a longer sequence (preferred if applicable) or cyclic extension of a shorter sequence). For example, for 10 OFDM symbols, truncating the sequence for 12 OFDM symbols leads to {0, 2, 1, 3, 0, 2, 1, 3, 0, 2}, and for 14 OFDM symbols, cyclic extension of the sequence for 12 OFDM symbols leads to {0, 2, 1, 3, 0, 2, 1, 3, 0, 2, 1, 3, 0, 2}. Another limitation is that the hopping pattern is only intra-slot but not inter-slot.

Another approach to define the hopping pattern is to reuse the widely adopted binary pseudo-random sequence c(i). This approach may be utilized if more OFDM symbol allocations are supported, and can cover intra-slot and/or inter-slot hopping. Denote the system frame number (SFN) of a radio frame as n_{f}, the slot index within a radio frame as n_{s,f}^{μ}, the OFDM symbol index within a slot as l, the SRS starting symbol index within a slot as l₀, and a SRS symbol index relative to the starting symbol as l′. Also denote nₛₗₒₜ^{frame,μ} as the number of slots in a radio frame, and N_{symb}^{slot} as the number of OFDM symbols in a slot. The equation for determining the SRS frequency-domain starting position without hopping (legacy behavior) is k̅₀^{(p}^{ᵢ}⁾=n_{shift}N_{sc}^{RB}+(k_{TC}^{(p}^{ᵢ}⁾)+k_{offset}^{l′}+k_{offset}^{s,f,l′})mod K_{TC}. The equation for determining the SRS frequency-domain starting position with hopping would have an extra term (e.g., k̅₀^{(p}^{ᵢ}⁾=n_{shift}N_{sc}^{RB}+((k_{TC}^{(p}^{ᵢ}⁾)+k_{offset}^{l′}+k_{offset}^{s,f,l′})mod K_{TC}), where k_{offset}^{s,f,l′}=f(n_{s,f}^{μ}N_{symb}^{slot}+l₀+l′, c) is the additional comb offset value, such as k_{offset}^{s,f,l′}=c(n_{s,f}^{μ}N_{symb}^{slot}+l₀+l′) if the comb offset needs to hop between 2 values. Hopping among more values can also be supported based on the c(i) sequence. For example, for M values, the offset can be k_{offset}^{s,f,l′}=(Σₘ₌₀⁷2^{m}c(8n_{s,f}^{μ}N_{symb}^{slot}+8l₀+8l′+m))mod M (or Σₘ₌₀^{M-1}2^{m}c(8n_{s,f}^{μ}N_{symb}^{slot}+8l₀+8l′))mod M). The M values may be for comb 2 (M=2), comb 4 (M=4), and comb 8 (M=8), or for comb offset hopping with a subset configured for hopping restriction (e.g., for comb 8 with a subset of [1,5,6], M=3). In addition, if SFN no is a re-initialization instance and the current SFN is n_{f}, in the above formulas, instead of n_{s,f}^{μ}N_{symb}^{slot}, the term (n_{f}−n₀)n_{s,f}^{μ}N_{symb}^{slot} may be used. If re-initialization is to be done for every nₗ radio frames and the current SFN is n_{f}, in the above formulas, the term (n_{f} mod nₗ)n_{s,f}^{μ}N_{symb}^{slot} may be used. These formulas can also be applicable to cyclic shift hopping described below. If for aperiodic SRS more randomness is desirable, the SRS counter n_{SRS} can be used to as a parameter in c(i), but it may lead to occasional collision with other SRS(s).

b. The Time-Domain Parameter and/or Behavior (e.g., Slot Index, Symbol Index, Re-Initialization Behavior)

If only intra-slot hopping is to be supported, only the symbol index l′ is needed, similar to the positioning SRS case.

If intra-slot and inter-slot hopping is to be supported, then slot index, symbol index, and possibly also SRS counter may be used.

In existing sequency/group hopping with pseudo-random sequence c(i), the pseudo-random sequence can be initialized with cᵢₙᵢₜ=n_{ID}^{SRS} at the beginning of each radio frame. This can be reused for comb offset hopping. The re-initialization at the beginning of each radio frame is useful to ensure that newly multiplexed SRS can be aligned with existing multiplexed SRS in terms of the c(i) value so that they can remain orthogonal over time. Therefore, the re-initialization can be kept, but may be extended to initialize at the beginning of a radio frame according to the system frame number (SFN).

c. Network-Configured ID for UE-Specific Initialization

The SRS sequence identity n_{ID}^{SRS} is given by the higher layer parameter sequenceId in the SRS-Resource IE, in which case n_{ID}^{SRS} ∈{0, 1, . . . , 1023}, or the SRS-PosResource-r16 IE, in which case n_{ID}^{SRS} {0, 1, . . . , 65535}. This has been used to determine the SRS sequence as well as for UE-specific initialization for sequence/group hopping and can be reused here. Alternatively, another ID for comb offset hopping can also be introduced for higher flexibility and randomness, so that SRSs inside and outside a CJT transmission area can hop/behave in different ways even if they happen to be assigned with the same sequence/sequenceId.

d. How the Comb Offset Value is Determined by the Parameters for Each SRS Port of an SRS Resource for an SRS Transmission Occasion

For different SRS ports in an SRS resource, they can be associated with the same additional comb offset value for each transmission to avoid collision on the same comb offset (i.e., RE) and the same cyclic shift (at least for comb 8) and reduce complexity. The additional comb offset value for each transmission can be determined by approaches described above (e.g., based on positioning SRS approach, or based on the c(i) sequence with network-configured ID for UE-specific initialization).

e. Potential Issue on Multiplexing with Legacy UEs if Comb Offset Hopping are Enabled

When legacy UEs and new UEs with comb offset hopping enabled are multiplexed on the same PRBs and OFDM symbols, the new UEs may hop to the comb offset assigned to legacy UEs and lead to collision. This should be avoided, e.g., via FDM on different PRBs or TDM by gNB implementation. FDM on different REs of the same PRBs is also possible, by excluding some comb offset values for comb offset hopping. For example, if a legacy UE occupies comb offset 0 on PRBs shared with a new UE, the new UE should not hop to comb offset 0 and may only hop to comb offset 1, 2, and 3 as configured by RRC. This can be easily realized by using f(n_{s,f}^{μ}N_{symb}^{slot}+l₀+l′, c)mod 3 and then map to the allowable additional comb offset value set.

In any case, when comb offset hopping is used for an SRS port, it should not lead to full collision with the same cyclic shift to another FDMed SRS port from the same UE or a different UE by hopping to the same comb offset (i.e., RE), which causes the orthogonal SRS ports to significantly interfere with each other and renders both ports unusable. Thus, if comb offset hopping is enabled for a set of SRS ports with the same cyclic shift and occupying overlapping time-frequency resources, these SRS ports should be configured with the same hopping pattern, the same ID for comb offset hopping, the same re-initialization, and same time-domain behavior and resource allocation (unless the hopping pattern is designed to depend on only the frame/slot/OFDM symbol locations but not UE-specific parameters). For any SRS ports that may be transmitted on the same RE, they need to be CDMed, that is, they need to have the same SRS sequence but different cyclic shift values.

f. Applicability to Periodic/Semi-Persistent/Aperiodic SRS

Comb offset hopping should be applicable to periodic/semi-persistent/aperiodic SRS. The above design of hopping pattern depends on the OFDM symbol location within a slot/radio frame, which ensures that any SRSs multiplexed in an orthogonal way stay orthogonal, regardless of the SRS transmissions being periodic (P)/semi-persistent (SP)/aperiodic (AP) SRS transmission. Thus, to increase the SRS interference randomization benefit, it is desirable that comb offset hopping/cyclic shift hopping is applied to AP/P/SP SRS and for all the SRS usages.

Overall, several randomized frequency-domain resource mapping enhancements for SRS transmission can be considered. A limitation of these enhancements may be that they need to ensure that when an SRS transmission occupies some REs not assigned based on legacy standards, a potential collision may occur. Though via proper gNB implementation, the potential collision may be avoidable, but higher complexity and some loss of configuration flexibility may be possible. Another aspect to be studied is the non-uniform time/frequency-domain SRS samples due to hopping and randomization, which may impact SRS-based channel estimation.

For randomized frequency-domain resource mapping for SRS transmission, appending Table 6.4.1.4.3-1 (SRS bandwidth configuration) in TS 38.211 with more rows/columns; pseudo-random RE/PRB skipping within a hop, and its potential impact due to non-uniform time/frequency-domain SRS samples, its potential impact on the minimum SRS sequence length; comb hopping with comb values according to a pseudo-random sequence, its potential impact on multiplexing multiple SRSs, and its potential impact due to non-uniform time/frequency-domain SRS samples; comb offset hopping with comb offset values according to a pseudo-random sequence, and its potential impact on multiplexing multiple SRSs; and randomized code-domain resource mapping for SRS transmission are described in this disclosure.

Randomized code-domain resource mapping for SRS transmission was previously proposed, and some examples were captured in the agreement (e.g., cyclic shift hopping/randomization, sequence hopping/randomization, per-hop sequence from a long SRS sequence.

In existing standards, the mapping between SRS port(s) and cyclic shift(s) is fixed and cannot be changed unless a RRC reconfiguration of the SRS. Therefore, once two SRSs collide with the same cyclic shift(s) on an OFDM symbol, the SRSs may collide on other OFDM symbols. To improve the interference randomization across different SRSs sent by different UEs, cyclic shift hopping/randomization may be utilized.

To enable cyclic shift randomization/hopping over time, a pseudo random sequence to introduce additional offset(s) of the current cyclic shift(s) can be utilized. When multiple ports of an SRS resource are multiplexed on a RE via different cyclic shifts, the current design provides a suitable spacing between them (generally spreading the ports uniformly, e.g., 2-port SRS may use cyclic shifts 0 and 4). The spacing can be maintained if a common additional offset is applied to all the ports, which simplifies the design.

For SRSs orthogonalized via CDM with the same sequence and occupying the same OFDM symbols and PRBs, they should be configured with the same cyclic shift hopping sequence so that they hop in the same way to maintain CDM orthogonality. In other words, all CDMed ports/UEs should hop in a pre-coordinated way to avoid collision. A possible way is that, the hopping pattern may be a function of the sequence ID, such as changing the configured cyclic shift value α₀ to (α₀+(dₗ+n)s)mod D, where s may be the SRS sequence ID (ranging from 0 to 1023), {dₗ} is a pseudo-random integer sequence on multiple SRS transmission occasions, n may be an additional value signaled by the network to further randomize among different cells with possibly the same sequence, l is the indexing for SRS transmission occasions, and D is the maximum cyclic shift. These SRSs can occupy the same OFDM symbols; otherwise, over time, they may use different cyclic shift offsets on an OFDM symbol and collide. Alternatively, the gNB may configure some skipping pattern to the same pseudo-random sequence so that different SRSs are aligned with their cyclic shift offsets.

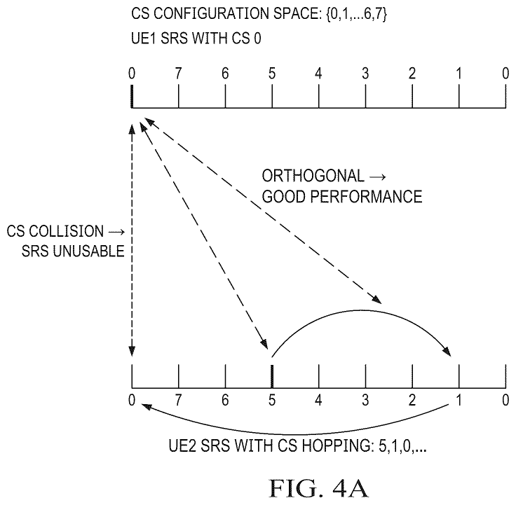

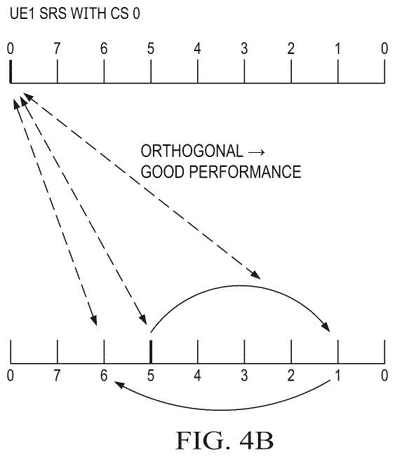

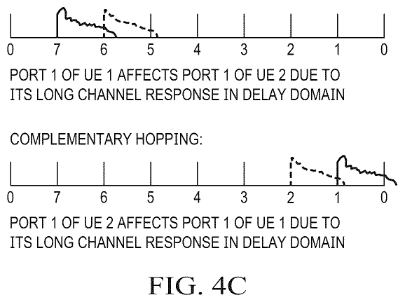

SRS-based channel estimation for TDD CJT can be enhanced. One direction is to alleviate the negative impact of cross-SRS interference via various randomization/hopping schemes, including CS hopping or randomization. However, CS hopping or randomization may inadvertently cause two SRSs to be hopped on the same CS value, causing significant interference and rendering the SRSs unusable. It is thus desirable to provide designs for CS hopping or randomization so that SRSs will not collide on the same CS value. FIG. 4A shows examples of hopping for SRS orthogonality and SRS collision. The straight arrows show the current CS values, and the curved arrows illustrate CS hopping from one CS value to the next. A full collision occurs when UE 2's SRS hops to CS 0.

Some embodiments use 8 CSs in this disclosure as examples, which corresponds to SRS comb 2. Other numbers of CSs are also applicable. The design is to be used by gNB to configure and trigger the UE's SRS, the UE's setting of SRS parameters, and the corresponding transmission operations, and the gNB's receiving and processing of the SRS according to the SRS's parameters.

The cyclic shift configuration space contains {0, 1, . . . , 6, 7}, and the cyclic shift values are assigned in a cyclic way as 0, 7, 6, . . . , 2, 1, according to the existing standards specifications.

To resolve the CS collision issue, gNB configures SRS CS hopping on a subset of CS values, and over time the UE generates the SRS CS values based on the configured subset of CS values, so that the resulting CS values would not collide with a CS value already used by another SRS. For example: in legacy SRS: the first SRS port is configured with a cyclic shift value α₀.

In an embodiment of CS hopping without restriction: the first SRS port is configured with a cyclic shift value α₀ but hops according to αₗ=(α₀+(dₗ+n)s)mod D, where s is the SRS sequence ID, {dₗ} is a pseudo-random integer sequence on multiple SRS transmission occasions, n may be an additional value signaled by the network, l is the indexing for SRS transmission occasions, and D is the maximum cyclic shift.

In an embodiment of CS hopping on only a subset of CS values, first the first SRS port is configured with a cyclic shift value α₀, and it is also configured with m possible hopping values (e.g., [5,1,6] used UE2 in FIG. 4B). Then, the first port hop to the i-th hopping value during the lth SRS transmission occasion, where i=αₗ mod m. So, for regular CS hopping, the UE generates a pseudo-random integer sequence and then applies mod 8 (for the example of at most 8 CS values) to obtain its CS value. With the restriction, the UE applies mod 3 (for example) and uses the outcome to select a CS value out of the 3 configured values. The parameters for generating the pseudo-random sequence are known to both the gNB and UE, so that both the gNB and UE know which CS value(s) will be used.

The restricted CS hopping could prevent full collision due to pseudo-randomized CS hopping, which may lead to poor performance. This may be necessary for CS hopping to be supported.

Additional embodiments are described below.

In one embodiments, each port may be separately configured with a subset of hopping values. Alternatively, all ports of the SRS resource (for codebook/antennaSwitching) or the SRS resource set (for nonCodebook) hop on the configured subset of hopping values.

In another embodiment, the number of hopping values may be 1 (i.e., per-port configuration of CS value). This embodiment can also cover non-hopping cases.

In yet another embodiment (fractional CS hopping), the subset of hopping values may include a fractional number, e.g., [0, 4/3, 5, 7/8]. The fractional number can further help randomize the interference because it does not fully collide with integer CS values. This also effectively increase the maximum number of CS values. In the above example of [0, 4/3, 5, 5/6], the gNB can determine the minimum CS spacing needed for each port multiplexed via CDM based on each port's delay spread information, and if the delay spread of a port is small, then a fractional CS value with suitable spacing to its neighboring ports can be determined and configured to the UE. The fractional CS values are not necessarily associated with CS hopping. In some embodiments, a fractional CS value can be configured by gNB for an SRS port of a UE.

In yet another embodiment (fractional CS offset), the CS values may be offset by a number, which could be fractional, and the number is to be added to any CS value obtained by the UE based on network signaling and/or calculation using network provided parameters. E.g., the offset ½ may be configured, so that an SRS hopping according to 3, 7, 2, 7, 2, 2, 3, 7, 3, . . . becomes 3.5, 7.5, 2.5, 7.5, 2.5, 2.5, 3.5, 7.5, 3.5, . . . (i.e., the offset ½ is added to any obtained CS values). Integer CS offset is also allowed (e.g., CS 0 will hop to CS 1, CS 2, . . . , CS 7, CS 0, . . . over multiple SRS transmission occasions). The CDMed SRS ports can be configured with the same offset, so that they can randomize interference to other SRSs.

In yet another embodiment (complementary CS hopping), if a port has CS value α, and the number of maximum CS values is n, then the port hops between a and n−α, which creates complementary CS hopping patterns (i.e., reversing the CS assignments).

When all ports do the same complementary CS hopping in the long delay spread cases, an interfering port becomes an interfered port, and an interfered port becomes an interfering port, averaging out each port's SINR and performance. An example is shown in FIG. 4C, in which port 1 of UE 1 causes interference to port 2 of UE 2 due to the long channel response in delay domain associated with port 1. When the cyclic shifts are reversed, the interfering/interfered ports are swapped, leading to interference randomization/averaging effect. Though the figure shows the case that a port's channel response is long and extends to another port's channel samples, the same embodiment design can be used for the case that a port's channel delay is long (i.e., shifted to right) and extends to another port's channel samples.

In yet another embodiment (combined CS hopping), CS hopping on a subset of CS values and CS offset can be combined, so that all the CDMed ports are shifting around, and on top of that, some ports have additional hopping patterns. That is, the offset value is added on the configured subset of CS values for each SRS transmission occasion.

In yet another embodiment, CS hopping may be combined with non-uniform CS assignment. For example, for comb 2 and a 2-port SRS, instead of the legacy cyclic shift mapping of [CS0, CS4], a new mapping may be [CS0, CS2]. The region of CS0˜CS3 may be seen as a region for SRS with long channel delays. Within the region, the ports of the SRS resource may be uniformly allocated. Then, for the 2 ports, they may be configured with subsets {CS0, CS1} and {CS2, CS3}, respectively, for their cyclic shift hopping; that is, the ports still hop within the designated long-delay region while achieving interference randomization. This case may be called intra-region hopping (i.e., each SRS resource is configured with a region and the hopping is within the region). In another embodiment, each SRS resource is configured within one region out of several regions, and the hopping is across the different regions, which may be called inter-region hopping. In general, based on network configuration, hopping within a region or across regions can be supported. A region may be a number of consecutive cyclic shifts (including the wraparound, such as cyclic shifts 0 and 7 for comb 2), and it may be configured for a SRS resource to determine the cyclic shift locations for the ports in the SRS resource. For example, if region CS0˜CS3 is configured for a 2-port SRS resource with comb 2, and α₀ of 0 is configured, and if the ports are configured to be uniform within the region, then the 2 ports will be mapped to CS0 and CS2, instead of CS0 and CS4. For another example, if region CS0˜CS3 is configured for a 2-port SRS resource with comb 2, and α₀ of 0 is configured, and if the ports are configured to be non-uniform within the region, then the 2 ports may be mapped to CS0 and CS1, which is useful if the delays/delay spreads of the ports are short. Other examples of combining the non-uniform mapping and hopping are also applicable and may be configured by the network based on implementation needs.

In some embodiments, complementary CS hopping and CS offset can be combined.

In yet another embodiment, for cyclic shift hopping, the time-delay domain granularity can be finer than the cyclic shift assignment in existing standards. For example, for comb 2, currently there are 8 cyclic shifts on an RE, and in the time-delay domain (which may also be called as cyclic-shift-domain, code domain, cyclic shift configuration space, etc.), there are 8 equally spaced cyclic shift points on which the ports are assigned to (with or without hopping). More randomness can be achieved if the ports can hop among 8K equally spaced points in the time-delay domain (with the factor K>1). The potential value(s) of K can be decided. Larger K leads to high randomization benefit, but the benefit may diminish for very large K as cyclic shift spacing gets narrow, and the complexity may also increase. A reasonable value can be K=2. For comb 2, K=3 or even K=4 may be used since the cyclic shift spacing is relatively wide compared to comb 4 and comb 8. Then, for the cyclic shift value,

$${α}_{i} = 2 π \frac{{n}_{SRS}^{cs , i}}{{n}_{SRS}^{cs , max}} + 2 π \frac{{n}_{SRS}^{cs , offset}}{K \times {n}_{SRS}^{cs , max}} ,$$

where n_{SRS}^{cs,offset} can be randomly chosen from {0, 1, . . . K×n_{SRS}^{cs,max}−1} at each SRS transmission.

Sequence hopping and sequence group hopping have been supported in 5G NR since Rel-15 (6.4.1.4.2 in TS 38.211). The sequence group number u=(f_{gh}(n_{s,f}^{μ}, l′)+n_{ID}^{SRS})mod 30 and the sequence number v can change over different SRS transmission occasions, roughly speaking initialized with the parameter s (the SRS sequence ID) and hopping based on a pre-defined pseudo-random sequence c(i). The resulting SRS sequence group number u may hop over 30 values and the SRS sequence number v may hop over {0,1}. Sequence hopping and sequence group hopping may be enabled as sequence hopping only or sequence group hopping only, but not both.

As such, sequence-level hopping/randomization is already standardized. Though introducing more hopping patterns for sequence hopping or sequence group hopping can be straightforward, such as introducing a new parameter or a new pseudo-random sequence, it is unclear how much additional gains can be achieved since the current sequence number or sequence group number is already sufficiently (pseudo-) randomized via s and c(i). A low complexity enhancement from the existing design may be to enable sequence hopping and sequence group hopping for the same SRS resource, which increases the level of randomization. That is, if groupOrSequenceHopping specifies both sequence hopping and group hopping, sequence hopping and group hopping shall be used, with the sequence hopping part according to that in sequence hopping only and the group hopping part according to that in group hopping only, i.e.,

$${f}_{gh} ( {n}_{s , f}^{μ} , {l}^{′} ) = ( {\sum }_{m = 0}^{7} c ( 8 ( {n}_{s , f}^{μ} , {N}_{symb}^{slot} + {l}_{0} + {l}^{′} ) + m ) \cdot {2}^{m} ) mod 30$$

$$v = \{ \begin{matrix}c ( {n}_{s , f}^{μ} , {N}_{symb}^{slot} + {l}_{0} + {l}^{′} ) & {M}_{sc , b}^{SRS} \geq 6 {N}_{sc}^{RB} \\ 0 & otherwise\end{matrix}$$

where the pseudo-random sequence c(i) is defined by clause 5.2.1 and shall be initialized with cᵢₙᵢₜ=n_{ID}^{SRS} at the beginning of each radio frame.

Some further details and several embodiments for cyclic shift hopping/randomization are provided below. Comb offset hopping and cyclic shift hopping share a great amount of commonalities, and most of the embodiment designs provided for one can be applicable to the other. Therefore, unless otherwise mentioned, the embodiments described for one can also be used for the other. Though some embodiments use comb 8 or maximum cyclic shifts of 8 as examples, other combs (e.g., comb 2, comb 4) or maximum cyclic shift numbers are also applicable. Some other embodiments in this application are described using cyclic shift hopping (including the subset configured for hopping restriction) as examples, but they can also be applied to comb offset hopping (including the subset configured for hopping restriction).

The hopping pattern may include, for example, the pseudo-random sequence, time-domain granularity for hopping. The hopping pattern for cyclic shift offset value (on top of the cyclic shift value computed based on RRC configured cyclic shift value cyclicShift) may be based on a cyclic shift hopping sequence by reusing the widely adopted pseudo-random sequence c(i). Thus the equation for determining the SRS cyclic shift would have an extra term, e.g., n_{offset}^{s,f,l′}=f(n_{s,f}^{μ}N_{symb}^{slot}+l₀+l′, c) is the cyclic shift offset value, such as n_{offset}^{s,f,l′}=c(n_{s,f}^{μ}N_{symb}^{slot}+l₀+l′) if the cyclic shift needs to hop between 2 values. Hopping among more values can also be supported based on the c(i) sequence. For example, for M values, the offset can be n_{offset}^{s,f,l′}=(Σₘ₌₀⁷2^{m}c(8n_{s,f}^{μ}N_{symb}^{slot}+8l₀+8l′+m))mod M. If for aperiodic SRS more randomness is desirable, the SRS counter n_{SRS} can be used to as a parameter in c(i), but it may lead to occasional collision with other SRS.

For cyclic shift hopping, the time-delay domain granularity can also be finer than the cyclic shift assignment in existing standards. For example, for comb 2, there are 8 cyclic shifts on a RE, and in the time-delay domain there are 8 equally spaced cyclic shift points on which the ports are assigned to (with or without hopping). More randomness can be achieved if the ports can hop among 8K equally spaced points in the time-delay domain (with the factor K>1). This is in some sense similar to fractional cyclic shift provided in this application, but the difference is that for each of the 8 cyclic shift points, instead of all K subsampling points can be packed with SRS ports with different fractional cyclic shifts, only one of them is occupied each time. That is, with the finer granularity cyclic shift hopping, the gNB expects that only one port can occupy any of the K subsampling points around each of the 8 cyclic shift points for each transmission.

The time-domain parameter and/or behavior may include, for example, slot index, symbol index, re-initialization behavior. When designing the time-domain behavior for hopping, a factor to consider is the multiplexing orthogonality among multiple SRSs. For SRSs multiplexed based on CDM and/or FDM via different comb offsets, they should remain orthogonal when hopping is turned on, regardless of whether the SRSs are configured with the same or different periodicities, the same or different numbers of OFDM symbols, the same or different repetition factors, being dropped or not (due to e.g., collision), and being triggered aperiodically or not. Taking into account all these possibilities, this disclosure provides embodiment techniques that the hopping be tied to the frame/slot/OFDM symbol structure but not related to any UE-specific configuration/behavior. For example, hopping based on the slot index n_{s,f}^{μ} within a radio frame and OFDM symbol index l, can be used as the time-domain parameters for hopping, which is similar to existing sequency/group hopping. This covers intra-slot and/or inter-slot hopping. The system frame number (SFN) n_{f} can also be incorporated, and the multiplexing orthogonality is still maintained if the multiplexed SRS resources apply the same dependency on SFN.

The slot index, symbol index, and possibly also SRS counter may be used for cyclic shift hopping and/or comb offset hopping. In existing sequency/group hopping with pseudo-random sequence c(i), the pseudo-random sequence shall be initialized with cᵢₙᵢₜ=n_{ID}^{SRS} at the beginning of each radio frame. This can be reused for cyclic shift hopping. The re-initialization at the beginning of each radio frame is useful to ensure that newly multiplexed SRS can be aligned with existing multiplexed SRS in terms of the c(i) value so that they can remain orthogonal over time. Therefore, the re-initialization should be kept, but may be extended to initialize at the beginning of a radio frame according to the SFN. This is because the re-initiation at each radio frame has the implication that, for every radio frame (20 ms), the same pattern occurs, which limits the randomization effect. To allow a longer pattern than a radio frame, the UE can initialize at the beginning of a radio frame according to the SFN (e.g., all aligned with SFN 0 if SFN 0 is set as the time for re-initialization, which means the hopping pattern would repeat only after 1024 radio frames). Alignment with another SFN value is also possible, and the value may need to be known by both the gNB and the UE (e.g., via standardization, via RRC configuration, etc.). If the re-initialization/alignment SFN is t, then the additional offset equation can be modified to k_{offset}^{s,f,l′}=f((n_{f}−t)nₛₗₒₜ^{frame,μ}N_{symb}^{slot}+n_{s,f}^{μ}N_{symb}^{slot}+l₀+l′, c), where n_{f} is the current SFN. Re-initialization may also be done multiple times over SFN 0˜SFN 1023 (e.g., for every nₗ radio frames). If re-initialization is to be done for every nₗ radio frames (starting from SFN0) and the current SFN is n_{f}, in the above formulas, the term (n_{f} mod nₗ)nₛₗₒₜ^{frame,μ}N_{symb}^{slot} may be used, i.e. k_{offset}^{s,f,l′}=f((n_{f} mod nₗ)nₛₗₒₜ^{frame,μ}+n_{s,f}^{μ}N_{symb}^{slot}+l₀+l′,c).

Network-configured ID may be used for UE-specific initialization. When deciding the network-configured ID for hopping initialization, still a factor to consider is the multiplexing orthogonality among multiple SRSs. The multiplexed SRSs can be configured with the same initialization ID so that they will not collide on the same time-frequency resource due to pseudo-random hopping. This may imply that UE-specific ID such as C-RNTI is not suitable, and even the cell ID is not suitable except for the scenario of intra-cell CJT, where is quite limiting. So, this disclosure provides embodiment techniques considering only SRS sequence identity n_{ID}^{SRS} or a new ID.

The SRS sequence identity n_{ID}^{SRS} is given by the higher layer parameter sequenceId in the SRS-Resource IE, in which case n_{ID}^{SRS} ∈{0, 1, . . . , 1023}, or the SRS-PosResource-r16 IE, in which case n_{ID}^{SRS} ∈{0, 1, . . . , 65535}. This has been used to determine the SRS sequence as well as for UE-specific initialization for sequence/group hopping and can be reused here. But, a possible drawback is that all the hopping patterns are completely correlated with each other. For an extreme example, suppose the underlying pseudo-random sequence has a segment of consecutive zeros, then none of the hopping methods would actually hop on the corresponding OFDM symbols, which may not be desirable. Additionally, if two cells happen to use the same SRS sequence for their UEs, then quite likely the SRSs by the UEs will hop in the same way and lack sufficient interference randomization.

Alternatively, another ID for cyclic shift hopping can also be introduced for higher flexibility and randomness, so that SRSs inside and outside a CJT transmission area can hop/behave in different ways even if they happen to be assigned with the same sequence/sequenceId. If comb offset hopping/cyclic shift hopping are both supported, one dedicated ID for comb offset hopping and another dedicated ID for cyclic shift hopping can be supported for better interference randomization.

To determine the cyclic shift value by the parameters for each SRS port of an SRS resource for an SRS transmission occasion, for different SRS ports in an SRS resource, for simplicity, the SRS ports can be associated with the same cyclic shift offset value for each transmission which also avoids collision. The cyclic shift offset value for each transmission can be determined by approaches described above, e.g., based on the c(i) sequence with network-configured ID for UE-specific initialization.

Potential issue on multiplexing with legacy UEs if comb offset hopping are enabled may occur. When legacy UEs and new UEs with cyclic shift hopping enabled are multiplexed on the same REs, the new UEs may hop to the cyclic shift assigned to legacy UEs and lead to collision. This collision issue can be avoided (e.g., via FDM on different PRBs/REs or TDM by gNB implementation). Code division multiplex (CDM) on the same REs is also possible, by excluding some cyclic shift values for cyclic shift hopping. For example, if a legacy UE occupies cyclic shift 0 on REs shared with a new UE, the new UE may not hop to cyclic shift 0 and may only hop to cyclic shifts 1˜7 as configured by RRC. This can be easily realized by using f(n_{s,f}^{μ}N_{symb}^{slot}+l₀+l′, c)mod 7 and then map to the allowable cyclic shift offset value set.

For SRSs orthogonalized via CDM with the same sequence and occupying the same OFDM symbols and PRBs/REs, if cyclic shift hopping is enabled, they should be configured with the same cyclic shift hopping sequence so that they hop in the same way to maintain CDM orthogonality. In other words, if cyclic shift hopping is enabled, all CDMed ports/UEs should hop in a pre-coordinated way to avoid collision.

In any case, when cyclic shift hopping/randomization is used for an SRS port, it should not lead to full collision with the same cyclic shift to another CDMed SRS port from the same UE or a different UE, which causes the orthogonal SRS ports to significantly interfere with each other and renders both ports unusable. Thus, these CDMed SRS ports should be configured with the same SRS sequence, same hopping pattern, the same ID for cyclic shift hopping, same re-initialization, and the same time-domain behavior and resource allocation (unless the hopping pattern is designed to depend on only the frame/slot/OFDM symbol locations but not UE-specific parameters). The difference between them can be the cyclic shift value configured by the network (i.e., the one if cyclic shift hopping is turned off).

Cyclic shift hopping can be applicable to periodic/semi-persistent/aperiodic SRS.

Comb offset hopping and cyclic shift hopping are compared here. Regarding granularity for hopping, for comb offset hopping, the SRS may hop on at most 2 values for comb 2, 4 values for comb 4, and 8 values for comb 8. For cyclic shift hopping, the SRS may hop on at most 8 values for comb 2, 12 values for comb 4, and 6 values for comb 8, if additional time-delay domain hopping granularity is not supported. If the additional time-delay domain hopping granularity (with the factor K>1) is supported, the SRS can hop on K times more values as described above.

Regarding multiplexing restriction, comb offset hopping leads to that an SRS port will be transmitted on multiple comb offset values. Then for each comb offset value, the SRS port should still be orthogonal with any other SRS ports via CDM. For example, if the SRS port with has 8 hops on all 8 comb offsets, then likely all SRS ports on all those REs have to have the same SRS sequence. This may be a restrictive. Cyclic shift hopping does not have such a restriction, since it is only on the same frequency-domain resources.

Thus, generally comb offset hopping may have coarser hopping granularity and more multiplexing restriction than cyclic shift hopping. If only one is to be supported, cyclic shift hopping may be utilized. However, a better way may be to support both which gives the network more choices for SRS interference randomization. Note that when both are supported, though it is possible to enable both on the same time-frequency resources for maximum benefit of interference randomization, in practice it may be easier to configure them on non-overlapping time-frequency resources to avoid complicated interactions between them. If both are supported, the initialization IDs for the hopping methods can be configured separately for them. In any case, the same hopping patterns for all the SRSs on the overlapping time/frequency resources may have to be ensured, only differentiated by their initial configured comb offsets and/or cyclic shifts. It is also possible to support a joint hopping in frequency-code domain. That is, the comb offsets and cyclic shifts configured for the joint hopping form a 2-dimensional resource grid, and a pseudo-random sequence is applied to hop from one grid point to another. To avoid collisions within the 2-dimensional resource grid due to the pseudo-random hopping, all the SRS ports configured to hop on the resource grid may use the same hopping/offset pattern, which may limit additional randomization benefit, if any, compared with the separate comb offset hopping and cyclic shift hopping. For simplicity, some embodiments may utilize separate hopping.

For comb offset hopping for SRS and for randomized code-domain resource mapping for SRS transmission via cyclic shift hopping, for each SRS port, the hopping pattern can be intra-slot/inter-slot based on a pseudo-random sequence (e.g., c(i)), and for cyclic shift hopping the time-delay domain granularity can be based on existing cyclic shifts or K times the existing cyclic shifts. Hopping can be based on slot index and symbol index, and re-initialize at the beginning of each radio frame or a radio frame according to the system frame number (SFN). A new network-configured ID for UE-specific initialization for comb offset hopping/cyclic shift hopping may be supported. When multiplexed with legacy UE, the comb offset(s) and cyclic shift(s) used the legacy UE cam be excluded for comb offset hopping/cyclic shift hopping. Comb offset hopping/cyclic shift hopping can be applicable to periodic/semi-persistent/aperiodic SRS.

To support hopping on only a subset of comb offset values, the following operations may be followed. First, the network configures M possible hopping values; (e.g., for comb 8, the configured subset for comb offset hopping of a SRS resource is S=[1,5], i.e., S(0)=1 and S(1)=5), in which case (k_{TC}^{(p}^{ᵢ}⁾+k_{offset}^{l′}) can be 1 or 5 and M=2. Second, the UE performs comb offset hopping of the associated SRS port(s) of the SRS resource within the subset. The equation can ensure multiplexed ports would not collide (i.e., differentiated by (k_{TC}^{(p}^{ᵢ}⁾)+k_{offset}^{l′}). For example, k_{offset}^{s,f,l′}=(S(c(n_{s,f}^{μ}N_{symb}^{slot}+l₀+l′))−k_{TC}^{(p}^{ᵢ}⁾)−k_{offset}^{l′}) mod K_{TC}). Alternatively, the operations may be that, first, the network configures M possible hopping values (e.g., for comb 8, the configured subset for comb offset hopping of a SRS resource is S=[1,5], i.e., S(0)=1 and S(1)=5), in which case k_{offset}^{s,f,l′} can be 1 or 5 and M=2. Second, the UE performs comb offset hopping of the associated SRS port(s) of the SRS resource within the subset, by applying k_{offset}^{s,f,l′}=(S(c(n_{s,f}^{μ}N_{symb}^{slot}+l₀+l′)))mod K_{TC} on top of (k_{TC}^{(p}^{ᵢ}⁾)+k_{offset}^{l′}). The additional offset (i.e., the hopping pattern) is common to all ports (all pᵢ's). The designs and equations are similar for cyclic shift hopping.

If a port needs to hop on more than 2 values, then the binary c(i) sequence may need further operations to generate more than 2 values. For M values in the subset S, the binary function c(n_{s,f}^{μ}N_{symb}^{slot}+l₀+l′) in the above can be generalized to (Σₘ₌₀^{M-1}2^{m}c(8n_{s,f}^{μ}N_{symb}^{slot}+8l₀+8l′))mod M. For example, S may be [1,5,6], so M=3, and the formula generates random values of 0, 1, or 2 for each SRS transmission. Then, according to S(0)=1, S(1)=5, and S(2)=6, the additional offset for hopping k_{offset}^{s,f,l′} takes values of 1, 5, or 6.

The subset is configured using a new RRC parameter which includes one or more integer values for hopping offsets. The new RRC parameter includes a list of values in the set of comb offsets/cyclic shifts for a SRS resource. The ordering of the elements in the subset may have different designs. One way is that the configured subset always has the elements in an ascending order or descending order, e.g., S={1, 5, 6}. In an embodiment, the elements are not necessarily sorted in an ascending order or descending order. The configured subset of comb offset values is ordered and the UE follows the ordering for the mapping. For example, S may be [1, 5, 6], or [5, 1, 6], etc., and they can lead to different behaviors even though the elements are identical if sorted. The elements may be unique and distinct from each other, or alternatively, identical elements in the subset may also be possible (e.g., S may be [5, 1, 6, 1] and the hopping will utilize the ordering given by the subset, i.e., S(0)=5, S(1)=1, S(2)=6, S(3)=1; or [5, 1, 1, 6], etc.). In the latter case, M may be equal to or greater than K_{TC} or n_{SRS}^{cs,max}, but to limit the complexity/overhead, it may be limited to K_{TC} or n_{SRS}^{cs,max} for comb offset hopping or cyclic shift hopping, respectively.

In an embodiment, a new RRC parameter for the subset configuration includes a bitmap for the set of comb offset/cyclic shifts. For example, in the case of comb 8, the RRC parameter combOffsetHoppingSubset can be configured via an 8-bit bitmap {0,1,0,0,0,1,1,0}. That is, S={1, 5, 6}, S(0)=1, S(1)=5, S(2)=6. The number of elements in S is at most K_{TC} or n_{SRS}^{cs,max}. The elements in the subset are unique and distinct from each other (i.e., no repetition is possible).

In an embodiment, the subset for a SRS resource is explicitly configured by legacy parameters cyclicShift and combOffset for cyclic shift hopping and comb offset hopping, respectively. In this case, the new RRC parameter is signaled to enable the subset for the hopping, and the subset is the same as the cyclicShift and combOffset values for all the SRS ports of the SRS resource. For example, if the SRS resource has 4 ports using cyclic shifts of {1, 3, 5, 7} for ports {0, 1, 2, 3}, respectively, then, when the subset for hopping is enabled, ports {0, 1, 2, 3} hop on {1, 3, 5, 7} but not on any other cyclic shifts. The RRC signaling overhead and complexity are low, but the interference randomization benefit may be limited.

To incorporate all cases for SRS cyclic shift hopping and comb offset hopping, the following hopping pattern equations can be used. Let F be the SFN, N=128, t=(F mod N)Nₛₗₒₜ^{frame,μ}N_{symb}^{slot}+n_{s,f}^{μ}N_{symb}^{slot}+l, f=S{(Σₘ₌₀⁷2^{m}c(8t+m))mod M}, and S{n} for the (n+1)st element in the set S, then:
k_{offset}^{F,s,f,l′}=f for comb offset hopping, where l=l₀+l′ if R=1 or the SRS resource is configured with combOffsetHoppingWithRepetition=Per-symbol, or l is the OFDM symbol index of the first symbol across the R repetitions if the SRS resource is configured with combOffsetHoppingWithRepetition=Per-R-Repetition;
S={0, 1, . . . , K_{TC}−1} if combOffsetHoppingSubset is not configured; otherwise S is determined based on combOffsetHoppingSubset; M=|S|; OR

$${α}_{i} = 2 π \frac{{n}_{SRS}^{cs , i}}{{n}_{SRS}^{cs , max}} + 2 π \frac{{n}_{cs offset , i}^{F , s , f , {l}^{′}}}{K \times {n}_{SRS}^{cs , max}} , {n}_{cs offset , i}^{F , s , f , {l}^{′}} = f$$

for cyclic shift hopping, where l=l₀+l′; S={0, 1, . . . , n_{SRS}^{cs,max}−1} if cyclicShiftHoppingSubset is not configured; otherwise S is determined based on cyclicShiftHoppingSubset; K=1 if cyclicShiftHoppingFinerGranularity is not configured; otherwise K is determined based on cyclicShiftHoppingFinerGranularity; M=K|S|.

In an embodiment, the configured subset of comb offset values is ordered and the UE follows the ordering for the mapping. For example, S may be [1,5,6], or [5,1,6], etc., and they can lead to different behaviors even though the elements are identical if sorted. Identical elements in the subset may also be possible (e.g., S may be [5, 1, 6, 1] or [5, 1, 1, 6], etc.).

For per-hop sequence from a long SRS sequence, SRSs generated from the same base sequence r̅_{u,v}(n) of the same base sequence length N_{ZC} (which is a prime number) and different in only the cyclic shifts are orthogonal over any integer multiple of 12 SRS subcarriers, and other than that, SRSs are generally non-orthogonal. Therefore, when an SRS with a shorter length is multiplexed with an SRS with a longer length, they are generally not orthogonal. This may lead to some issues or limitations. For example, SRS1 with FH multiplexed with SRS2 spanning on PRBs of multiple hops are not orthogonal with each other, and SRS1 with RPFS multiplexed with SRS2 spanning on PRBs of multiple partial sounding are not orthogonal with each other.

These technical issues can be remedied by using the same base sequence r̅_{u,v}(n) of the same base sequence length N_{ZC} for different SRSs, even if in an SRS transmission occasion, the SRS sequence length is shorter than N_{ZC} due to FH and/or RPFS. Then, as long as the overlapping subcarriers are an integer multiple of 12, the SRSs on the overlapping portion are orthogonal with each other. One embodiment solution to enable this is that, for FH, the parameter N_{ZC} of the SRS sequence is generated based on m_{SRS,b}_{ₕₒₚ} instead of m_{SRS,B}_{_{SRS}}, and for RPFS, the parameter N_{ZC} of the SRS sequence is generated based on m_{SRS,b}_{ₕₒₚ} (for FH) or m_{SRS,B}_{_{SRS}} (for non-FH) instead of m_{SRS,B}_{_{SRS}}/P_{F}. In other words, the per-hop or RPFS SRS sequence is extracted from a long SRS sequence.

A possible issue with this approach is the increased PAPR. The tradeoff between the higher multiplexing capacity and increased PAPR can be further discussed in this disclosure.

In some embodiments, for randomized code-domain resource mapping for SRS transmission, cyclic shift hopping/randomization with additional cyclic shift offset values according to a pseudo-random sequence, and its potential impact on multiplexing multiple SRSs; combining SRS sequence hopping and sequence group hopping; and extracting the SRS sequence from a long SRS sequence in frequency hopping and/or RPFS, and its impact on PAPR are discussed in this disclosure.

Randomized transmission of SRS was previously proposed, such as pseudo-random muting of SRS transmission for periodic and semi-persistent SRS. For P SRS or SP SRS, the interference generated by this technique is generally predictable in the time-domain, and randomization may be introduced to improve the SRS performance. A binary pseudo-random sequence may be introduced with each bit corresponding to a potential SRS transmission occasion (before the randomization is applied), and the SRS is transmitted only if the bit is 1. If more randomness is preferred, the pseudo-random sequence may further include some fractional values (between 0 and 1) and a fraction of the number PRBs are actually sounded in an SRS transmission occasion.

A possible drawback with the randomized transmission of SRS is that, the channel estimation based on SRS cannot assume a uniform pattern in time/frequency domains (i.e., at some times), SRS samples are not available on some REs. This may affect the channel estimation filter design and the performance.

In some embodiments, for randomized transmission of SRS, skipping some SRS transmission occasions or a fraction of the PRBs of some SRS transmission occasions according to a pseudo-random sequence, and its potential impact due to non-uniform time-domain SRS samples are discussed in this disclosure.

Some enhancements on per-TRP power control and/or power control of one SRS towards to multiple TRPs were proposed.

As described below on pathloss difference for TRP-common SRS and in in disclosure below, in the scenario of TRP-common SRS where there exist SRSs sent by a UE and utilized by multiple TRPs for channel estimation, the pathlosses between the UE and TRPs can be quite different, which will lead to SRS receive power imbalance at the TRP receiver. Likely, at least 6 dB to 10 dB pathloss difference needs to be handled in practical scenarios. The pathloss difference will become receive power imbalance. For example, if there is 10 dB pathloss difference, there may be about 10 dB receive power imbalance in total, at one TRP if the TRP-common SRS transmission power is set according to the pathloss of one TRP, or split in two TRPs if the TRP-common SRS transmission power is set according to the pathloss values of two TRPs (such as based on the average of the pathloss values). Which one leads to better overall CJT performance may be subject to further study.

However, if it is desirable to adjust the SRS transmission power, the standards already provide quite some flexibility. For example, if the gNB would like an SRS to be sent with a higher/lower power with a fixed amount of difference, it can set P₀ differently. If the gNB would like to change the SRS transmission power sensitivity to pathloss, it can change a value. If the gNB would like to change the SRS transmission power in one or several occasions, it can signal a TPC command which every time can change the power up to −1 dB to 3 dB.

In case when standardized approach is motivated, there could be several embodiments, as provided below. It is noted that the existing SRS power is computed as follows: P=P₀+α₁·PL₁+10 log₁₀ BW+h, where the capping by the maximum P_{CMAX} is not added here and hereafter for simplicity but should be understood as incorporated whenever the power reaches the maximum. The alpha, PL RS, and close-loop power control adjustment state are configured for the SRS resource set which are applicable to all SRS resources within the set. This is suitable for transmission to one TRP that transmits the PL RS. When multiple TRPs are present, multiple SRS resource sets, each for a TRP, may need to be configured, unless the gNB determines that one SRS is sufficient for covering the multiple TRPs for TDD CJT. Therefore, in general, M (M>=1) power control processes for M SRS resource sets are needed, where each of the M SRS resource sets is for one of the M TRPs. Each of the M power control processes is based on a different UL power control parameter set (P0, alpha, and closed loop state) associated with a different DL pathloss RS. There are some possible drawbacks for this solution. First, the number of SRS resource sets is generally at most 2 per current standards, which may be insufficient to support TDD CJT. Increasing the number of SRS resource sets is not a scalable solution since it increases the SRS overhead by multiple folds and increases the standard complexity. Second, the per-TRP SRS transmissions and near-far issue can lead to high SRS interference. This solution may not be used by some embodiments of this disclosure.

In one embodiment, for an SRS resource set, a same power control process for all SRS resources of an SRS resource set is used, where the power control process is based on one P₀ value and one closed loop state and jointly on more than one DL pathloss RS and/or more than one alpha. In other words, for the multiple TRPs for TDD CJT, there can still be only one SRS resource set with possibly one or more SRS resources, and the resource set is associated with one power control parameter set that applies to all the SRS resources. Each transmission occasion of any SRS resource in the resource set is towards multiple TRPs. Then for this embodiment, the SRS power could be P=P₀+(α₁·PL₁+α₂·PL₂)/2+10 log₁₀ BW+h, or P=P₀+(α₁+α₂)·PL/2+10 log₁₀ BW+h, or P=P₀+α·(PL₁+PL₂)/2+10 log₁₀ BW+h, for 2 TRP case, where the first needs to be configured with 2 alphas and 2 pathloss RSs, each associated with one TRP, respectively; while the second is configured with 2 alphas and 1 pathloss RS, each alpha associated with one TRP, respectively; and the third is configured with 1 alpha and 2 pathloss RSs, each RS associated with one TRP, respectively. The first one seems to better incorporate the differences in the pathloss and requirement of fractional power control for different TRPs, and hence it may be utilized. For more TRPs, this embodiment can be generalized to n DL pathloss RSs and/or n alphas, with the same power control process for all SRS resources of an SRS resource set configured with N DL pathloss RSs and N alphas, and the power control is based on P=P₀+Σₘ₌₁^{N}αn·PLₙ/N+10 log₁₀ BW+h.

In another embodiment, for an SRS resource set, more than 1 power control processes each for a subset of SRS resource of the SRS resource set, where each of the power control process is based on a different UL power control parameter set (P0, alpha, and closed loop state) associated with a different DL pathloss RS. In other words, for the multiple TRPs for TDD CJT, there can still be only one SRS resource set with multiple SRS resources, and some SRS resource(s) are associated with a UL power control parameter set (P0, alpha, and closed loop state) associated with a DL pathloss RS, and other SRS resource(s) are associated with a different UL power control parameter set (P0, alpha, and closed loop state) associated with a different DL pathloss RS. Different transmission occasions of the SRS resource set can be towards different TRPs. Then for this embodiment, the SRS power could be P₁=P_{0,1}+α₁·PL₁+10 log₁₀ BW+h₁ for TRP 1, which is for subset 1 of SRS resources, and P₂=P_{0,2}+α₂·PL₂+10 log₁₀ BW+h₂ for TRP 2, which is for subset 2 of SRS resources. For more TRPs, this embodiment can be generalized to n power control parameter sets (P0, alpha, and closed loop state), each for one TRP. Since in the current standards, all SRS resources in an SRS resource set shares the same power control parameter setting, to allow this embodiment to work, the standards need to be changed so that an SRS resource set can be associated with multiple power control parameter settings, and each SRS resource needs to be associated with one of them. As there is no reduction in the actual amount of SRS resource configuration or SRS transmissions (essentially it aggregates multiple SRS resource sets into one), this embodiment may not be utilized. This embodiment option overcomes the technical issues with limited SRS resource sets by reducing the SRS overhead/transmission/interference while still covering multiple TRPs, though more SRS resources within a SRS resource set may need to be configured.

In another embodiment, for an SRS resource set, there is more than 1 power control process and one or more SRS resources. Each SRS resource of the SRS resource set is associated with the power control processes. Each of the power control process is based on a different UL power control parameter set (P0, alpha, and closed loop state) associated with a different DL pathloss RS. In other words, for the multiple TRPs for TDD CJT, there can still be only one SRS resource set with one or more SRS resources, and all the SRS resource(s) are associated with a first UL power control parameter set (P0, alpha, and closed loop state) associated with a first DL pathloss RS, and the same SRS resource(s) are also associated with a second UL power control parameter set (P0, alpha, and closed loop state) associated with a second DL pathloss RS. Different transmission occasions of a same SRS resource can be towards different TRPs. Then for this embodiment, the SRS power could be P₁=P_{0,1}+α₁·PL₁+10 log₁₀ BW+h₁ for TRP 1 for the SRS resources, and P₂=P_{0,2}+α₂·PL₂+10 log₁₀ BW+h₂ for TRP 2, which is for the same SRS resource. For more TRPs, this embodiment can be generalized to n power control parameter sets (P0, alpha, and closed loop state), each for one TRP. Since in the current standards, all SRS resources in an SRS resource set shares the same power control parameter setting, to allow this embodiment to work, the standards need to be changed so that an SRS resource set can be associated with multiple power control parameter settings, and each SRS resource may need to be associated with all of them. This embodiment option overcomes the issues with limited SRS resource sets and resources by reducing the SRS overhead/transmission/interference while still covering multiple TRPs, though each SRS transmission may be received by the TRPs with lower power accuracy. As there is reduction in the actual amount of SRS resource configuration or SRS transmissions, this embodiment may have more advantages than the previous embodiment.

This can also be generalized to incorporate a third power control process for a third SRS resource in the SRS resource set, and the third power control process and third SRS resource are for both TRP1 and TRP2, with P_{1,2}=P₀+(α₁·PL₁+α₂·PL₂)/2+10 log₁₀ BW+h. Whether a particular SRS transmission is for TRP1 or TRP2 or both is pre-configured by the network and known to the UE, and/or indicated in MAC CE/DCI, so that the UE knows to apply the correct power control to each transmission. In general, for the embodiment techniques, the resource set is associated with m power control processes, where each of the m power control processes is configured with one UL power control parameter set (P0, alpha, and closed loop state) but one or more DL pathloss RSs. Occasions of the SRS resource set can be towards different subsets of totally M TRPs where M≥m (i.e., each of the m power control processes is for one subset of the M TRPs). For example, the SRS power could be P₁=P_{0,1}+α₁·PL₁+10 log₁₀ BW+h₁ when transmitting to TRP 1 (i.e., this transmission is a TRP-specific transmission with TRP-specific power control); and P_{2&3}=P_{0,2&3}+(α₂·PL₂+α₃·PL₃)/2+10 log₁₀ BW+h_{2&3} when transmitting to both TRP 2 and TRP 3 (i.e., this transmission is a TRP-common transmission with TRP-common power control). In summary, m (m>=1) power control processes for the SRS resource set where each of the m power control processes is configured with one P0 value, one closed loop state, and jointly on n (n>=1) DL pathloss RS(s) and/or n alphas, where n can be different for different power control processes. A transmission occasion of the SRS resource can be towards N (i.e., one or multiple) TRP(s) based on which power control process is used. Which TRPs are more suitable for TRP-specific transmission and which TRPs are more suitable for TRP-common transmission can be determined by network implementation. This embodiment also overcomes the issues with limited SRS resource sets by not increasing the number of SRS resource sets while still covering multiple TRPs. It incorporates the above two embodiments depending on network configuration, though it may slightly increase complexity. This embodiment may have more advantages than the previous three embodiments.

When the SRS resource(s) in a SRS resource set is configured with m>1 power control processes, and the resource(s) and the resource set are periodic or semi-persistent, the power control processes can be applied to the transmissions in an alternating way (i.e., for the first slot that the resource is to be transmitted, the first power control process is to be applied, and for the second slot that the resource is to be transmitted, the second power control process is to be applied, and so on). Alternatively, each resource may be configured with more than one sets of periodicity and slot offset, each set for a power control process. For aperiodic SRS resource, a DCI bit field may be used to indicate which of the power control processes need to be applied for the associated aperiodic SRS transmission.

Enhancements on SRS time domain (TD) orthogonal cover codes (OCC) were proposed and captured. In TD OCC, the same SRS on 2 or more adjacent OFDM symbols applies an orthogonal cover code such as {+1,+1}{+1,−1} and so on.

A potential advantage of the SRS TD OCC is that the SRS may be transmitted on more OFDM symbols while multiplexed with other SRS in an orthogonal way, and then on each of the multiple OFDM symbols the SRS can be transmitted with a desired power (as opposed to being ‘muted’ on some of the multiple OFDM symbols if TD OCC is not utilized). In addition, compared to SRS repetition, TD OCC may effectively average the different interference experienced by the SRS on different OFDM symbols, and hence it may work well with SRS interference randomization.

A few technical issues may need to be resolved for SRS TD OCC. Different from CSI-RS or DMRS using OCC, SRS utilizes cyclic shifts to multiplex with another SRS. If SRS TD OCC is to be supported, an approach that incorporates both cyclic shifts and TD OCC is required. Furthermore, with the SRS receive power imbalance that may occur in some CJT scenarios, the multiplexed SRSs with TD OCC may have different receive power levels, and how this affects the SRS performance may require further study.

For multi-port SRS, if the channel delay is long such as due to TRP-common SRS transmission (as the TA value may not be adjusted according to some of the TRPs according to the propagation delay in both DL reference timing and UL SRS transmission), the cyclic shifts assigned to the SRS on each OFDM symbol used by TD OCC may be more spaced out by assigning configuring multiple ports on the same cyclic shift, which may help utilize the code-domain resource more efficiently (depending on several factors such as the SRS port to cyclic shift configuration, knowledge about the channel delay at the network side, etc.). This is also useful if the channel delay spread is long for some SRS ports, then the gNB with the knowledge of the delay spread can configuring the SRS ports on fewer cyclic shifts (via assigning multiple ports on a same cyclic shift via TD OCC) so that the ports with long delay spread are overlapping, leaving more resources for other SRS transmissions. The cons of TD OCC relative to SRS repetition includes that if the SRS transmission on one OFDM symbol is dropped, then the SRS transmission with TD OCC may all be unusable, in which case to reduce power and interference, SRS on the other OFDM symbols covered by one OCC can be all dropped.

Increasing the maximum number of cyclic shifts was previously proposed and captured, including, for example, multiplying mask sequence to the legacy SRS sequence to effectively increase the maximum cyclic shifts.

In TS 38.211, the following maximum numbers of cyclic shifts are supported:

TABLE 6.4.1.4.2-1
Maximum number of cyclic shifts n_{SRS}^{cs,max}
as a function of K_{TC}.
TS 38.211
6.4.1.4 Sounding reference signal
...
6.4.1.4.2 Sequence generation

| K_{TC} | n_{SRS}^{cs,max} |
|---|---|
| 2 | 8 |
| 4 | 12 |
| 8 | 6 |

One way to increase the SRS capacity is to allow higher maximum numbers of cyclic shifts to be specified. For example, the maximum for comb 2 may be increased to 12 or 16, comb 4 may be increased to 16, and comb 8 may be increased to 12. To avoid loss of orthogonality, the increased maximum numbers may only be for FR1 and also subject to gNB decision under the scenarios of short delay spreads, such as in case of small cells and/or indoor scenarios. In general, the feasibility and potential applicable scenarios for increased maximum of cyclic shifts can be further studied in RAN1.

If the maximum number of cyclic shifts is increased for a comb, in some cases an SRS with the increased maximum should not be multiplexed on the same RE with another SRS with the legacy maximum to avoid the loss of orthogonality between them. For example, if the maximum is increased from 8 to 12 and if a legacy SRS and new SRS are multiplexed on the same RE, then the spacing between them could be as small as 1/24 of the total spacing, rather than 1/12 of the total spacing. This can also be a drawback for this potential enhancement. To avoid this technical issue, the gNB may not multiplex legacy and new SRSs on a same RE, or the gNB has to avoid configuring some cyclic shifts for the SRSs which are too close to each other, the maximum may be increased as a multiple of the legacy maximum.

In addition, the minimum SRS sequence length for each comb may need to be further examined. This can be subject to further study. Fractional cyclic shift may be utilized and still orthogonal.

Increasing the maximum number of cyclic shifts to 12 or 16, including the feasibility and potential applicable scenarios, multiplexing with legacy SRSs, and impact on minimum SRS sequence length are discussed in this disclosure.

Another potential scheme for SRS capacity enhancement is to increase the SRS comb, e.g., increase to comb 12 while not reducing the cyclic shifts per comb offset. For comb 12, if the number of cyclic shifts per comb offset can be more than 4, such as 6 or 8 or more, then the SRS capacity can be increased on the PRBs with comb 12. This is feasible for channels with short delay spread, such as CDL-C 30 ns.

For preceded SRS for DL CSI acquisition, in existing standards, SRS with usage ‘antennaSwitching’ for DL CSI acquisition is not precoded, which is similar to SRS with usage ‘codebook’ for UL CSI acquisition. Thus, for a 4-port SRS with ‘antennaSwitching’, it needs to consume 4 times resources in time/frequency/code domains as a 1-port SRS. However, if in a CJT transmission with many UEs paired, a UE may only need to support 1 or 2 layers. Therefore, if precoded SRS for DL CSI acquisition is supported, the UE may only need to sound for the 1 or 2 layers on 1 or 2 precoded ports, which can lead to significant SRS overhead reduction and increase of SRS capacity. The overhead reduction may be more pronounced for 8 (or even more) Tx SRS, if supported.

To support precoded SRS for DL CSI acquisition, precoded SRS is already supported since Rel-15. That is, SRS with usage ‘nonCodebook’ for UL CSI acquisition is precoded. As such, the potential standards support for precoded SRS for DL CSI acquisition is very similar to that for NCB SRS. Hence, it is expected that the essential standard impact for supporting precoded SRS for DL CSI acquisition is limited. To limit the standard impact and implementation complexity for potential enhancement on precoded SRS for DL CSI, this disclosure may focus on only the essential standard impact for supporting precoded SRS for DL CSI acquisition for UEs already supporting ‘nonCodebook’. For such UEs supporting ‘nonCodebook’, they already have the capability to calibrate transmit antennas for beamforming purposes. In addition, since the UEs support TDD, their transmit antennas and receive antennas are also already calibrated to ensure channel reciprocity holds well. Combining these two aspects, it seems that UEs supporting ‘nonCodebook’ and TDD should be capable of supporting precoded SRS for DL CSI acquisition, and if any additional UE antenna calibration is still needed as determined by RAN1/RAN4, the standard and implementation efforts for supporting the additional UE antenna calibration may be quite limited.

In an embodiment, for precoded SRS for DL CSI acquisition, study of whether the standardized mechanism for NCB SRS can be largely reused.

Enhanced signaling for flexible SRS transmission was previously proposed (e.g., dynamic update of SRS parameters).

In existing standardized mechanisms, most SRS parameters are specified using RRC configuration signaling, which can be quite slow and inflexible. For example, most of the time/frequency/code domain parameters for an SRS transmission are based on RRC, so even with various hopping/randomization schemes, SRS transmissions follow a quite deterministic pattern, and hence SRS interference may not have sufficient randomness. Thus, if needed, MAC CE and DCI may be enhanced to improve the flexibility of SRS parameter assignments, and the gNB can determine on the fly the best SRS transmission parameters to use and convey the decision to the UE via MAC CE or DCI.

In existing DCI design, only at most 3 bits for SRS request, at most 2 bits for SRS available offset indication, and at most 2 bits for SRS TPC command are conveyed for AP SRS transmissions. This does not provide sufficient flexibility for the gNB to control the AP SRS transmissions, and thus the AP SRS transmissions are of limited patterns and randomness.

To overcome this issue, more parameters may be signaled by the gNB in DCI. Frequency-domain parameters such as the sounding bandwidth and comb, and code-domain parameters such as the sequence identity and cyclic shifts, as well as some randomization parameters described above such as an indicator of a pseudo-randomization sequency to be used by the UE for the SRS, may be included in a DCI. This may well increase the DCI overhead, and designs such as GC-DCI or other means to reduce the DCI overhead should be considered. For example, to avoid high DCI overhead, a typical approach is to utilize MAC CE to activate/deactivate/update some parameter sets and then rely on DCI to indicate further selections based on the MAC CE. This is similar to CSI request trigger state list update by MAC CE and then up to 6 bits in DCI to select a CSI request trigger state. Another means to reduce the DCI overhead is described below.

Compared with various SRS transmissions with pre-determined pseudo-randomization schemes, data transmissions are intrinsically more random. An embodiment approach to significantly improve the SRS interference randomness and capacity is to rely more on AP SRS transmissions on an on-demand basis as soon as a data packet arrives and reduce the P/SP SRS transmissions, and the AP SRS parameters may be partially based on the associated data transmission parameters. For example, the PUSCH/PDSCH FDRA is determined based on many factors such as traffic loads, channel and interference variations, scheduler algorithms, etc., and hence the allocated bandwidth and PRB locations are highly random. Then, an AP SRS may be used for the CSI acquisition for the data transmission and hence may reuse the data transmission parameters for the SRS, such as using the PUSCH/PDSCH FDRA to determine the SRS frequency-domain resource location. Then, by proper DCI design, the SRS indication may be embedded in the PUSCH/PDSCH scheduling DCI with limited DCI overhead increase. Due to the randomness of data transmission PRB locations, the SRS transmission PRB locations will also be a bit unpredictable, and its impact on SRS-based channel estimation can be further studied.

P/SP SRS does not have sufficient randomness once configured/activated. To improve the flexibility and increase the randomness, DCI or MAC CE may be used to dynamically change/update some parameters of P/SP SRS transmissions. For example, the configured cyclic shift value α₀ may be updated by DCI/MAC once in a while, the SRS sequence ID may be updated by DCI/MAC once in a while, etc. As described above, the change of the parameters may need to be sent to not only one UE but multiple UEs with SRSs multiplexed with each other. Therefore, a group-common DCI/MAC update signaling may be provided for reduced signaling overhead.

In an embodiment, for enhanced signaling for flexible SRS transmission, AP SRS with SRS parameters indicated in DCI and its impact on DCI overhead; SRS parameters based on data transmission parameters and its impact on channel estimation; and P/SP SRS with DCI/MAC changing some parameters and its impact on DCI overhead are discussed in this disclosure.

Dynamic update of one or more of the following SRS parameters may be applied.

For frequency-domain parameter (e.g., BW change, comb change and/or hopping location change), there is no mechanism in existing standards to dynamically update SRS frequency-domain parameters, unless the different trigger states in SRS request are used for indicating different frequency-domain parameters, which is very limiting. The resulting SRS transmissions are therefore of limited patterns and randomness, even for aperiodic SRS transmissions. Consequently, improving SRS frequency-domain flexibility can be important for SRS capacity enhancement and interference randomization.

Parameters related to SRS frequency-domain resource allocation may be signaled by the gNB in MAC CE and/or DCI. However, SRS frequency-domain resource allocation may involve a lot of value choices, which may lead to high overhead. Then designs such as GC-DCI or other means to reduce the overhead should be considered. For example, to avoid high DCI overhead, a typical approach is to utilize MAC CE to activate/deactivate/update some parameter sets and then rely on DCI to indicate further selections based on the MAC CE, that is, a 3-step indication. This is similar to CSI request trigger state list update by MAC CE and then up to 6 bits in DCI to select a CSI request trigger state.

An embodiment is to dynamically change the starting RB location for RPFS via a parameter dynamically selected from a set of pre-configured parameters. This can also help randomize cross-SRS interference in frequency domain. If this is to be supported, the dynamic update signaling should be sent to a group of UEs that are multiplexed for transmission to avoid collisions between them, and updates should be applied at the same time. To realize the synchronous update by multiple UEs at the same time, a group-common DCI may be designed and utilized.

For code-domain parameters (e.g., cyclic shift/SRS sequence), similar to SRS frequency-domain parameters, there is no mechanism in existing standards to dynamically update SRS code-domain parameters. So even with SRS cyclic shift hopping based on pseudo-random sequence being under consideration, there will not be any means to change code-domain parameters on demand fast enough. Consequently, improving SRS code-domain flexibility can be important for SRS capacity enhancement and interference randomization.

Parameters related to SRS code-domain resource allocation may be signaled by the gNB in MAC CE and/or DCI. For example, two different SRS sequences (via two different SRS sequenceId) may be configured for a SRS resource, and MAC CE and/or DCI may dynamically select one of them. However, when one SRS resource changes its sequence, the SRS resources CDMed with this SRS resource from the same or other UEs also need to change their sequence synchronously to avoid collision in this transmission or future transmissions. A potential design is to configure the same sequenceIds to CDMed SRS resources from the multiple UEs, and utilize a GC-DCI to update the sequence dynamically for the SRS resources of the UEs. The update can be applied to P/SP/AP SRS.

Dynamic change of cyclic shift can also follow a similar approach via GC-DCI. However, if the cyclic shift change affects only one UE, then GC-DCI is not needed, and UE-specific DCI can be used. For example, if the gNB identifies that one cyclic shift experiences persistent collision, it may inform the UE to use a different cyclic shift.

Partial sounding can be a useful technique to enable more SRSs to be multiplexed. In Rel-17, RB-based partial frequency sounding (RPFS) was introduced. Partial frequency sounding extensions was previously proposed, such as larger partial frequency sounding factor, starting RB location hopping enhancements, partial frequency hopping on other bandwidths corresponding to b, bₕₒₚ<b<B_{SRS} besides the last bandwidth B_{SRS}.

In Rel-17, partial sounding factors PF=2 and 4 are supported. For Rel-18, other PF factors can help ease the SRS capacity crunch. Given the current SRS design, additional PF factors such as 3, 6, 8, or 12 can be considered, which is generally an extension of the Rel-17 mechanism and can significantly increase the SRS capacity.

Partial sounding may require a longer time for the UE to complete the sounding on a bandwidth. To alleviate this issue, the gNB can decide to turn on partial sounding with higher PF factors only if the frequency/temporal selectivity is not too severe. In addition, with partial sounding, the transmission power for each RE can be increased, which may offset the negative impact due to a larger PF factor.

Another issue for RPFS is that in some cases, after reducing the sounding bandwidth, the SRS sequence length becomes very short, such as shorter than the maximum number of cyclic shifts. Further study is needed. In addition, larger PF factor may not be applicable for some sequence length if the Rel-17 agreement on the sequence length is still kept:

When RPFS is configured, UE may expect the length of the SRS sequence to be a multiple of 6.

To summarize, increasing the PF factor can be an effective way to significantly reduce the cross-SRS interference via increasing the SRS capacity so that more SRSs may be multiplexed in an orthogonal way, though with some cons and some issues requiring further study. Nevertheless, whether to utilize the enhancement for a particular scenario can be up to the gNB to determine, that is, the gNB can apply the enhancement only if it deems suitable and beneficial for the scenario.

For frequency hopping with RPFS, start RB location hopping can be supported across different legacy FH periods. However, for SRS within the same FH period, e.g., with repetition factor R>1, additional start RB location hopping was discussed but not supported. Considering the need for improved interference randomization, partial sounding start RB location hopping in one FH period may be further discussed in Rel-18.

To support start RB location hopping in one FH period, note that the frequency-domain starting position k₀^{(p}^{ᵢ}⁾ is defined by

$${k}_{0}^{( {p}_{i} )} = {\overline{k}}_{0}^{( {p}_{i} )} + {n}_{offset}^{FH} + {n}_{offset}^{RPFS}$$

$$where$$

$${n}_{offset}^{RPFS} = {N}_{sc}^{RB} {m}_{SRS , {B}_{SRS}} ( ( {k}_{F} + {k}_{hop} ) mod {P}_{F} ) / {P}_{F}$$

defines the starting RB location hopping for different FH periods. One more term may be added to the equation to realize start RB location hopping in one FH period, e.g.,

$${n}_{offset}^{RPFS} = {N}_{sc}^{RB} {m}_{SRS , {B}_{SRS}} ( ( {k}_{F} + {k}_{hop} + {k}_{FH} ) mod {P}_{F} ) / {P}_{F}$$

and k_{FH} depends only on the SRS counter n_{SRS} and is selected from a pre-defined pseudo-random sequence, such as {0, 2, 1, 3}. With this simple change, each time when SRS is transmitted, the SRS counter increases by 1, and accordingly the next number in the pseudo-random sequence is selected and added to the SRS starting position value. This achieves start RB location hopping in one FH period. The same equation may also be applied to the case without FH, and hence even when FH is not enabled, some additional randomness can be possible if this scheme is adopted.

This scheme helps provide increased interference randomization benefit, but the resulting SRS samples in time/frequency domains can be quite non-uniform now, which may add complexity in the channel estimation or impact the channel estimation performance.

In Rel-17, RB-based partial frequency sounding start RB location hopping sequences were introduced. Specifically, for P_{F}=2, k_{hopping}={0, 1}, and for P_{F}=4, k_{hopping}={0, 2, 1, 3}. These hopping sequences help randomize the SRS frequency locations, but the number of sequences is very limited. In Rel-18, more hopping sequences may be considered to achieve higher interference randomization gains.

For example, P_{F}=2, k_{hopping}={1, 0} may be added as an option for gNB configuration, and it may be configured with a multiplexed RPFS SRS so that they will always occupying different PRBs. For P_{F}=4, k_{hopping}={0, 1, 2, 3} may also be added, and it may be multiplexed with other RPFS SRSs in a FDM way for all the transmissions. If P_{F}=8 is supported, k_{hopping}={0, 4, 2, 6, 1, 5, 3, 7}(which is an existing pseudo-random sequence) may be supported, or k_{hopping}={0, 1, 2, 3, 4, 5, 6, 7} may be supported.

Generally, to avoid collision of SRSs multiplexed on potentially overlapping time/frequency/code domain resources if RPFS is enabled, the gNB may need to configured all these SRSs with the same PF factor and the same hopping sequence. This requires extra coordination effort by the gNB.

In an embodiment, for partial frequency sounding extensions, Larger partial frequency sounding factor, its potential impact due to non-uniform time/frequency domain SRS samples, and its impact on minimum sequence length; Partial sounding start RB location hopping in one FH period according to a pseudo-random sequence, its potential impact due to non-uniform time/frequency domain SRS samples, and its potential impact on multiplexing multiple SRSs; and new sequences for partial sounding start RB location hopping, its potential impact due to non-uniform time/frequency domain SRS samples, and its potential impact on multiplexing multiple SRSs are discussed in this disclosure.

Some enhancements on enhanced configuration of SRS transmission to enable more efficient SRS parameter assignment were proposed (e.g., configuration of v (sequence index within a group) per SRS resource, configuration of cyclic shift per SRS port per SRS resource).

To be consistent with TS 38.211 (excerpt below), v is referred to as ‘sequence number’ as opposed to ‘sequence index’:

TS 38.211, 6.4.1.4.2

The sequence group u = (f_{gh}(n_{s,f}^{μ}, l′) + n_{ID}^{SRS}) mod 30 and
the sequence number v in clause 5.2.2 depends
on the higher-layer parameter groupOrSequenceHopping
in the SRS-Resource IE or the SRS-PosResource IE.
The SRS sequence identity n_{ID}^{SRS} is given by the higher
layer parameter sequenceId in the SRS-Resource IE,
in which case n_{ID}^{SRS} ϵ {0, 1, ... , 1023}, or the SRS-
PosResource-r16 IE, in which case n_{ID}^{SRS} ϵ {0, 1, ... , 65535}.
The quantity l′ ϵ {0,1, ... , N_{symb}^{SRS} − 1} is the OFDM symbol
number within the SRS resource.

In the current standards, v is set as 0 except if sequence hopping is configured for a long SRS sequence of an SRS resource, in which case v hops between 0 and 1 in a pseudo-random fashion. For a long SRS sequence of an SRS resource without sequence hopping, if the gNB can set the v to be 1 in some cases, it can enhance the randomness of the resulting SRS interference.

This approach seems to be rather straightforward to support, but it requires all the CDMed SRS to be configured with the same v to maintain their orthogonality. In addition, the effect of randomization may not be as obvious as sequence hopping, that is, the gNB may configure sequence hopping per SRS resource to achieve more randomness.

In the current standards, when multiple SRS ports are configured for an SRS resource, only one cyclic shift value α₀ (corresponding to n_{SRS}^{cs} configured as cyclicShift) is configured for the first port, and the cyclic shifts of the other ports are computed based on an equation depending on α₀ and the port indexes.

For all 2-port SRS and some 4-port SRS, only one comb offset is used, and the cyclic shifts are uniformly spread within the maximum cyclic shifts of that comb offset, i.e., the ports are separated as far as possible in the cyclic shift domain. In these cases, it is desirable to keep the current design as otherwise, some ports will become closer to each other in the cyclic shift domain.

For some 4-port SRS, two comb offsets are used, and the cyclic shifts are still determined by only one value, i.e., α₀, for both comb offsets. This seems quite limiting. For example, in some cases, the ports are not separated as far as possible in the cyclic shift domain for either of the comb offsets. For another example, in some cases, the ports on different comb offsets use the same cyclic shift values, increasing the PAPR of the SRS transmission. These technical issues may be addressed by introducing the capability of configuration of cyclic shift per SRS port per SRS resource. More specifically, when an SRS resource uses multiple comb offsets, one cyclic shift value should be configured for each comb offset. Then for each comb offset, the ports can be separated as far as possible based on the configured cyclic shift value. In any case, the potential impact of configuration of cyclic shift per SRS port on PAPR can be further studied, and there may need to be a restriction on the minimum separation on the cyclic shifts for an SRS resource.

In an embodiment, for enhanced configuration of SRS transmission to enable more efficient SRS parameter assignment, study the effectiveness of configuration of v (sequence number within a group) per SRS resource relative to sequence hopping per SRS resource; Configuration of cyclic shift per SRS port per SRS resource for at least SRS using more than one comb offset, its potential impact on PAPR, and the potential restriction on the minimum separation on the cyclic shifts for an SRS resource are discussed in this disclosure.

However, in some cases, non-equidistant assignment of cyclic shifts for a SRS resource may be desirable. For example, if the channel delay of some SRS is much different from that of another SRS, then the ports of the SRSs can be assigned to the same cyclic shift points of the cyclic shift space rather than mixing their cyclic shifts together. Then this configuration can be more immune to different channel delays. Also if the delay spread for a SRS resource is short, then the cyclic shifts for the ports do not have to spread so far from each other; instead, they can be located close to each other, leaving more space for SRSs with longer delay spread. On the other hand, for the above two examples to work well, the network needs to know the delays/delay spreads, but with such knowledge, it may be possible for the network to use other implementation-based methods to achieve similar effects. For another example, in some cases, the ports on different comb offsets use the same cyclic shift values, potentially increasing the PAPR of the SRS transmission in some cases. These issues may be addressed by introducing the capability of configuration of cyclic shift per SRS port per SRS resource. This may also be needed for 8 Tx SRS configuration. More specifically, when a SRS resource uses multiple comb offsets, one cyclic shift value should be configured for each comb offset. Overall, configuration of cyclic shift per SRS port per SRS resource can be beneficial in some cases.

Some enhancements on enhanced SRS transmission based on additional parameters were proposed (e.g., SRS resource mapping based on network-provided parameters (e.g., configurable indexes) or system parameters (e.g., slot index)).

Using network-provided parameters to randomize SRS transmission parameters has been widely used in the current standards. For example, the SRS sequence identity n_{ID}^{SRS} is a network-provided parameter, a configurable index, given by the higher layer parameter sequenceId in the SRS-Resource IE, in which case n_{ID}^{SRS}∈{0, 1, . . . , 1023}, or the SRS-PosResource-r16 IE, in which case n_{ID}^{SRS}∈{0, 1, . . . , 65535}. It is used as the seed in many cases, e.g., for SRS sequence hopping or SRS sequence group hopping, a pseudo-random sequence c(i) is applied and is initialized with cᵢₙᵢₜ=n_{ID}^{SRS} at the beginning of each radio frame.

The same approach can be applied to some enhancements discussed above to improve the randomization effect. For example, when a pseudo-random sequence is decided for an enhancement, a network-provided parameter (reusing the SRS sequence identity or a new parameter) may be used to pick a value (such as an initial value) from the sequence. At least the following enhancements may be relevant to this approach: further enhancements to frequency hopping (e.g., pseudo-random RE/PRB skipping within a hop); comb hopping; comb offset hopping; cyclic shift hopping/randomization; sequence hopping/randomization; randomized transmission of SRS; and RPFS starting RB location hopping enhancements, including SRS interference randomization via partial sounding start RB location hopping in one FH period, new sequences for partial sounding start RB location hopping.

Using system parameters (e.g., slot index) to randomize SRS transmission parameters has been widely used in the current standards. For example, many SRS transmission parameters are re-initialized at the beginning of each radio frame. For another example, many SRS transmission parameters depend on the OFDM symbol number within the SRS resource, often denoted as l′∈{0, 1, . . . , N_{symb}^{SRS}−1}, and as l′ changes, the SRS transmission parameters change accordingly.

The same approach can be applied to some enhancements discussed above to improve the randomization effect. For example, the slot index, the PRB index, the PUSCH RBG index, etc., may be further added to provide additional randomness. At least the following enhancements may be relevant to this approach: further enhancements to frequency hopping (e.g., pseudo-random RE/PRB skipping within a hop; comb hopping; comb offset hopping; cyclic shift hopping/randomization; sequence hopping/randomization; randomized transmission of SRS; RPFS starting RB location hopping enhancements, including SRS interference randomization via partial sounding start RB location hopping in one FH period; and new sequences for partial sounding start RB location hopping.

In more details, for the enhancements described in this subsection to work for orthogonal SRSs that the orthogonality is maintained with additional resource randomization introduced by network-provided parameters or system parameters, the SRSs may need to be assigned with the same or carefully chosen network-provided parameters or system parameters and apply the same randomization enhancements. For example, if SRS1 and SRS2 differ only in frequency-domain resources (i.e., FDMed) but may occupy the same time/code domain resources, when additional frequency-domain randomization/hopping is used for SRS1 and the resulting SRS1 frequency-domain resources may overlap with SRS2, then the gNB may need to configured the same frequency-domain randomization/hopping to SRS2 as well, and the randomization parameters may be chose to the same (so that SRS1 and SRS2 may hop in the same way) or some related values to ensure that they always occupy orthogonal frequency-domain resources. To this purpose, sometimes they will have to be configured with the same time-domain resources, i.e., some network coordination is needed.

If SRS1 and SRS2 differ only in code-domain resources (i.e., CDMed via different cyclic shifts) but may occupy the same time/frequency domain resources, when additional code-domain randomization/hopping is used for SRS1 and the resulting SRS1 code-domain resources may overlap with SRS2, then the gNB may need to configured the same code-domain randomization/hopping to SRS2 as well, and the randomization parameters may be chose to the same (so that SRS1 and SRS2 may hop in the same way) or some related values to ensure that they always occupy orthogonal code-domain resources. To this purpose, sometimes they will have to be configured with the same time-domain resources, i.e., some network coordination is needed.

In an embodiment, for resource mapping for SRS transmission based on network-provided parameters or system parameters, network updating SRS sequence identity, for at least some potential enhancements for SRS hopping/randomization; and utilizing system parameters such as OFDM symbol/slot/radio frame indexes for at least some potential enhancements for SRS hopping/randomization are discussed in this disclosure.

Many technical enhancements are described above, and there are more that were proposed or can be proposed. In this disclosure's, many of these technical enhancements can be utilized for standard support, though some require some additional study of possible issues. The issues and associated potential enhancements are summarized as follows:

Leading to non-uniform SRS sample pattern in time/frequency domain, and its impact on the SRS-based channel estimation may be studied for: pseudo-random RE/PRB skipping within a hop; comb hopping; randomized transmission of SRS; SRS parameters based on data transmission parameters; partial sounding start RB location hopping in one FH period; and new sequences for partial sounding start RB location hopping.

Potential increase of PAPR may be studied for per-hop sequence from a long SRS sequence; and configuration of cyclic shift per SRS port per SRS resource.

Requiring additional coordination among multiplexed SRSs to ensure orthogonality may be studied for: comb hopping; comb offset hopping; cyclic shift hopping; configuration of v (sequence number within a group) per SRS resource; partial sounding start RB location hopping in one FH period; and new sequences for partial sounding start RB location hopping.

Impact on the minimum SRS sequence length may be studied for: pseudo-random RE/PRB skipping within a hop; increasing the maximum number of cyclic shifts; and larger partial frequency sounding factor.

Impact on signaling overhead may be studied for: AP SRS with SRS parameters indicated in DCI; and P/SP SRS with DCI/MAC changing some parameters.

In an embodiment, for TDD CJT SRS enhancements, the following issues for relevant enhancements: leading to non-uniform SRS sample pattern in time/frequency domain, and its impact on the SRS-based channel estimation; potential increase of PAPR; requiring additional coordination among multiplexed SRSs to ensure orthogonality; impact on the minimum SRS sequence length; and impact on signaling overhead may be studied.

To support TDD CJT, some assumptions and requirements were provided by the WID and agreements from RAN1 #109-e, focused on the SRS-based CSI acquisition for TDD CJT. Below the SRS scenarios for TDD CJT taking into considerations of the assumptions and requirements are analyzed.

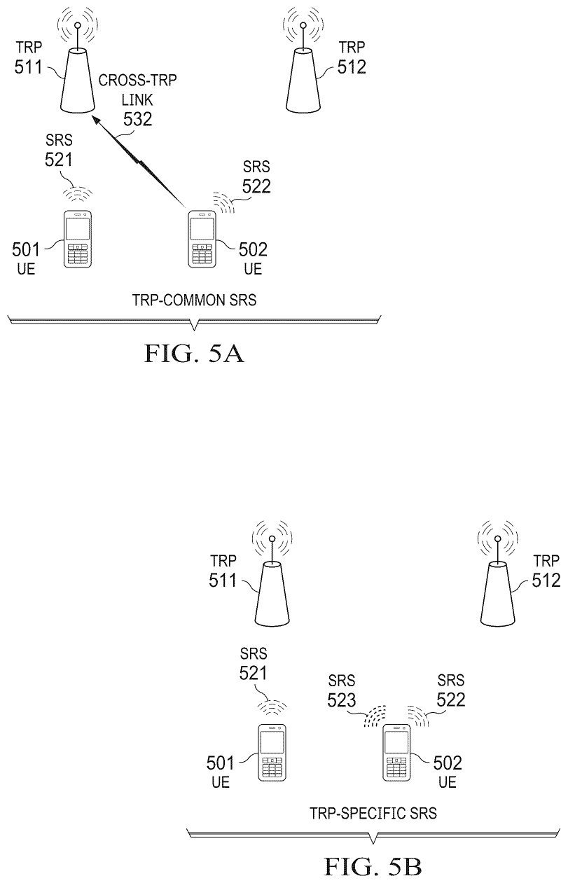

Some initial analysis of two different approaches of sending the SRS for CJT (i.e., TRP-common SRS and TRP-specific SRS) is provided herein, The two approaches are illustrated in FIG. 5.

In FIGS. 5A and 5B, 2 TRPs serving 2 UEs are shown. UE 501 is served by TRP 511 and sends SRS 521 targeting TRP 511 (i.e., the transmit power of UE 501 is set according to the propagation channel between UE 501 and TRP 511, and SRS 521 is received by TRP 511 with the desired power level.

UE 502 is a CJT UE served by TRP 511 and TRP 512. UE 502 sends at least SRS 522 targeting TRP 512, i.e., its power is set according to the propagation channel between UE 502 and TRP 512, and SRS 522 is received by TRP 512 with the desired power level.

In FIG. 5A, UE 502 sends a TRP-common SRS (i.e., SRS 522). SRS 522 is targeting TRP 512, but can also be received by TRP 511 via a cross-TRP link 532, based on which TRP 511 will estimate the channel between UE 502 and TRP 511 and use the acquired CSI for at least the DL CJT. SRS 522 may be received by TRP 511 with a power level different from that of SRS 521. The received power imbalance is due to SRS 522 NOT targeting TRP 511 (i.e., its power is NOT set according to the propagation channel between UE 502 and TRP 511).

The benefits of TRP-common SRS include reduced SRS overhead and hence reduced overall cross-SRS interference.

The possible drawbacks, however, may include the strong interference experienced by SRS 522 due to the non-negligible received power imbalance at TRP 511. This may cause difficulties in performing channel estimation for UE 501 and UE 502, especially when SRS 521 and SRS 522 are non-orthogonal and when SRS 522 received at TRP 511 via the cross-TRP link 532 is weak. The channel estimation performance highly depends on whether SRS 521 and SRS 522 can be orthogonal (which depends on SRS capacity) and how many dB weaker SRS 522 is than SRS 521 at the receiver side; see initial study below. The potential remedies may be to increase SRS capacity (to allow more orthogonal SRSs) and to improve the SRS interference randomization (to avoid persistently high interference), in addition to implementation-based approaches such as network coordination of SRS transmissions for UEs.

In FIG. 5B, UE 502 sends TRP-specific SRSs (i.e., SRS 522) to TRP 512 at a time and also SRS 523 to TRP 511 at a different time (i.e., TDMed). SRS 523 is targeting TRP 511 (i.e., its power is set according to the propagation channel between UE 502 and TRP 511, and SRS 523 is received by TRP 511 with the desired power level). Based on SRS 523, TRP 511 will estimate the channel between UE 502 and TRP 511 and use the acquired CSI for at least the DL CJT.

SRS 522 can still be received at TRP 511 via the cross-TRP link, similar to the SRS 522 in the TRP-common SRS case. That is, SRS 522 may still cause interference to SRS 521. However, TRP 511 does not need to perform channel estimation based on SRS 522.

The pros of TRP-specific SRS include the elimination of the received power imbalance at TRP 511, which may improve the channel estimation performance between UE 502 and TRP 511, and hence improve the DL CJT performance for UE 502.

The cons include increased SRS overhead and hence cross-SRS interference. A potential remedy may be to increase the SRS capacity.

As mentioned before, in the scenario of TRP-common SRS where there exist SRSs sent by a UE and utilized by multiple TRPs for channel estimation, the pathlosses between the UE and TRPs can be quite different, which will lead to SRS receive power imbalance at the TRP receiver. The power imbalance value is related to the pathloss difference. Some initial numerical study is provided in in this disclosure below, which shows that, if only 3 dB pathloss difference is allowed, then about 28% of UEs can be served by 2 TRPs, 5% of UEs can be served by 3 TRPs, and only 1% of UEs can be served by 4 TRPs. In general, the higher the percentage of UEs that can be served by 2, 3, or 4 TRPs, the better the CJT performance. Thus, allowing only 3 dB pathloss difference is quite limiting and will not deliver high CJT performance. Likely, at least 6 dB to 10 dB pathloss difference needs to be handled in practical scenarios. The pathloss difference will become receive power imbalance. For example, if there is 10 dB pathloss difference, there may be about 10 dB receive power imbalance in total (at one TRP or split in two TRPs).

For TDD CJT SRS enhancements, TRP-common SRS can reduce SRS overhead, but channel estimation for a weak link may be degraded, especially if SRSs are non-orthogonal. Potential technical solutions include increasing SRS capacity and SRS interference randomization.

TRP-specific SRS leads to higher SRS overhead and interference. Potential technical solutions include increasing SRS capacity.

For TDD CJT SRS enhancements, at least 6 dB to 10 dB pathloss difference needs to be handled in practical scenarios.

Non-orthogonal SRSs lead to significant performance degradation, especially for the weaker SRS.

Orthogonal SRSs generally have good performance; the weaker signal is a bit worse (about x dB degradation if it is x dB weaker).

SRS enhancements targeting 8 Tx has been discussed. Related to 8Tx SRS, in parallel in RAN1, agenda item 9.1.3.1 covers “Increased number of orthogonal DMRS ports; Including increasing orthogonal DMRS ports for UL/DL MU-MIMO and 8 Tx UL SU-MIMO,” and agenda item 9.1.4.2 covers “SRI/TPMI enhancement for enabling 8 TX UL transmission; To support up to 4 or more layers per UE in UL targeting CPE/FWA/vehicle/industrial devices.” It is likely that some decisions regarding the 8Tx SRS may be related to the other agenda items, and hence some alignments across the agenda items to ensure consistency may be required, or the present agenda item may need to consider some outcomes from the other agenda items. In any case, the 8 Tx SRS enhancements under consideration in the present agenda item could be sufficiently flexible/general to be potentially consistent with possible outcomes from related agenda items.

In this disclosure, 8Tx SRS enhancements are discussed for usage codebook (CB), nonCodebook (NCB), and antennaSwitching (AS), and the aspects such as the maximum number of SRS resource sets, whether to support 8 ports in one or multiple resources, whether to support 8 ports in one or multiple OFDM symbols, etc., are described. The existing designs will be first reviewed. Then which parts may be readily extended to 8 Tx SRS while which other parts may need to be updated/modified/FFS to accommodate 8 Tx SRS will be analyzed.

Regarding the number of ports of an SRS resource, some restrictions are provided in existing standards for 1/2/4 Tx SRS.

TS 38.214

```
  6.1.1.1 Codebook based UL transmission
... The transmission precoder is selected from the uplink codebook that has a number of
    antenna ports equal to higher layer parameter nrofSRS-Ports in SRS-Config, as
    defined in Clause 6.3.1.5 of [4, TS 38.211]....
6.1.1.2 Non-Codebook based UL transmission
... Only one SRS port for each SRS resource is configured. ...
  6.2.1.2 UE sounding procedure for DL CSI acquisition
  ...
      - For 1T=1R, or 2T=2R, or 4T=4R, up to two SRS resource sets each with one
      SRS resource, where the number of SRS ports for each resource is equal to 1, 2, or
      4 if the UE is not indicating a capability for [maximum 2 semi-persistent and
      maximum 1 periodic SRS resource sets], or up to two SRS resource sets
      configured with resourceType in SRS-ResourceSet set to ‘semi-persistent’ and up
      to one SRS resource set configured with resourceType in SRS-ResourceSet set to
      ‘periodic’ if the UE is indicating a capability for [maximum 2 semi-persistent and
      maximum 1 periodic SRS resource sets], where the two SRS resource sets
      configured with ‘semi-persistent’ are not activated at the same time.
```

Table 1 summarizes the existing design for the number of ports per SRS resource with up to 4 Tx SRS:

TABLE 1
Existing design for the number of ports
per SRS resource with up to 4 Tx SRS

| CB | NCB | AS with nTnR |
|---|---|---|
| nrofSRS-Ports, i.e., 1,2,4 | 1 | nrofSRS-Ports, i.e., 1,2,4 |

As shown above, NCB always has one port for an SRS resource, as each (virtualized) port corresponds to a UL transmission layer. This design can be reused for 8 Tx SRS for NCB, as already reflected in the agreement. For CB and AS, n Tx SRS supports n ports in an SRS resource, where n=1, 2, 4. This design can still be reused for 8 Tx SRS, that is, 8-port SRS resource can be supported in Rel-18. Even though 8 Tx SRS may also be supported via 2 SRS resources and each resource has 4 ports, which may be further discussed if needed, the baseline should be to support 8-port SRS resource.

In an embodiment, for 8Tx SRS, for the number of ports in an SRS resource, 1 port per SRS resource for NCB or 8 ports for an SRS resource for CB/AS may be supported.

Regarding the number of SRS resource per SRS resource set for 8 Tx SRS, some restrictions are provided in existing standards for 1/2/4 Tx SRS.

TS 38.214

```
  6.1.1.1 Codebook based UL transmission
... Except when higher layer parameter ul-FullPowerTransmission is set to
    ‘fullpowerMode2’, the maximum number of configured SRS resources for codebook
    based transmission is 2. ...
... The transmission precoder is selected from the uplink codebook that has a number of
    antenna ports equal to higher layer parameter nrofSRS-Ports in SRS-Config, as
    defined in Clause 6.3.1.5 of [4, TS 38.211]....
When higher layer parameter ul-FullPowerTransmission is set to ‘fullpowerMode2’,
...
- subject to UE capability, a maximum of 2 or 4 SRS resources are supported in an
    SRS resource set with usage set to ‘codebook’
6.1.1.2 Non-Codebook based UL transmission
... ... The maximum number of SRS resources per SRS resource set that can be
configured for non-codebook based uplink transmission is 4. ...
  6.2.1.2 UE sounding procedure for DL CSI acquisition
  ...
    - For 1T=1R, or 2T=2R, or 4T=4R, up to two SRS resource sets each with one
    SRS resource, where the number of SRS ports for each resource is equal to 1, 2, or
    4 if the UE is not indicating a capability for [maximum 2 semi-persistent and
    maximum 1 periodic SRS resource sets], or up to two SRS resource sets
    configured with resourceType in SRS-ResourceSet set to ‘semi-persistent’ and up
    to one SRS resource set configured with resourceType in SRS-ResourceSet set to
    ‘periodic’ if the UE is indicating a capability for [maximum 2 semi-persistent and
    maximum 1 periodic SRS resource sets], where the two SRS resource sets
    configured with ‘semi-persistent’ are not activated at the same time.
```

Table 2 summarizes the existing design for the number of SRS resource per SRS resource set with n ports, where n=1, 2, 4.

TABLE 2
Existing design for the number of SRS resources per
SRS resource set with n ports, where n =1, 2, 4

| CB | NCB | AS with nTnR |
|---|---|---|
| {1,2} or {1,2,3,4} for | {1,2,3,4}, i.e., up to n | 1 |
| ‘fullpowerMode2’, and {1,2} | | |
| otherwise | | |

For CB with up to 4 ports, at most 2 SRS resources per SRS resource set can be configured except for ‘fullpowerMode2’. The same maximum can be reused for the case when 8 Tx SRS is supported for CB, i.e., if ‘fullpowerMode2’ is not configured, at most 2 SRS resources per SRS resource set should still be supported for 8 Tx SRS. However, if ‘fullpowerMode2’ is configured, the maximum number of SRS resources per SRS resource set for 8 Tx SRS may depend on the UE capability/implementation, as the SRS resources may be related to some specific design of UE Tx chains, PA architecture, and/or panels. More study may be needed, and outcomes from related agenda items may be considered.

For NCB with up to 4 layers, existing design is up to 4 SRS resources per SRS resource set. The same principle can still be reused for supporting up to 8 layers, that is, in Rel-18, the maximum number of SRS resources per SRS resource set can be revised from 4 to 8 for NCB.

For AS with nTnR, existing design is 1 SRS resource per SRS resource set. This can still be reused for 8 Tx SRS.

In an embodiment, for 8Tx SRS, for the maximum number of SRS resources per SRS resource set, at least support: 2 for CB without ‘fullpowerMode2’, and FFS for CB with ‘fullpowerMode2’, 8 for NCB, or 1 for AS.

In existing design, for a UE supporting n Tx SRS, it can sound all the n ports (in 1 SRS resource or in n SRS resources) simultaneously, that is, the n ports can be sounded in 1 OFDM symbol. This can be extended to 8 Tx SRS so that the UE should be able to sound all the 8 ports in 1 OFDM symbol if appropriate design supports it. Some initial considerations related to this are discussed below.

According to the current standards, all the n ports (n=1, 2, 4) for n Tx SRS are sounded in the RBs simultaneously:

For CB/AS, the n ports are configured in 1 SRS resource, and the resource mapping guarantees that all the n ports simultaneously occupy the same RBs. The ports are multiplexed via cyclic shifts, and they use 1 comb offset (for 1 Tx, 2 Tx, and some 4 Tx) or 2 comb offsets (for some 4 Tx).

For NCB, the n ports are configured in n SRS resources in a resource set, as specified in the following. They can be multiplexed via cyclic shifts and/or comb offsets.

TS 38.214

6.1.1.2 Non-Codebook based UL transmission
... The UE shall use one or multiple SRS resources for SRS
transmission, where, in an SRS resource set, the maximum
number of SRS resources which can be configured tot he UE
for simultaneous transmission in the same symbol and the
maximum number of SRS resources are UE capabilities.
The SRS resources transmitted simultaneously occupy the
same RBs. ...

To multiplex 8 ports on the same OFDM symbol and same RBs is straightforward in most cases. For example, with comb 2, 1 comb offset with 8 different cyclic shifts or 2 comb offsets with 4 different cyclic shifts each may be used. With comb 4, 2 comb offsets with 4 different cyclic shifts or even 4 comb offsets with 2 different cyclic shifts each may be used. On the other hand, splitting the 8 ports with comb 2 or comb 4 on multiple consecutive OFDM symbols is also possible in implementation via existing mechanisms.

However, with comb 8, the maximum of 6 cyclic shifts is supported, and further details may need to be discussed:

Some ports on different comb offsets have to use the same cyclic shift. Then the PAPR may be increased (depending UE transmitter architecture). Even though the same PAPR issue exists in current standards for 4-ports with comb 8, whether Rel-18 would adopt this approach can be discussed.

The maximum number of cyclic shifts for comb 8 may be increased in Rel-18, and hence the 8 ports can use different cyclic shifts. Some pros and cons for this approach have been discussed earlier.

The 8 ports may be split on N consecutive OFDM symbols, and on each OFDM symbol, a subset of ports is sounded. However, if N=2, then 4 ports need to be sounded on each OFDM symbol with comb 8, which still has the PAPR issue for CB/AS according to existing Rel-17 design. (NCB may not have this issue based on gNB configuration of the cyclic shift for each port/resource). If N=4 or 8, there will not be such PAPR issue, but the latency may not be preferred.

Further utilization for 8 Tx SRS with comb 8 may be implemented. The standards may also consider to support the 8 ports on multiple OFDM symbols in a TDM and/or TD-OCC way (simple repetition on multiple OFDM symbols is allowed but is a different concept from what is considered here).

When 8 ports are TDMed on multiple OFDM symbols, it may require the network to configure multiple OFDM symbols in a slot (which may impact the multiplexing with other UL transmissions) or separate the OFDM symbols on different slots (which may have phase alignment issues and may prolong the time to complete the sounding of all 8 ports).

The benefit of TDMed 8 ports includes that, in some cases, each port may be sounded with higher transmission power, which improves the channel estimation performance. However, if the UE already uses full power transmission for all its PAs when 1 OFDM symbol is configured for the 8 ports, splitting the ports on different OFDM symbols will not lead to any per-port power increase.

In any case, the benefits and drawbacks for TDMed 8 ports are known to the network and the network can decide if there are sufficient benefits to utilize it. In this aspect, TDMed 8 ports can be supported.

When the 8 ports are split on N OFDM symbols, the N OFDM symbols should be adjacent to each other in one slot, and N could be 2 or 4. The case N=8 makes the ports are a bit too far from each other and is not preferred. Each port could still have the same PRB allocations.

In addition to TDM, TD OCC can also be utilized for transmitting the 8-port SRS on multiple OFDM symbols. Compared to simple repetition, TD OCC allows more ports to be transmitted on the same amount of time/frequency resources. The same restriction on N should also be applicable to TD OCC on N OFDM symbols, and on each OFDM symbol, all 8 ports should be transmitted to reduce the latency of obtaining the channels of the 8 ports.

At least support the 8-port SRS resource(s) with usage ‘codebook’, ‘nonCodebook’, or ‘antennaSwitching’ transmitted in multiple OFDM symbols where different ports are mapped to N different OFDM symbols (N=2 or 4, and the n different OFDM symbols are consecutive in 1 slot).

At least support the 8-port SRS resource(s) with usage ‘codebook’, ‘nonCodebook’, or ‘antennaSwitching’ transmitted in multiple OFDM symbols where the ports are mapped to N different OFDM symbols based on TD-OCC (N=2 or 4, and the n different OFDM symbols are consecutive in 1 slot; also 1/2/4-port SRS TD OCC may be supported).

In an embodiment, at least 8 Tx SRS on 1 OFDM symbol with comb 2 and comb 4 may be supported (e.g., FFS 8 Tx SRS with comb 8; FFS 8 Tx SRS on more than 1 OFDM symbol).

### The Maximum Number of SRS Resource Sets for 8 Tx SRS

Regarding the maximum number of SRS resource sets for 8 Tx SRS, some restrictions may be in existing standards for 1/2/4 Tx SRS.

TS 38.214

```
  6.1.1.1 Codebook based UL transmission
... Only one or two SRS resource sets can be configured in srs-
    ResourceSetToAddModList with higher layer parameter usage in SRS-ResourceSet
    set to ‘codebook’, and only one or two SRS resource sets can be configured in srs-
    ResourceSetToAddModListDCI-0-2 with higher layer parameter usage in SRS-
    ResourceSet set to ‘codebook’.
6.1.1.2 Non-Codebook based UL transmission
... Only one or two SRS resource sets can be configured in srs-
ResourceSetToAddModList with higher layer parameter usage in SRS-ResourceSet
set to ‘nonCodebook’, and only one or two SRS resource sets can be configured in srs-
ResourceSetToAddModListDCI-0-2 with higher layer parameter usage in SRS-
ResourceSet set to ‘nonCodebook’. ...
  6.2.1.2 UE sounding procedure for DL CSI acquisition
  ...
    - For 1T=1R, or 2T=2R, or 4T=4R, up to two SRS resource sets each with one
    SRS resource, where the number of SRS ports for each resource is equal to 1, 2,
    or 4 if the UE is not indicating a capability for [maximum 2 semi-persistent and
    maximum 1 periodic SRS resource sets], or up to two SRS resource sets
    configured with resourceType in SRS-ResourceSet set to ‘semi-persistent’ and
    up to one SRS resource set configured with resourceType in SRS-ResourceSet
    set to ‘periodic’ if the UE is indicating a capability for [maximum 2 semi-
    persistent and maximum 1 periodic SRS resource sets], where the two SRS
    resource sets configured with ‘semi-persistent’ are not activated at the same
    time
```

Table 3A summarizes the existing design for the number of SRS with n ports, where n=1, 2, 4.

TABLE 3A
Existing design for the number of SRS resource sets
with n ports, where n = 1,2,4

| | CB | NCB | AS with nTnR |
|---|---|---|---|
| Not for DCI 0_2 | Up to 2 for all | Up to 2 for all | Up to 2 for all |
| | P/SP/AP | P/SP/AP | P/SP/AP (except |
| For DCI 0_2 | Up to 2 for all | Up to 2 for all | for some UEs, up to |
| | P/SP/AP | P/SP/AP | 1 P and 2 SP) |

As shown above, generally up to 2 SRS resource sets per UE per usage of CB, NCB, and AS with nTnR, respectively. This is usually related to up to 2 TRPs that the UE may send SRS to. So, in a sense, each SRS resource set may correspond to a TRP. As a side note, for AS with nTmR where n and m are different, 3 or 4 AP SRS resource sets may be configured, and in such a case, different AP SRS resource sets are not corresponding to different TRPs.

The same design can be extended to the case when 8 Tx SRS is supported for CB/NCB/AS. Though in principle it could be possible to increase the number of SRS resource sets for 8 Tx SRS, e.g., combining 2 SRS resource sets for an 8 Tx SRS (while keeping M-TRP support), it may require additional design to indicate the relation between different SRS resource sets. Therefore, no change in the maximum number of SRS resource sets for 8 Tx SRS is suggested.

In an embodiment, the existing design of the maximum number of SRS resource sets for 8 Tx SRS may be reused (i.e., no change).

Summary of Important SRS Parameters with n Ports, n=1, 2, 4, 8

The above discussions on some important SRS parameters, including the number of ports per SRS resource, number of SRS resources per SRS resource set, number of OFDM symbols to sound all the n ports, and maximum number of SRS resource sets, for SRS with n ports, n=1, 2, 4, 8, are summarized in the Table 3B. As shown in Table 3B, most of these parameters for 8 Tx SRS can be set based on the principle of existing mechanisms (except for a couple of cases marked in italics in the table, which can be FFS).

TABLE 3B
Important SRS parameters with n ports, where n =1, 2, 4,8 .
Italic texts require FFS; all others are based on
existing design principle. (FPM2 = fullpowerMode2)

| | | CB | NCB | AS with nTnR |
|---|---|---|---|---|
| #ports/resource | | n (=1,2,4,8) | 1 | n (=1,2,4,8) |
| Max #resources/ | | 2 for non-FPM2; | n (=1,2, | 1 |
| set | | 2 or 4 for FPM2 for | 4,8) | |
| | | n≤4; | | |
| | | FFS FPM2 for n=8 | | |
| # OFDM symbols | | 1 (except FFS 8 Tx with comb 8) | | |
| Max # SRS | Not for | 2 for all P/SP/AP | 2 for all | 2 for all P/SP/AP |
| resource | DCI | | P/SP/AP | (except for some |
| sets | 0_2 | | | UEs, up to 1 P |
| | For | 2 for all P/SP/AP | 2 for all | and 2 SP) |
| | DCI | | P/SP/AP | |
| | 0_2 | | | |

For the usages of CB/NCB/AS, the legacy values and legacy schemes (repetition, FH, RPFS) are supported for 8 Tx SRS. The comb and cyclic shift design for 8 Tx SRS based on legacy schemes on one or more OFDM symbols (repetition, frequency hopping, partial sounding, or a combination thereof) is detailed in the following paragraphs in this disclosure.

The design of comb/comb offsets for 8 Tx SRS and the design of cyclic shifts for 8 Tx SRS are highly related. Changing one may lead to change of the other. So one way to proceed is to jointly consider them in a coupled way, but the drawback is that there could be many combinations to consider. Hence a step-by-step approach is taken. First, some high-level guidelines/considerations are provided, and then comb offsets can be decided, based on which cyclic shifts can be decided.

Generally, comb offsets and cyclic shifts assigned to a SRS resources equally spaced, respectively. However, non-equidistant cyclic shifts may be useful in some situations. For example, the 8 ports of a SRS resource may be configured on one comb offset for comb 4 with maximum of 12 cyclic shifts allowed. For another example, the 8 ports may be configured on 3 comb offsets, with 3, 3, and 2 ports on the comb offsets. These are quite nontypical and they can amount to a very large number of combinations. This disclosure will focus on the equidistant cases first and then move on to the non-equidistant ones later.

Comb and comb offsets: For comb 2, 8 ports may be put in 1 comb offset (8 cyclic shifts per comb offset) or 2 comb offsets (e.g., 4 cyclic shifts per comb offset). Both are feasible and have their respective advantages. The embodiment techniques in this disclosure support both. For comb 4, if the comb offsets for the 8 ports are equidistant, then 2 or 4 comb offsets are possible. Both are feasible and have their respective advantages. Embodiment techniques in this disclosure support both. For comb 8, if the comb offsets and cyclic shifts for the 8 ports are equidistant, then 4 or 8 comb offsets are possible. Both are feasible and have their respective advantages. The embodiment techniques in this disclosure support both.

In some embodiments, for an 8-port SRS resource in a SRS resource set with usage ‘codebook’ or ‘antennaSwitching’, for equidistant configuration of comb offset(s) and cyclic shifts, the following can be supported: 1 or 2 comb offsets for comb 2; 2 or 4 comb offsets for comb 4; 4 or 8 comb offsets for comb 8.

Cyclic shifts: for equidistant cyclic shifts, there can still be many combinations if there is no restrictions on which ports can be CDMed on the same comb offset. For example, ports 1000 and 1001, or ports 1000 and 1002, or ports 1000 and 1004, etc., out of the ports {1000, . . . , 1007}, can be CDMed on one RE. There may even be hardware/PA related considerations for which ports should be CDMed/FDMed. To reduce the complexity, some embodiments may configure the cyclic shifts for the ports only in one of the two orderings. That is, for the 8 ports 1000˜1007, the rectangular grid formed by C comb offsets in ascending order (i.e., C rows) and 8/C cyclic shifts on each comb offset (i.e., 8/C columns). Ordering 1 utilizes allocating the 8 ports in ascending order first to a row, and then across the C rows in ascending order. Ordering 2 utilizes allocating the 8 ports in ascending order first to a column, and then across the 8/C columns.

This disclosure now describes across the C comb offsets, how the cyclic shift locations are distributed. For example, the 8 ports may be staggered uniformly across the 2 comb offsets for comb 2 (in which n_CS\hat{ }max=8): comb offset 0 with {CS0, CS2, CS4, CS6}; comb offset 1 with {CS1, CS3, CS5, CS7}.

However, such a uniform distribution across the comb offsets may not be always possible. For example, for 2 comb offsets for comb 4 (in which n_CS\hat{ }max=12) (see also Tables 4 and 5): comb offset 0 with {CS0, CS3, CS6, CS9}; comb offset 2 with {CS1, CS4, CS7, CS10} or {CS2, CS5, CS8, CS11}.

Furthermore, with comb 8 (in which n_CS\hat{ }max=6), a uniform distribution across the comb offsets is impossible, and some ports on different comb offsets have to use the same cyclic shift. One example is (see also Table 6) like the following: comb offset 0 with {CS0, CS3}; comb offset 2 with {CS1, CS4}; comb offset 4 with {CS2, CS5}; comb offset 6 with {CS0, CS3}.

Considering all the above possible examples, it may be desirable to provide sufficient flexibility in the standards and leave the options open for the network configuration. The network may configure C cyclic shift locations for C comb offsets, that is, one cyclic shift location for each comb offset, and on each comb offset, the ports are uniformly distributed based on the configured cyclic shift location, similar to the legacy design.

In some embodiments, for an 8-port SRS resource in a SRS resource set with usage ‘codebook’ or ‘antennaSwitching’, for the rectangular grid formed by C comb offsets in ascending order (i.e., C rows) and 8/C cyclic shifts on each comb offset (i.e., 8/C columns), the first cyclic shift position on a comb offset is configured by the network, and the other cyclic shift positions are uniformly distributed on the comb offset. The 8 ports 1000˜1007 may be allocated in ascending order according to the following 2 orderings: Ordering 1 (first to a row, and then across the C rows in ascending order); Ordering 2 (first to a column, and then across the 8/C columns).

If, for simplicity, only one ordering is to be supported, Ordering 2 may be advantageous as it is more aligned with existing multi-comb-offset design.

In an embodiment, the 8/C cyclic shifts on each comb offset are aligned across the C comb offset, which may increase the PAPR if the 8 ports are transmitted by less than C PAs. To avoid PAPR increase, the 8/C cyclic shifts can be staggered on half or all comb offsets. The staggering on all comb offsets is similar to 4 ports with comb 4 and 2 comb offset. For example, 4 ports on comb offset 0 on CS {0, 3, 6, 9}, and the other 4 ports on comb offset 2 on CS {1, 4, 7, 10} for comb 4. For another example, 2 ports on comb offset 0 on CS {0,6}, 2 ports on comb offset 1 on CS {3,9}, 2 ports on comb offset 2 on CS {0,6}, 2 ports on comb offset 3 on CS {3,9}, for comb 4. For another example, 2 ports on comb offset 0 on CS {0,6}, 2 ports on comb offset 1 on CS {1,7}, 2 ports on comb offset 2 on CS {3,9}, 2 ports on comb offset 3 on CS {4,10}, for comb 4.

To illustrate the proposal, in Table 4, Ordering 1 and configured cyclic shift positions {CS0, CS1} for comb 4 are shown (i.e., α₀ for the first comb offset is 0, and α₀ for the comb offset is 1). In Table 5, Ordering 2 and configured cyclic shift positions {CS0, CS2} for comb 4 are shown, i.e., α₀ for the first comb offset is 0, and α₀ for the comb offset is 2. In Table 6, Ordering 2 and configured cyclic shift positions {CS0, CS1, CS2, CS0} for comb 8 are shown, i.e., α₀ for the comb offsets are 0, 1, 2, 0, respectively. For comb 2, there is no need to configure multiple cyclic shift positions unless higher flexibility is needed.

TABLE 4
Cyclic shift mapping with Ordering 1 and configured
cyclic shift positions {CS0, CS1} for comb 4

| | CS0 | CS1 | CS2 | CS3 | CS4 | CS5 | CS6 | CS7 | CS8 | CS9 | CS10 | CS11 |
|---|---|---|---|---|---|---|---|---|---|---|---|---|
| RE0 | 1000 | | | 1001 | | | 1002 | | | 1003 | | |
| RE2 | | 1004 | | | 1005 | | | 1006 | | | 1007 | |

TABLE 5
Cyclic shift mapping with Ordering 2 and configured
cyclic shift positions {CS0, CS2} for comb 4

| | CS0 | CS1 | CS2 | CS3 | CS4 | CS5 | CS6 | CS7 | CS8 | CS9 | CS10 | CS11 |
|---|---|---|---|---|---|---|---|---|---|---|---|---|
| RE0 | 1000 | | | 1002 | | | 1004 | | | 1006 | | |
| RE2 | | | 1001 | | | 1003 | | | 1005 | | | 1007 |

TABLE 6
Cyclic shift mapping with Ordering 2 and configured cyclic shift
positions {CS0, CS1, CS2, CS0} for comb 8

| | CS0 | CS1 | CS2 | CS3 | CS4 | CS5 |
|---|---|---|---|---|---|---|
| RE0 | 1000 | | | 1004 | | |
| RE2 | | 1001 | | | 1005 | |
| RE4 | | | 1002 | | | 1006 |
| RE6 | 1003 | | | 1007 | | |

For Nₐₚ^{SRS}=8, the 8 antenna ports {pᵢ}ᵢ₌0^{N}^{ₐₚ}^{^{SRS}}⁻¹ are given by pᵢ=1000+i. For comb 2, i.e., K_{TC}=2, the embodiment is as follows. The configured cyclic shift n_{SRS}^{cs}∈{0, 1, . . . , n_{SRS}^{cs,max}−1} is used to generate the cyclic shift locations according to

$${α}_{i} = 2 π \frac{{n}_{SRS}^{cs , i}}{{n}_{SRS}^{cs , max}} and {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} ,$$

where n_{SRS}^{cs,max} is the maximum number of cyclic shifts. The frequency-domain starting position term k_{TC}^{(p}^{ᵢ}⁾=(k̅_{TC}+K_{TC}/2)mod K_{TC} if pᵢ∈{1001, 1003, 1005, 1007} and n_{SRS}^{cs}∈{n_{SRS}^{cs,max}/2, . . . , n_{SRS}^{cs,max}−1}, and k_{TC}^{(p}^{ᵢ}⁾=k̅_{TC} otherwise.

For Nₐₚ^{SRS}=8, and comb 4, i.e., K_{TC}=4, the embodiment is as follows. Totally J∈{2,4} configured cyclic shifts n_{SRS}^{cs,j}∈(0, 1, . . . , n_{SRS}^{cs,max}−1) are used to generate the cyclic shift locations according to

$${α}_{i} = 2 π \frac{{n}_{SRS}^{cs , i}}{{n}_{SRS}^{cs , max}} and {n}_{SRS}^{cs , i} = ( {n}_{SRS}^{cs} + \frac{{n}_{SRS}^{cs , max} ⌊ ( {p}_{i} - 1000 ) / J ⌋}{{N}_{ap}^{SRS} / J} ) mod {n}_{SRS}^{cs , max} , where j = 0 for {p}_{i} ∈ \{ 1000 , 1000 + J , 1000 + 2 J , … , 1000 + ( \frac{{N}_{ap}^{SRS}}{J} - 1 ) J \} and j = 1 for {p}_{i} ∈ \{ 1000 + 1 , 1000 + J + 1 , 1000 + 2 J + 1 , 1000 + ( \frac{{N}_{ap}^{SRS}}{J} - 1 ) J + 1 \} ,$$

and so on, for the J comb offsets. The frequency-domain starting position term k_{TC}^{(p}^{ᵢ}⁾=(k̅_{TC}+K_{TC}/J+j)mod K_{TC} for these ports. The equations can be extended to comb 8 and 4 comb offsets configured.

Finally, non-equidistant cyclic shifts and comb offsets can be supported. For an 8-port SRS resource in a SRS resource set with usage ‘codebook’ or ‘antennaSwitching’, non-equidistant configuration of comb offset(s) and/or cyclic shifts. The 8 ports (or even n>8, i.e., more than 8 ports in future releases) in a SRS resource may be distributed on 1 through K_{TC} comb offsets, and on each of the comb offsets, there could be 1 or more (up to n or the maximum number of CS in that comb offset) cyclic shifts allocated. The number of the comb offsets with a port can be 3, 5, etc., which does not have to divide n or K_{TC}, and the comb offsets do not have to be equally spaced. On each comb offset, the ports do not have to be equally spaced, and different comb offsets can have different numbers of ports for the SRS resource. The cyclic shifts may be configured on a per-port basis, or on a per-comb-offset basis.

When the 8 ports are configured with m OFDM symbols, the m OFDM symbols may be adjacent to each other in one slot, m being 2, 4, 8, 10, 12, 14. A clarification here is that m should not be interpreted as the TDM splitting factor, since the TDM scheme may still be enabled together with repetition, frequency hopping, and/or RPFS. To differentiate, denote the TDM splitting factor as s, and s should be 2 or 4, and s=8 may also be supported. Also m should be divisible by s for simplicity.

On each of the m OFDM symbols, there should be exactly 8/s ports. The ports TDMed on the s consecutive OFDM symbols should be different but have the same PRB/comb offset allocations, regardless of frequency hopping being enabled or not. For example, for the ports {1000, . . . , 1007}TDMed with s=2, the first symbol may have ports {1000, 1001, 1004, 1005}, and the second symbol may have ports {1002, 1003, 1006, 1007}, and on each symbol, the 4 ports are allocated to the physical resources and cyclic shift positions according to the legacy 4-port SRS mechanism. The consideration is based on coherent port group. For codebook design of an 8TX partial-coherent UE, configured with an 8-port SRS resource, when Ng=2, two coherent groups of {0, 1, 4, 5} and {2, 3, 6, 7}; when Ng=4, four coherent groups of {0,4}, {1,5}, {2,6}, and {3,7}. Therefore, to be consistent, port mapping within a set of s OFDM symbols can be split according to the coherent groups if applicable.

A few detailed embodiment designs include:

The ports may be split into {1000, 1002, 1004, 1006} and {1001, 1003, 1005, 1007} or other ways on different comb offsets. Whether the different ways of splitting are substantial or not may depend on the UE implementation. For simplicity, only one splitting may be adopted, such as {1000, . . . , 1003} and {1004, . . . , 1007}. If necessary, one more splitting may also be supported. In general, the ordering may be similar to that discussed for comb offsets and cyclic shifts mapping ordering, and at most 2 orderings may be supported, i.e., first mapping 8/s consecutive ports to an OFDM symbol and then going to the next OFDM symbol, or first mapping s consecutive ports to s OFDM symbols and then going to the next s consecutive ports to the s OFDM symbols.

To map the ports on an OFDM symbol to the cyclic shift positions, the port indexes may be remapped to reuse the legacy 4-port equations. For example, {1001, 1003, 1005, 1007} may be remapped to {1000′, 1001′, 1002′, 1003′} and use the 4-port cyclic shift mapping. This may be done using an equation pᵢ′=└pᵢ/s┘ where pᵢ=1000+i for the 8 ports, and pᵢ′ is to be used in existing cyclic shift equations as pᵢ in the equation

$${n}_{SRS}^{cs , i} = \{ \begin{matrix}( {n}_{SRS}^{cs} + \frac{{n}_{SRS}^{cs , max} ⌊ ( {p}_{i} - 1000 ) / 2 ⌋}{{N}_{ap}^{SRS} / 2} ) mod {n}_{SRS}^{cs , max} & if {N}_{ap}^{SRS} = 4 and {n}_{SRS}^{cs , max} = 6 \\ ( {n}_{SRS}^{cs} + \frac{{n}_{SRS}^{cs , max} ( {p}_{i} - 1000 )}{{N}_{ap}^{SRS}} ) & otherwise\end{matrix} in 3 GPP TS 38.211 .$$

If repetition, frequency hopping, and/or RPFS is also enabled, the 8 ports should be transmitted on consecutive OFDM symbols as a bundle. For example, for the ports {1000, . . . , 1007} configured with m=4 OFDM symbols, s=2, and 2 times repetition, on the 4 adjacent OFDM symbols, the transmissions should be {1000, . . . , 1003}, {1004, . . . , 1007}, {1000, . . . , 1003}, {1004, . . . , 1007}. That is, repetition or hopping should be done after the 8 ports are all sounded in a bundle. The other ordering, i.e., {1000, . . . , 1003}, {1000, . . . , 1003}, {1004, . . . , 1007}, {1004, . . . , 1007}, is also possible, but with slightly less time-domain diversity for each port. If the repetition factor is R, then it may be advantageous to have m divisible by s*R. The existing equations in 3GPP TS 38.211 and 3GPP TS 38.214 with N_{symb}^{SRS} will be changed to N_{symb}^{SRS}/s, where N_{symb}^{SRS} is the m here. For example

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋$$

is changed to

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{sR} ) + ⌊ \frac{{l}^{′}}{sR} ⌋$$

for periodic or semi-persistent SRS, and n_{SRS}=└l′/R┘ is changed to n_{SRS} └l′/(sR)┘ for aperiodic SRS.

TABLE 7
An 8-port SRS resource configured with TDM splitting factor 2 on 8
OFDM symbols, with 4 times repetition

| | OS0 | OS1 | OS2 | OS3 | OS4 | OS5 | OS6 | OS7 |
|---|---|---|---|---|---|---|---|---|
| Ports | 1000, 1001, | 1002, 1003, | 1000, 1001, | 1002, 1003, | 1000, 1001, | 1002, 1003, | 1000, 1001, | 1002, 1003, |
| used | 1004, 1005 | 1006, 1007 | 1004, 1005 | 1006, 1007 | 1004, 1005 | 1006, 1007 | 1004, 1005 | 1006, 1007 |
| Remap | 1000′~1003′ | 1000′~1003′ | 1000′~1003′ | 1000′~1003′ | 1000′~1003' | 1000′~1003′ | 1000′~1003′ | 1000′~1003′ |
| (if needed) | | | | | | | | |

In some embodiments, for an 8-port SRS resource in a SRS resource set with usage ‘codebook’ or ‘antennaSwitching’, configured with TDM splitting factor s≥1 and resource mapping of m≥2 OFDM symbols, m=2, 4, 8, 10, 12, 14 and s=1, 2, 4 can be supported, where m is a multiple of s. The 8 ports are split on s adjacent OFDM symbols, and each symbol has p=8/s different ports. On each OFDM symbol, the resource mapping reuses the existing p-port mapping, with ports {1000, . . . , 1000+p−1} on the first symbol, {1000+p, . . . , 1000+2p−1} on the second symbol, etc., and the ports are remapped to {1000′, . . . , (1000+p−1)′} on each symbol for cyclic shift mapping. When s=1, then TDM is not enabled.

An embodiment method includes: receiving, by a user equipment (UE), control information for a first sounding reference signal (SRS) resource, the control information indicating at least a first frequency resource in a carrier, a frequency-domain shift parameter, a partial sounding factor (PF) value, and a frequency-domain offset value; and transmitting, by the UE, based on the control information, the first SRS resource on a first partial frequency sounding resource within the first frequency resource in the carrier, wherein a resource starting physical resource block (PRB) of the first frequency resource is in accordance with the frequency-domain shift parameter, wherein a bandwidth of the first partial frequency sounding resource is based on at least the PF value and a bandwidth of the first frequency resource, and wherein a partial frequency sounding resource starting PRB of the first partial frequency sounding resource is based at least on the resource starting PRB of the first frequency resource and the frequency-domain offset value.

SRS may collide with other transmission and may be dropped. The existing baseline for SRS collision handling is to drop SRS transmission on a per-symbol basis. This works well for non-TDMed SRS resource. For TDMed SRS ports, however, if the transmission within one group of {1, 2, . . . , s} is dropped on an OFDM symbol, then it is possible that the rest of the SRS transmissions in the group may not be useful to the gNB, especially when the dropped port(s) and other port(s) are in one coherent group. In addition, for subsequent PUSCH transmission relying on the SRS resource with usage codebook, when some ports of the SRS resource are dropped and others are transmitted, it may be unclear what the SRI is referring to.

To solve these technical issues, one approach would be to drop all transmissions within the group of {1, 2, . . . , s} upon the dropping of any of them. If more “precision” is desired, the UE can drop all transmissions within a coherent group of ports for usage set as ‘codebook’ upon the dropping of any of them, and across different coherent groups, the dropping can be independently decided.

More complicated optimization can also be considered. In fact, when SRS repetition is configured, dropping on one OFDM symbol would not affect the gNB's capability of estimating the channel for each port. Within the m OFDM symbols configured for the SRS resource in a slot, as long as one complete set of the 8 ports can be transmitted, there is no need to drop the entire group(s) of {1, 2, . . . , s}. Moreover, the UE can decide to swap the transmissions of some ports based on the dropping which can help preserve the sounding of all 8 ports. The gNB and the UE know the dropping and swapping, so there is no issue with the network and UE being “out of sync.” However, the approach is much more complicated and may not be preferred by UE/network vendors.

Proposal 7: For an 8-port SRS resource in a SRS resource set with usage ‘codebook’ or ‘antennaSwitching’ and with TDM factor s=2, when the s subsets of ports are mapped onto m≥2 OFDM symbols in a slot according to the pattern {{1, 2, . . . , s}, . . . , {1, 2, . . . , s}}(totally m/s groups of {1, 2, . . . , s}), and when the SRS transmission on a subset of the s OFDM symbols within a group of {1, 2, . . . , s} is dropped:
If m/s=1, UE drops the SRS transmission on the rest of OFDM symbols within the group of {1, 2, . . . , s}.

If m/s>1, if a complete set of the 8 ports can be transmitted on the OFDM symbols not affected by the dropping, then UE transmits the SRS on the rest of m OFDM symbols; otherwise, UE drops the SRS transmission on all the m OFDM symbols.

If comb offset hopping is configured for the SRS resource with TDM, when multiple groups of {1, 2, . . . , s} are transmitted in a slot, across the groups the hopping pattern can follow the configuration combOffsetHoppingWithRepetition=Per-R-Repetition or combOffsetHoppingWithRepetition=Per-symbol. Within each group of {1, 2, . . . , s}, there can be hopping or non-hopping. With hopping, it is easier to allow multiplexing with other SRS, but without hopping, it may simplify UE/gNB behavior. There are a few options.
Option 1: the time-domain behavior of cyclic shift hopping and/or comb offset hopping depends on the OFDM symbol index l′ of each symbol.
Option 2: the time-domain behavior of cyclic shift hopping and/or comb offset hopping depends on the OFDM symbol index l′ of the first of the m OFDM symbol if HoppingWithRepetition=Per-R-Repetition (or the first of the s OFDM symbol).
Option 3: do not support cyclic shift hopping or comb offset hopping for 8-port SRS.

For a given SRS resource, the UE is configured with repetition factor R∈{1, 2, 4} or R∈{1, 2, 3, 4, 5, 6, 7, 8, 10, 12, 14} by higher layer parameter resourceMapping in SRS-Resource where R≥Nₛ/s, where s=2 if the higher-layer parameter related to s is configured; otherwise s=1. When frequency hopping within an SRS resource in each slot is not configured and comb offset hopping is not configured and s=1 (R=Nₛ), each of the antenna ports of the SRS resource in each slot is mapped in all the Nₛ symbols to the same set of subcarriers in the same set of PRBs. When frequency hopping within an SRS resource in each slot is not configured and comb offset hopping is not configured and s=2 (R=N_{s/s}), antenna ports {1000, 1001, 1004, 1005} of the SRS resource in each slot is mapped in half of the Nₛ symbols and antenna ports {1000, 1002, 1004, 1006} of the SRS resource in each slot is mapped in the other half of the Nₛ symbols to the same set of subcarriers in the same set of PRBs according to clause 6.4.1.4.2 of [TS 38.211]. When frequency hopping within an SRS resource in each slot is not configured and comb offset hopping is configured and s=1 (R=Nₛ), each of the antenna ports of the SRS resource in each slot is mapped in all the Nₛ symbols to the subcarriers in the same set of PRBs according to clause 6.4.1.4.3 of [TS 38.211]. When frequency hopping within an SRS resource in each slot is configured without repetition (R=1), according to the SRS hopping parameters Bₛᵣₛ, Cₛᵣₛ and bₕₒₚ defined in clause 6.4.1.4 of [4, TS 38.211], each of the antenna ports of the SRS resource in each slot is mapped to different sets of subcarriers in each OFDM symbol, where the same transmission comb value is assumed for different sets of subcarriers. When both frequency hopping and repetition within an SRS resource in each slot are configured (Nₛ≥4, R≥2), each of the antenna ports of the SRS resource in each slot is mapped to the same set of subcarriers within each set of sR adjacent OFDM symbols, and frequency hopping across the Nₛ/sR sets is according to the SRS hopping parameters Bₛᵣₛ, Cₛᵣₛ and bₕₒₚ, where Nₛ should be divisible by R.

For operation with shared spectrum channel access in FR1, the UE does not expect that multiple hops of an SRS resource transmission are in different RB sets.

A UE may be configured Nₛ=2, 4, 8, 10, 12, or 14 adjacent symbol aperiodic SRS resource with intra-slot frequency hopping within a bandwidth part, where the full hopping bandwidth is sounded with an equal-size subband across Nₛ symbols when frequency hopping is configured with R=1. A UE may be configured Nₛ≥4 adjacent symbols aperiodic SRS resource with intra-slot frequency hopping within a bandwidth part, where the full hopping bandwidth is sounded with an equal-size subband across Nₛ/sR sets of sR adjacent OFDM symbols, when frequency hopping is configured with R≥2, Nₛ≥R and Nₛ should be divisible by sR. Each of the antenna ports of the SRS resource is mapped to the same set of subcarriers within each set of sR adjacent OFDM symbols of the resource if comb offset hopping is not configured.

A UE may be configured Nₛ=1 symbol periodic or semi-persistent SRS resource with inter-slot hopping within a bandwidth part, where the SRS resource occupies the same symbol location in each slot. A UE may be configured Nₛ=2, 4, 8, 10, 12, or 14 symbol periodic or semi-persistent SRS resource with intra-slot and inter-slot hopping within a bandwidth part, where the SRS resource occupies the same symbol location(s) in each slot. For Nₛ≥4, when frequency hopping is configured with R≥2, intra-slot and inter-slot hopping is supported with each of the antenna ports of the SRS resource mapped to different sets of subcarriers across Nₛ/sR sets of sR adjacent OFDM symbol(s) of the resource in each slot, where Nₛ should be divisible by sR. Each of the antenna ports of the SRS resource is mapped to the same set of subcarriers within each set of sR adjacent OFDM symbols of the resource in each slot. For Nₛ=sR, when frequency hopping is configured, inter-slot frequency hopping is supported with each of the antenna ports of the SRS resource mapped to the same set of subcarriers in R adjacent OFDM symbol(s) of the resource in each slot if comb offset hopping is not configured.

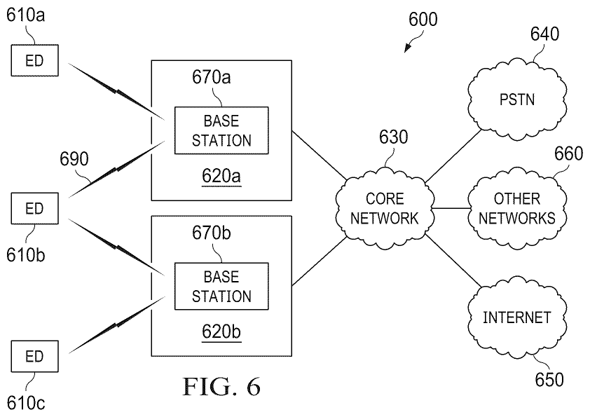

FIG. 6 illustrates an example communication system 600. In general, the system 600 enables multiple wireless or wired users to transmit and receive data and other content. The system 600 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 600 includes electronic devices (ED) 610a-610c, radio access networks (RANs) 620a-620b, a core network 630, a public switched telephone network (PSTN) 640, the Internet 650, and other networks 660. While certain numbers of these components or elements are shown in FIG. 6, any number of these components or elements may be included in the system 600.

The EDs 610a-610c are configured to operate or communicate in the system 600. For example, the EDs 610a-610c are configured to transmit or receive via wireless or wired communication channels. Each ED 610a-610c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 620a-620b here include base stations 670a-670b, respectively. Each base station 670a-670b is configured to wirelessly interface with one or more of the EDs 610a-610c to enable access to the core network 630, the PSTN 640, the Internet 650, or the other networks 660. For example, the base stations 670a-670b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 610a-610c are configured to interface and communicate with the Internet 650 and may access the core network 630, the PSTN 640, or the other networks 660.

In the embodiment shown in FIG. 6, the base station 670a forms part of the RAN 620a, which may include other base stations, elements, or devices. Also, the base station 670b forms part of the RAN 620b, which may include other base stations, elements, or devices. Each base station 670a-670b operates to transmit or receive wireless signals within a particular geographic region or area, sometimes referred to as a “cell.” In some embodiments, multiple-input multiple-output (MIMO) technology may be employed having multiple transceivers for each cell.

The base stations 670a-670b communicate with one or more of the EDs 610a-610c over one or more air interfaces 690 using wireless communication links. The air interfaces 690 may utilize any suitable radio access technology.

It is contemplated that the system 600 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 620a-620b are in communication with the core network 630 to provide the EDs 610a-610c with voice, data, application, Voice over Internet Protocol (VoIP), or other services. Understandably, the RANs 620a-620b or the core network 630 may be in direct or indirect communication with one or more other RANs (not shown). The core network 630 may also serve as a gateway access for other networks (such as the PSTN 640, the Internet 650, and the other networks 660). In addition, some or all of the EDs 610a-610c may include functionality for communicating with different wireless networks over different wireless links using different wireless technologies or protocols. Instead of wireless communication (or in addition thereto), the EDs may communicate via wired communication channels to a service provider or switch (not shown), and to the Internet 650.

Although FIG. 6 illustrates one example of a communication system, various changes may be made to FIG. 6. For example, the communication system 600 could include any number of EDs, base stations, networks, or other components in any suitable configuration.

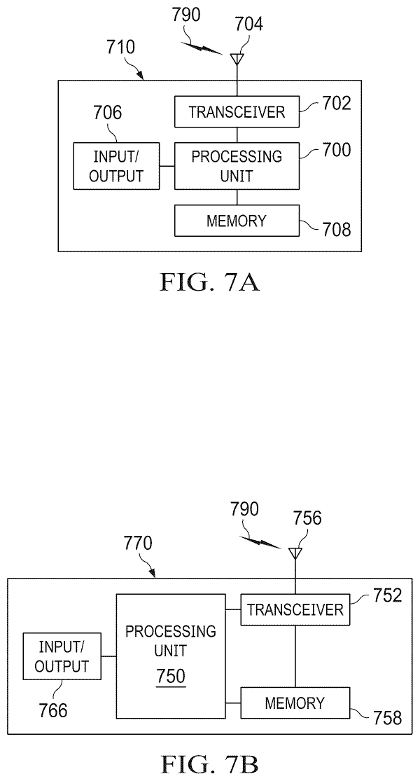

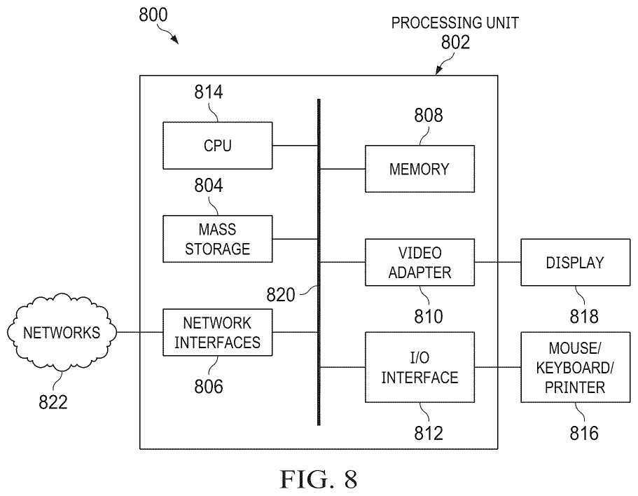

FIGS. 7A and 7B illustrate example devices that may implement the methods and teachings according to this disclosure. In particular, FIG. 7A illustrates an example ED 710, and FIG. 7B illustrates an example base station 770. These components could be used in the system 600 or in any other suitable system.

As shown in FIG. 7A, the ED 710 includes at least one processing unit 700. The processing unit 700 implements various processing operations of the ED 710. For example, the processing unit 700 could perform signal coding, data processing, power control, input/output processing, or any other functionality enabling the ED 710 to operate in the system 600. The processing unit 700 also supports the methods and teachings described in more detail above. Each processing unit 700 includes any suitable processing or computing device configured to perform one or more operations. Each processing unit 700 could, for example, include a microprocessor, microcontroller, digital signal processor, field programmable gate array, or application specific integrated circuit.

The ED 710 also includes at least one transceiver 702. The transceiver 702 is configured to modulate data or other content for transmission by at least one antenna or NIC (Network Interface Controller) 704. The transceiver 702 is also configured to demodulate data or other content received by the at least one antenna 704. Each transceiver 702 includes any suitable structure for generating signals for wireless or wired transmission or processing signals received wirelessly or by wire. Each antenna 704 includes any suitable structure for transmitting or receiving wireless or wired signals. One or multiple transceivers 702 could be used in the ED 710, and one or multiple antennas 704 could be used in the ED 710. Although shown as a single functional unit, a transceiver 702 could also be implemented using at least one transmitter and at least one separate receiver.

The ED 710 further includes one or more input/output devices 706 or interfaces (such as a wired interface to the Internet 650). The input/output devices 706 facilitate interaction with a user or other devices (network communications) in the network. Each input/output device 706 includes any suitable structure for providing information to or receiving information from a user, such as a speaker, microphone, keypad, keyboard, display, or touch screen, including network interface communications.

In addition, the ED 710 includes at least one memory 708. The memory 708 stores instructions and data used, generated, or collected by the ED 710. For example, the memory 708 could store software or firmware instructions executed by the processing unit(s) 700 and data used to reduce or eliminate interference in incoming signals. Each memory 708 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 7B, the base station 770 includes at least one processing unit 750, at least one transceiver 752, which includes functionality for a transmitter and a receiver, one or more antennas 756, at least one memory 758, and one or more input/output devices or interfaces 766. A scheduler, which would be understood by one skilled in the art, is coupled to the processing unit 750. The scheduler could be included within or operated separately from the base station 770. The processing unit 750 implements various processing operations of the base station 770, such as signal coding, data processing, power control, input/output processing, or any other functionality. The processing unit 750 can also support the methods and teachings described in more detail above. Each processing unit 750 includes any suitable processing or computing device configured to perform one or more operations. Each processing unit 750 could, for example, include a microprocessor, microcontroller, digital signal processor, field programmable gate array, or application specific integrated circuit.

Each transceiver 752 includes any suitable structure for generating signals for wireless or wired transmission to one or more EDs or other devices. Each transceiver 752 further includes any suitable structure for processing signals received wirelessly or by wire from one or more EDs or other devices. Although shown combined as a transceiver 752, a transmitter and a receiver could be separate components. Each antenna 756 includes any suitable structure for transmitting or receiving wireless or wired signals. While a common antenna 756 is shown here as being coupled to the transceiver 752, one or more antennas 756 could be coupled to the transceiver(s) 752, allowing separate antennas 756 to be coupled to the transmitter and the receiver if equipped as separate components. Each memory 758 includes any suitable volatile or non-volatile storage and retrieval device(s). Each input/output device 766 facilitates interaction with a user or other devices (network communications) in the network. Each input/output device 766 includes any suitable structure for providing information to or receiving/providing information from a user, including network interface communications.

FIG. 8 is a block diagram of a computing system 800 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 800 includes a processing unit 802. The processing unit includes a central processing unit (CPU) 814, memory 808, and may further include a mass storage device 804, a video adapter 810, and an I/O interface 812 connected to a bus 820.

The bus 820 may be one or more of any type of several bus architectures including a memory bus or memory controller, a peripheral bus, or a video bus. The CPU 814 may comprise any type of electronic data processor. The memory 808 may comprise any type of non-transitory system memory such as static random access memory (SRAM), dynamic random access memory (DRAM), synchronous DRAM (SDRAM), read-only memory (ROM), or a combination thereof. In an embodiment, the memory 808 may include ROM for use at boot-up, and DRAM for program and data storage for use while executing programs.

The mass storage 804 may comprise any type of non-transitory storage device configured to store data, programs, and other information and to make the data, programs, and other information accessible via the bus 820. The mass storage 804 may comprise, for example, one or more of a solid state drive, hard disk drive, a magnetic disk drive, or an optical disk drive.

The video adapter 810 and the I/O interface 812 provide interfaces to couple external input and output devices to the processing unit 802. As illustrated, examples of input and output devices include a display 818 coupled to the video adapter 810 and a mouse, keyboard, or printer 816 coupled to the I/O interface 812. Other devices may be coupled to the processing unit 802, and additional or fewer interface cards may be utilized. For example, a serial interface such as Universal Serial Bus (USB) (not shown) may be used to provide an interface for an external device.

The processing unit 802 also includes one or more network interfaces 806, which may comprise wired links, such as an Ethernet cable, or wireless links to access nodes or different networks. The network interfaces 806 allow the processing unit 802 to communicate with remote units via the networks. For example, the network interfaces 806 may provide wireless communication via one or more transmitters/transmit antennas and one or more receivers/receive antennas. In an embodiment, the processing unit 802 is coupled to a local-area network 822 or a wide-area network for data processing and communications with remote devices, such as other processing units, the Internet, or remote storage facilities.

A way to increase the network resources is to utilize more usable spectrum resources, which include not only the licensed spectrum resources of the same type as the macro, but also the licensed spectrum resources of different type as the macro (e.g., the macro is a FDD cell but a small cell may use both FDD and TDD carriers), as well as unlicensed spectrum resources and shared-licensed spectrums. Some of the spectrum resources lie in high-frequency bands, such as 6 GHz to 60 GHz. The unlicensed spectrums may be used by generally any user, subject to regulatory requirements. The shared-licensed spectrums are also not exclusive for an operator to use. Traditionally, the unlicensed spectrums are not used by cellular networks because it is generally difficult to ensure quality of service (QoS) requirements. Operating on the unlicensed spectrums mainly includes wireless local area networks (WLAN), e.g., the Wi-Fi networks. Due to the fact that the licensed spectrum is generally scarce and expensive, utilizing the unlicensed spectrum by the cellular operator may be considered. Note that on high-frequency bands and unlicensed/shared-licensed bands, typically TDD is used and hence the channel reciprocity can be exploited for the communications.

In a realistic deployment, a gNB may control one or more cells. Multiple remote radio units may be connected to the same base band unit of the gNB by fiber cable, and the latency between base band unit and remote radio unit is quite small. Therefore, the same base band unit can process the coordinated transmission/reception of multiple cells. For example, the gNB may coordinate the transmissions of multiple cells to a UE, which is called coordinated multiple point (CoMP) or multi-TRP (mTRP, M-TRP) transmission. The gNB may also coordinate the reception of multiple cells from a UE, which is called CoMP/M-TRP reception. In this case, the backhaul link between these cells with the same gNB is fast backhaul and the scheduling of data transmitted in different cells for the UE can be easily coordinated in the same gNB. The backhaul connections may also be ones with longer latency and lower transmission rates.

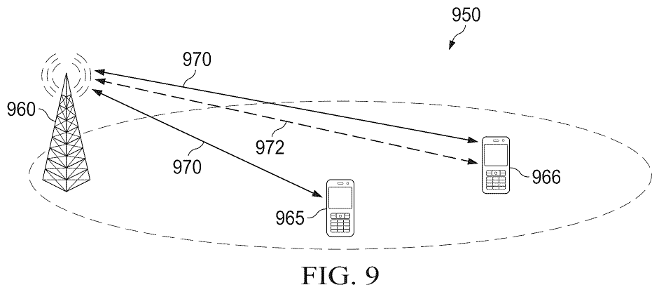

FIG. 9 illustrates the use of carrier aggregation (CA), which is another deployment strategy. As shown in FIG. 9, system 950 is a typical wireless network configured with carrier aggregation (CA) where communications controller 960 communicates to wireless device 965 using wireless link 970 (solid line) and to wireless device 966 using wireless link 972 (dashed line) and using wireless link 970, respectively. In some example deployments, for wireless device 966, wireless link 970 can be called a primary component carrier (PCC) while wireless link 972 can be called a secondary component carrier (SCC). In some carrier aggregation deployments, the PCC can carry feedback from a UE device to a communications controller while the SCC can only carry data traffic. In the 3GPP specifications, a component carrier is called a cell. When multiple cells are controlled by a same eNB, cross scheduling of multiple cells can be implemented because there may be a single scheduler in the same eNB to schedule the multiple cells. With CA, one eNB may operate and control several component carriers forming primary cell (PCell) and secondary cell (SCell).

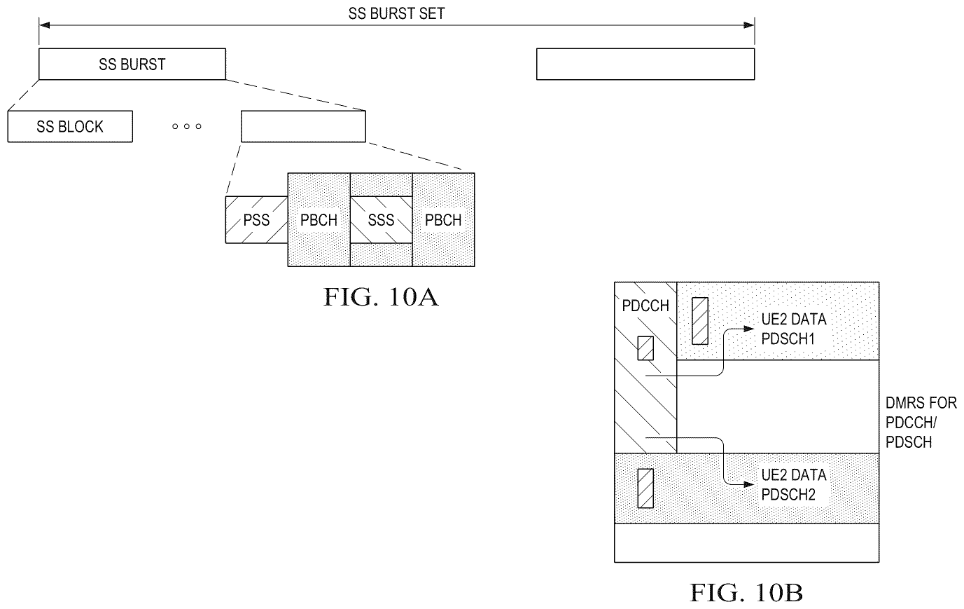

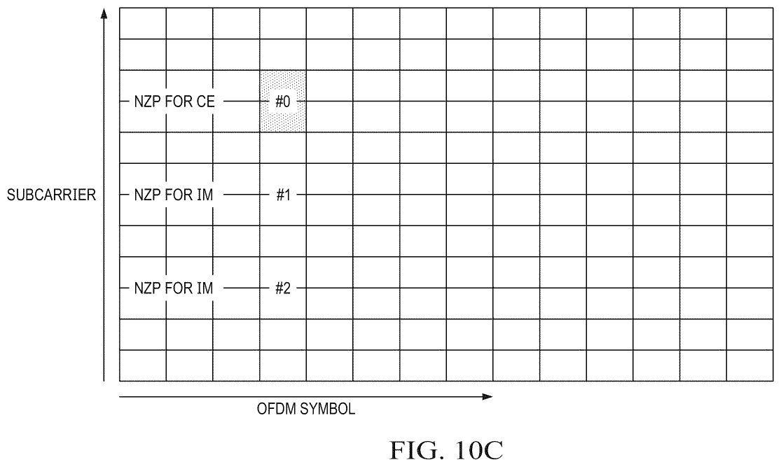

FIG. 10A illustrates physical layer channels and signals (including PSS/SSS, PBCH and its associated DMRS), according to some embodiments. FIG. 10B illustrates signals/channels which are multiplexed for more than one PDSCH (which could be for the same UE receiving one or more PDSCH transmissions from one or more TRPs), according to some embodiments. FIG. 10C illustrates examples of non-zero power (NZP) CSI-RS used for channel estimation, interference measurement, and so on, which are multiplexed with PDSCH and for one or more UEs, according to some embodiments.

Physical layer channels and signals include PSS/SSS, PBCH and its associated DMRS (see, e.g., FIG. 10A, in which the SS bursts are embedded, i.e., multiplexed with PBCH around it), PDSCH and its associated DMRS and phase tracking reference signal (PT-RS), PDCCH and its associated DMRS (see, e.g., FIG. 10B for some of these signals/channels which are multiplexed for more than one UE), and CSI-RS which further include those used, for CSI acquisition, for beam management, and for tracking (see FIG. 10C for some examples of non-zero power (NZP) CSI-RS used for channel estimation, interference measurement, and so on, which are multiplexed with PDSCH and for one or more UEs). The CSI-RS for tracking is also called a tracking reference signal (TRS).

The UE receives timing advance (TA) commands associated with the configured TA group (TAG) to adjust its uplink transmission timing to synchronize with the network for uplink transmission so that uplink transmissions from multiple UEs arrive at the base station at about the same time in a transmission time interval (TTI). Likewise, the UE needs to receive DL reference signals (RS) or synchronization signal (SS) blocks, also called SS/physical broadcast channel (PBCH) block SS/PBCH block (SSB) to acquire and maintain the DL synchronization, such as via maintaining a DL timing tracking loop, based on which the UE places the start of its FFT window inside the cyclic prefix (CP) for its DL reception. In addition, both UL and DL signals/channels are to be associated with some other signals for deriving the signal/channel properties, such as delay spread, Doppler shift, etc.

Sounding reference signals (SRSs) are reference signals transmitted by the user equipment (UE) in the uplink for the purpose of enabling uplink channel estimation over a certain bandwidth. As such, the network may be able to perform communication with the UEs based on the uplink channel estimation. Moreover, due to channel reciprocity between the uplink and the downlink present in a time division duplex (TDD) communication system, the network may utilize the SRSs to perform dynamic scheduling. That is, the network may exploit channel-dependent scheduling. In this case, the time-frequency resources are dynamically scheduled, taking into account the different traffic priorities and quality of services requirements. Typically, the UEs monitor several Physical Downlink Control Channels (PDCCHs) to acquire the scheduling decisions, which are signaled to the UEs by the network. Upon the detection of a valid PDCCH, the UE follows the scheduling decision and receives (or transmits) data.

The configuration of SRS related parameters of an SRS to be transmitted in the uplink (such as SRS transmission ports, SRS transmission bandwidth, SRS resources sets, transmission comb and cyclic shift, etc.) are semi-static in nature and may be provided through higher layer signaling, such as radio resource control signaling. Moreover, the association between the downlink reference signals, such as Channel State Information Reference Signals (CSI-RS) or demodulation reference signals (DMRS), and the uplink SRS should be conveyed to the UE to accurately reflect the interference situation and perform optimal beamforming. Thus, there is a need for apparatus and methods for signaling control information that accurately indicates a more dynamic configuration (not semi-static) of the aforementioned parameters, such as, for example, a portion of the transmission bandwidth required to transmit a subset of the SRS resource set (thereby implicitly indicating a transmission comb and cyclic shift) using a subset of the transmission ports associated with a particular set of downlink reference signals. The signaling of the control information may be closely tied to an actual data transmission. The transmission of the SRS may be periodic (i.e., periodic SRS, P-SRS or P SRS) as configured by Layer 3 RRC configuration signaling, semi-persistence (i.e., semi-persistent SRS, SP-SRS or SP SRS) activated/deactivated via Layer 2 MAC CE, or aperiodic (i.e., aperiodic SRS, A-SRS or AP-SRS or A SRS or AP SRS) indicated by Layer 1 DCI in PDCCH.

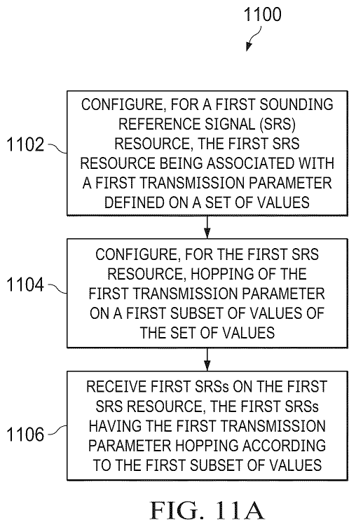

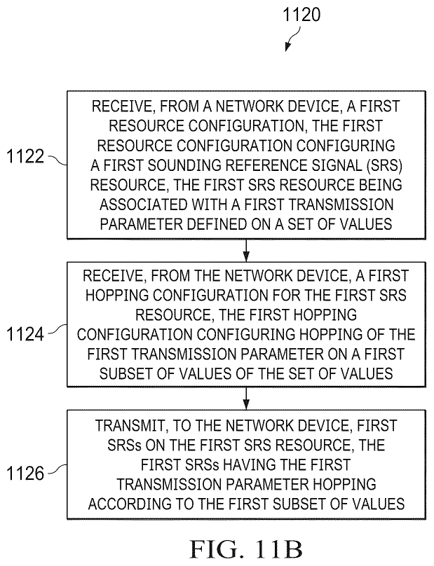

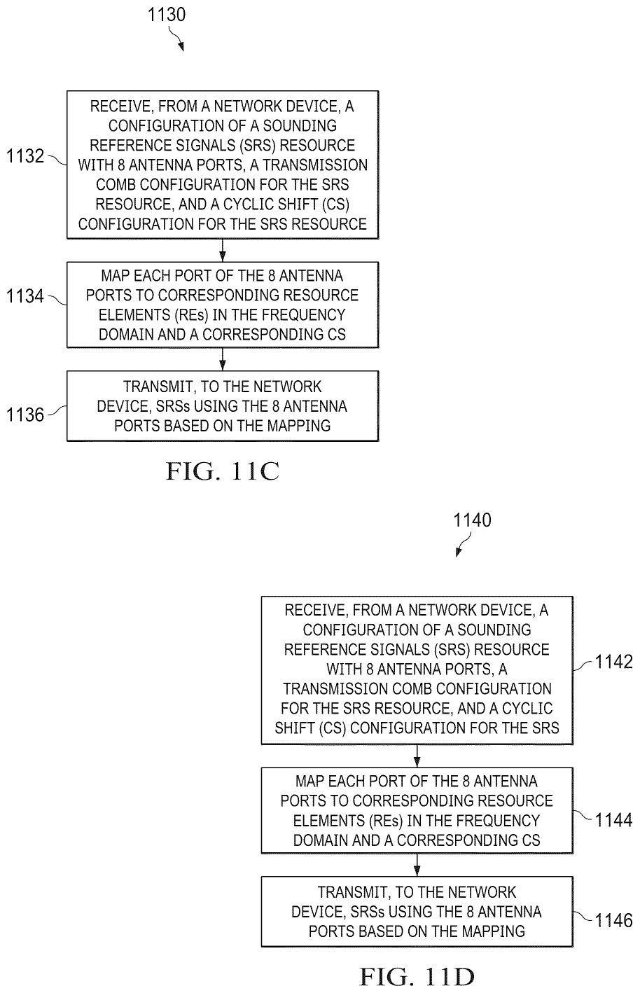

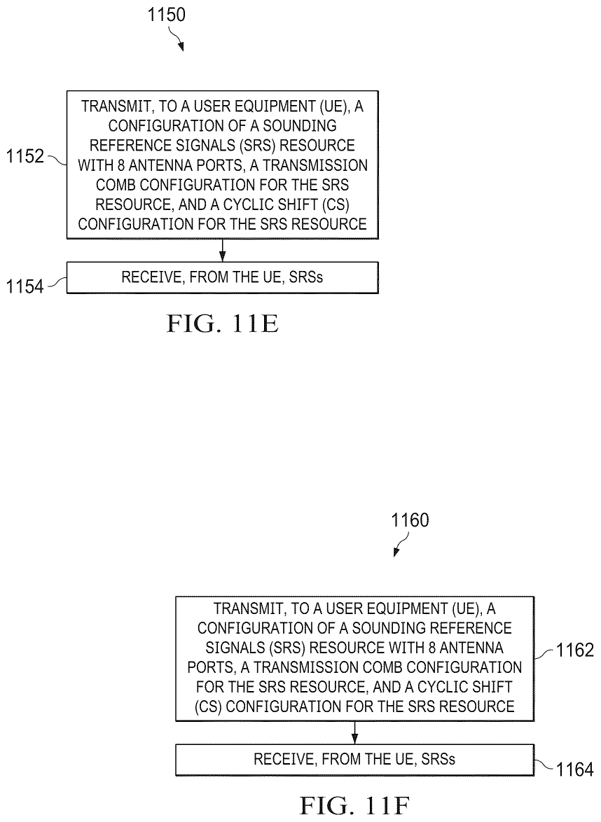

FIG. 11A illustrates a flow chart of a method 1100 performed by a network device, according to some embodiments. The network device may include computer-readable code or instructions executing on one or more processors of the network device. Coding of the software for carrying out or performing the method 1100 is well within the scope of a person of ordinary skill in the art having regard to the present disclosure. The method 1100 may include additional or fewer operations than those shown and described and may be carried out or performed in a different order. Computer-readable code or instructions of the software executable by the one or more processors may be stored on a non-transitory computer-readable medium, such as for example, the memory of the network device.

The method 1100 starts at the operation 1102, where the network device configures for a first sounding reference signal (SRS) resource. The first SRS resource is associated with a first transmission parameter defined on a set of values. At the operation 1104, the network device configures for the first SRS resource, hopping of the first transmission parameter on a first subset of values of the set of values. At the operation 1106, the network device receives first SRSs on the first SRS resource. The first SRSs have the first transmission parameter hopping according to the first subset of values.

In some embodiments, the set of values includes a second subset of values for resource hopping for a second SRS resource. The network device may configure for the second SRS resource. The second SRS resource may be associated with a second transmission parameter defined on the set of values. The network device may configure for the second SRS resource, hopping of the second transmission parameter on second subset of values of the set of values. The network device may receive second SRSs on the second SRS resource. The second SRSs have the second transmission parameter hopping according to the second subset of values. The first SRS resource and the second SRS resource may at least partially overlap in the time domain or in the frequency domain.

In some embodiments, the resource hopping may include cyclic shift (CS) hopping. The first subset of values may be a first subset of a set of CS values for CS hopping. The second subset of values may be a second subset of the set of CS values for CS hopping.

In some embodiments, the resource hopping may include comb offset hopping. The first subset of values may be a first subset of a set of comb offset values for comb offset hopping. The second subset of values may be a second subset of the set of comb offset values for comb offset hopping. The first subset of values may include first comb offset values, and the second subset of values may include second comb offset values.

In some embodiments, the first SRS resource may be configured for a first user equipment (UE). The second SRS resource may be configured for a second UE different from the first UE.

In some embodiments, the resource hopping may include CS hopping. The first subset of values may be a first subset of a set of CS values for CS hopping.

In some embodiments, the resource hopping may include comb offset hopping. The first subset of values may be a first subset of a set of comb offset values for comb offset hopping.

In some embodiments, the first subset of values for the first SRSs may hop on the first subset of values on multiple SRS transmission occasions based on an SRS hopping randomization identifier (ID), a pseudo-random integer sequence on the multiple SRS transmission occasions, a configured first resource value, a number of values in the first subset of values, and a time-domain index for the multiple SRS transmission occasions.

In some embodiments, the first SRS resource may be configured with multiple ports. The multiple ports may perform hopping based on a same pseudo-random integer sequence on the multiple SRS transmission occasions. In each of the multiple SRS transmission occasions, a same pseudo-random integer value may be used for all the multiple ports.

In some embodiments, the time-domain index may be based on a system frame number (SFN), a slot number within the SFN, and an orthogonal frequency-division multiplexing (OFDM) symbol index within a slot.

In some embodiments, a first number of values in the first subset may be 1, or a second number of values in the second subset may be 1.

FIG. 11B illustrates a flow chart of a method 1120 performed by a user equipment (UE), according to some embodiments. The UE may include computer-readable code or instructions executing on one or more processors of the UE. Coding of the software for carrying out or performing the method 1120 is well within the scope of a person of ordinary skill in the art having regard to the present disclosure. The method 1120 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 1120 starts at the operation 1122, where the UE receives, from a network device, a first resource configuration. The first resource configuration configures a first sounding reference signal (SRS) resource. The first SRS resource is associated with a first transmission parameter defined on a set of values. At the operation 1124, the UE receives, from the network device, a first hopping configuration for the first SRS resource. The first hopping configuration configures hopping of the first transmission parameter on a first subset of values of the set of values. At the operation 1126, the UE transmits, to the network device, first SRSs on the first SRS resource. The first SRSs have the first transmission parameter hopping according to the first subset of values.

In some embodiments, the UE may receive, from the network device, a second resource configuration. The second resource configuration may configure the second SRS resource. The second SRS resource may be associated with a second transmission parameter defined on the set of values. The UE may receive, from the network device, a second hopping configuration for the second SRS resource. The second resource configuration configuring hopping of the second transmission parameter on second subset of values of the set of values. The UE may transmit, to the network device, second SRSs on the second SRS resource. The second SRSs may have the second transmission parameter hopping according to the second subset of values. The first SRS resource and the second SRS resource may at least partially overlap in the time domain or in the frequency domain.

In some embodiments, the resource hopping may include cyclic shift (CS) hopping. The first subset of values may be a first subset of a set of CS values for CS hopping. The second subset of values may be a second subset of the set of CS values for CS hopping.

In some embodiments, the resource hopping may include comb offset hopping. The first subset of values may be a first subset of a set of comb offset values for comb offset hopping. The second subset of values may be a second subset of the set of comb offset values for comb offset hopping. The first subset of values may include first comb offset values, and the second subset of values may include second comb offset values.

In some embodiments, the resource hopping may include CS hopping. The first subset of values may be a first subset of a set of CS values for CS hopping.

In some embodiments, the resource hopping may include comb offset hopping. The first subset of values may be a first subset of a set of comb offset values for comb offset hopping.

In some embodiments, the first subset of values for the first SRSs may hop on the first subset of values on multiple SRS transmission occasions based on an SRS hopping randomization identifier (ID), a pseudo-random integer sequence on the multiple SRS transmission occasions, a configured first resource value, a number of values in the first subset of values, and a time-domain index for the multiple SRS transmission occasions.

In some embodiments, the first SRS resource may be configured with multiple ports. The multiple ports may perform hopping based on a same pseudo-random integer sequence on the multiple SRS transmission occasions. In each of the multiple SRS transmission occasions, a same pseudo-random integer value may be used for all the multiple ports.

In some embodiments, the time-domain index may be based on a system frame number (SFN), a slot number within the SFN, and an orthogonal frequency-division multiplexing (OFDM) symbol index within a slot.

In some embodiments, a first number of values in the first subset may be 1, or a second number of values in the second subset may be 1.

FIG. 11C illustrates a flow chart of a method 1130 performed by a user equipment (UE), according to some embodiments. The UE may include computer-readable code or instructions executing on one or more processors of the UE. Coding of the software for carrying out or performing the method 1130 is well within the scope of a person of ordinary skill in the art having regard to the present disclosure. The method 1130 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 1130 starts at the operation 1132, where the UE receives, from a network device, a configuration of a sounding reference signals (SRS) resource with 8 antenna ports, a transmission comb configuration for the SRS resource, and a cyclic shift (CS) configuration for the SRS resource. The transmission comb configuration indicates a comb value K. K is one of 2, 4, or 8. The transmission comb configuration further indicates a configured comb offset (k). k is an integer between 0 and K−1. The CS configuration indicates CS positions. At the operation 1134, the UE maps each port of the 8 antenna ports to corresponding resource elements (REs) in the frequency domain and a corresponding CS. The corresponding REs are a subset of a plurality of REs and on every K-th RE with an offset based on the configured comb offset (k) within an SRS transmission bandwidth. At the operation 1136, the UE transmits, to the network device, SRSs using the 8 antenna ports based on the mapping.

In some embodiments, the plurality of REs may be in an orthogonal frequency division multiplexing (OFDM) symbol.

In some embodiments, the SRS resource may be for usage set to ‘codebook’ or ‘antennaSwitching’.

In some embodiments, the comb value K may be 2. The UE may map the 8 antenna ports on every K-th RE with the configured comb offset (k) within the SRS transmission bandwidth. Or, the UE may map a first antenna port, a third antenna port, a fifth antenna port, and a seventh antenna port of the 8 antenna ports on every K-th RE with the configured comb offset (k), and a second antenna port, a fourth antenna port, a sixth antenna port, and an eighth antenna port of the 8 antenna ports on every K-th RE with a comb offset (k+1)modulo K, within the SRS transmission bandwidth.

In some embodiments, the comb value K may be 4. The UE may map a first antenna port, a third antenna port, a fifth antenna port, and a seventh antenna port of the 8 antenna ports on every K-th RE with the configured comb offset (k), and a second antenna port, a fourth antenna port, a sixth antenna port, and an eighth antenna port of the 8 antenna ports on every K-th RE with a comb offset (k+2)modulo K, within the SRS transmission bandwidth.

In some embodiments, the comb value K may be 8. The UE may map a first antenna port and a fifth antenna port of the 8 antenna ports on every K-th RE with the configured comb offset (k), a second antenna port and a sixth antenna port of the 8 antenna ports on every K-th RE with a first comb offset (k+2)modulo K, a third antenna port and a seventh antenna port of the 8 antenna ports on every K-th RE with a second comb offset (k+4)modulo K, and a fourth antenna port and an eighth antenna port of the 8 antenna ports on every K-th RE with a third comb offset (k+6)modulo K.

FIG. 11D illustrates a flow chart of a method 1140 performed by a user equipment (UE), according to some embodiments. The UE may include computer-readable code or instructions executing on one or more processors of the UE. Coding of the software for carrying out or performing the method 1140 is well within the scope of a person of ordinary skill in the art having regard to the present disclosure. The method 1140 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 1140 starts at the operation 1142, where the UE receives, from a network device, a configuration of a sounding reference signals (SRS) resource with 8 antenna ports and with a time division multiplexing (TDM) parameter, a transmission comb configuration for the SRS resource, and a cyclic shift (CS) configuration for the SRS resource. The transmission comb configuration indicates a comb value K. K is one of 2, 4, or 8. The transmission comb configuration further indicates a comb offset k. k is an integer between 0 and K−1. The CS configuration indicates CS positions. The SRS resource is mapped to a number m of consecutive orthogonal frequency division multiplexing (OFDM) symbols within a same slot. m is greater than or equal to 1. At the operation 1144, the UE maps each OFDM symbol of the consecutive OFDM symbols to a corresponding subset of the 8 antenna ports based on m and s. s is determined based on the TDM parameter and is a number of subsets of the 8 antenna ports. At the operation 1146, the UE transmits, to the network device, SRSs using the 8 antenna ports based on the mapping.

In some embodiments, the UE may map an i-th subset of 8/s antenna ports of the 8 antenna ports to every s-th OFDM symbol within the consecutive OFDM symbols starting from an i-th OFDM symbol of the consecutive OFDM symbols. i is from 1 to s.

In some embodiments, SRS transmissions on the consecutive OFDM symbols may be mapped with a same comb offset allocation and same CS positions.

In some embodiments, SRS transmissions on the consecutive OFDM symbols may be mapped with a same physical resource block (PRB) allocation.

In some embodiments, SRS transmissions on the consecutive OFDM symbols may be periodic, semi-persistent, or aperiodic. The SRS transmissions may be based on an SRS counter determined by s*R. R is a configured repetition factor for the SRS resource.

In some embodiments, m may be a multiple of s.

In some embodiments, m may be one of 2, 4, 8, 10, 12, or 14. s may be 2.

FIG. 11E illustrates a flow chart of a method 1150 performed by a network device, according to some embodiments. The network device may include computer-readable code or instructions executing on one or more processors of the network device. Coding of the software for carrying out or performing the method 1150 is well within the scope of a person of ordinary skill in the art having regard to the present disclosure. The method 1150 may include additional or fewer operations than those shown and described and may be carried out or performed in a different order. Computer-readable code or instructions of the software executable by the one or more processors may be stored on a non-transitory computer-readable medium, such as for example, the memory of the network device.

The method 1150 starts at the operation 1152, where the network device transmits, to a user equipment (UE), a configuration of a sounding reference signals (SRS) resource with 8 antenna ports, a transmission comb configuration for the SRS resource, and a cyclic shift (CS) configuration for the SRS resource. The transmission comb configuration indicating a comb value K. K is one of 2, 4, or 8. The transmission comb configuration further indicates a configured comb offset (k). k is an integer between 0 and K−1. The CS configuration indicates CS positions. Each port of the 8 antenna ports is mapped to corresponding resource elements (REs) in the frequency domain and a corresponding CS. The corresponding REs are a subset of a plurality of REs and on every K-th RE with an offset based on the configured comb offset (k) within an SRS transmission bandwidth. At the operation 1154, the network device receives, from the UE, SRSs.

In some embodiments, the plurality of REs may be in an orthogonal frequency division multiplexing (OFDM) symbol.

In some embodiments, the SRS resource may be for usage set to ‘codebook’ or ‘antennaSwitching’.

In some embodiments, the comb value K is 2. the 8 antenna ports may be mapped on every K-th RE with the configured comb offset (k) within the SRS transmission bandwidth. Or, a first antenna port, a third antenna port, a fifth antenna port, and a seventh antenna port of the 8 antenna ports may be mapped on every K-th RE with the configured comb offset (k), and a second antenna port, a fourth antenna port, a sixth antenna port, and an eighth antenna port of the 8 antenna ports may be mapped on every K-th RE with a comb offset (k+1)modulo K, within the SRS transmission bandwidth.

In some embodiments, the comb value K is 4. A first antenna port, a third antenna port, a fifth antenna port, and a seventh antenna port of the 8 antenna ports may be mapped on every K-th RE with the configured comb offset (k). A second antenna port, a fourth antenna port, a sixth antenna port, and an eighth antenna port of the 8 antenna ports may be mapped on every K-th RE with a comb offset (k+2)modulo K, within the SRS transmission bandwidth.

In some embodiments, the comb value K is 8. A first antenna port and a fifth antenna port of the 8 antenna ports may be mapped on every K-th RE with the configured comb offset (k). A second antenna port and a sixth antenna port of the 8 antenna ports may be mapped on every K-th RE with a first comb offset (k+2)modulo K. A third antenna port and a seventh antenna port of the 8 antenna ports may be mapped on every K-th RE with a second comb offset (k+4)modulo K. A fourth antenna port and an eighth antenna port of the 8 antenna ports may be mapped on every K-th RE with a third comb offset (k+6)modulo K.

FIG. 11F illustrates a flow chart of a method 1160 performed by a network device, according to some embodiments. The network device may include computer-readable code or instructions executing on one or more processors of the network device. Coding of the software for carrying out or performing the method 1160 is well within the scope of a person of ordinary skill in the art having regard to the present disclosure. The method 1160 may include additional or fewer operations than those shown and described and may be carried out or performed in a different order. Computer-readable code or instructions of the software executable by the one or more processors may be stored on a non-transitory computer-readable medium, such as for example, the memory of the network device.

The method 1160 starts at the operation 1162, where the network device transmits, to a user equipment (UE), a configuration of a sounding reference signals (SRS) resource with 8 antenna ports and with a time division multiplexing (TDM) parameter, a transmission comb configuration for the SRS resource, and a cyclic shift (CS) configuration for the SRS resource. The transmission comb configuration indicates a comb value K. K is one of 2, 4, or 8. The transmission comb configuration further indicates a comb offset k. k is an integer between 0 and K−1. The CS configuration indicates CS positions. The SRS resource is mapped to a number m of consecutive orthogonal frequency division multiplexing (OFDM) symbols within a same slot. m is greater than or equal to 1. Each OFDM symbol of the consecutive OFDM symbols is mapped to a corresponding subset of the 8 antenna ports based on m and s. s is determined based on the TDM parameter and is a number of subsets of the 8 antenna ports. At the operation 1164, the network device receives, from the UE, SRSs.

In some embodiments, the UE may map an i-th subset of 8/s antenna ports of the 8 antenna ports to every s-th OFDM symbol within the consecutive OFDM symbols starting from an i-th OFDM symbol of the consecutive OFDM symbols. i is from 1 to s.

In some embodiments, SRS transmissions on the consecutive OFDM symbols may be mapped with a same comb offset allocation and same CS positions.

In some embodiments, SRS transmissions on the consecutive OFDM symbols may be mapped with a same physical resource block (PRB) allocation.

In some embodiments, SRS transmissions on the consecutive OFDM symbols may be periodic, semi-persistent, or aperiodic. The SRS transmissions may be based on an SRS counter determined by s*R. R is a configured repetition factor for the SRS resource.

In some embodiments, m may be a multiple of s.

In some embodiments, m may be one of 2, 4, 8, 10, 12, or 14. s may be 2.

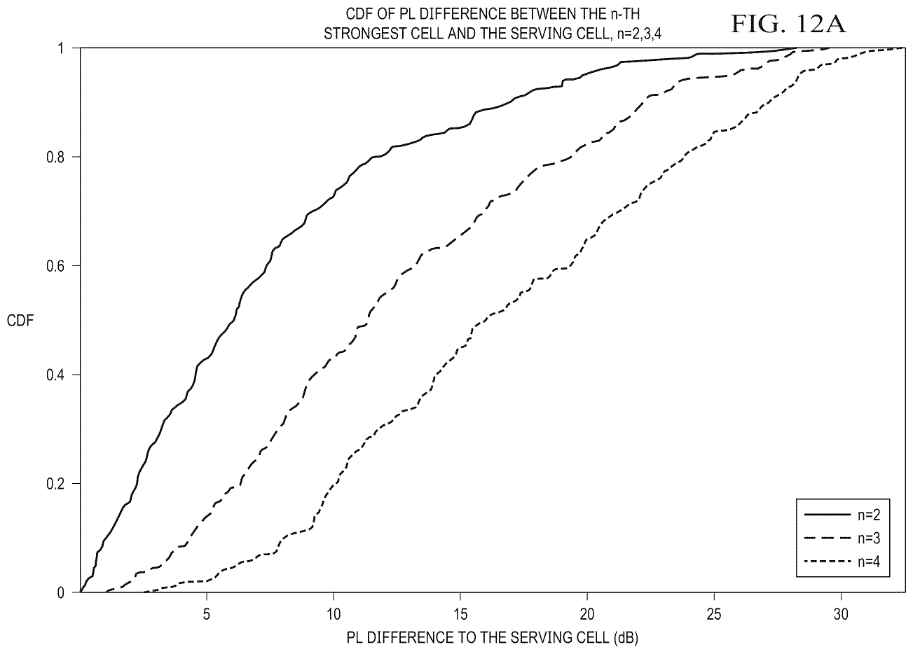

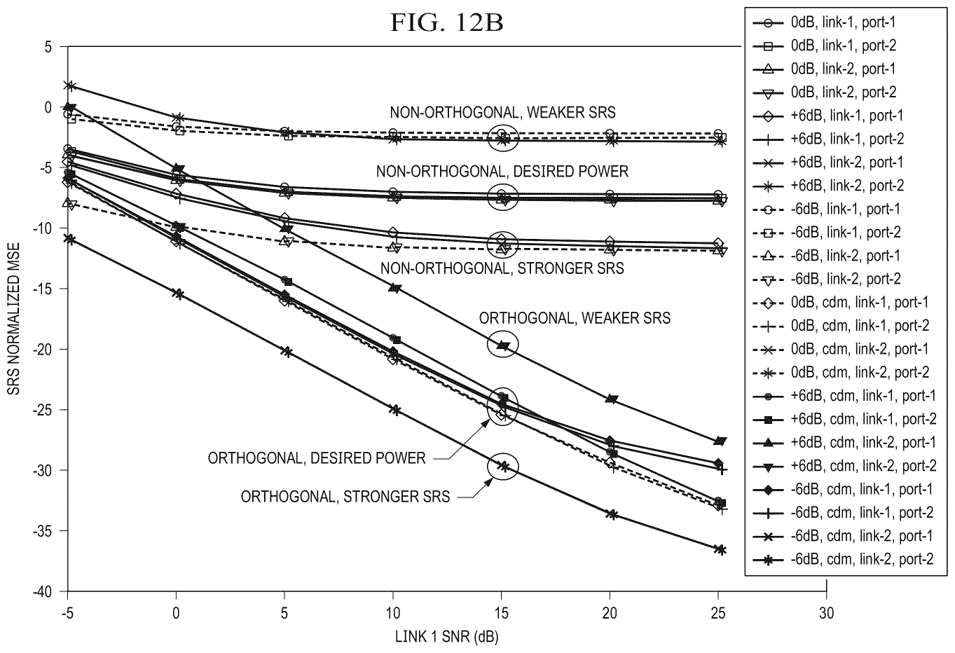

This disclosure provides a numerical study of pathloss difference for TRP-common SRS. 210 UEs are dropped in a 21-sector network according to Dense Urban of 200 m ISD. For each UE, the sector with the highest RSRP is selected as the serving cell/serving TRP, and 3 other sectors with the 2^{nd}, 3^{rd}, and 4^{th} highest RSRP are other CJT candidate TRPs. Since all sectors' transmission powers are identical, pathloss difference at each UE is equal to the RSRP difference. Then the pathloss difference between the candidate CJT TRPs and the serving cell is calculated for each UE, and finally 3 CDF curves are obtained in FIG. 12A. FIG. 12A shows cumulative distribution function (CDF) of pathloss difference between the 2^{nd} strongest cell and the serving cell, CDF of pathloss difference between the 3rd strongest cell and the serving cell, CDF of pathloss difference between the 4^{th} strongest cell and the serving cell. The vertical lines are at 3 dB, 6 dB, and 10 dB.

As shown in FIG. 12A, if only 3 dB pathloss difference is allowed, then about 28% of UEs can be served by 2 TRPs, 5% of UEs can be served by 3 TRPs, and only 1% of UEs can be served by 4 TRPs. Table 5 shows the percentages of UEs served by 2, 3, and 4 TRPs with at most 3, 6, and 10 dB pathloss differences.

TABLE 5
percentages of UEs served by 2, 3, and 4 TRPs with at most
3, 6, and 10 dB pathloss differences

| | 3 dB | 6 dB | 10 dB |
|---|---|---|---|
| 2 TRPs | 28% | 50% | 73% |
| 3 TRPs | 5% | 19% | 43% |
| 4 TRPs | 1% | 5% | 20% |

Then the channel estimation performance with received power imbalance and orthogonal/non-orthogonal SRSs is studied. In below figure, SRS 1 with 2 ports is sent on link 1, and SRS 2 with 2 ports is sent on link 2. They are orthogonal via CDM (as labeled by ‘cdm’) or non-orthogonal, and one link may be weak (due to higher pathloss, as labeled by ‘+6 dB’) or stronger (due to lower pathloss, as labeled by ‘−6 dB’). Note that the 2 ports of the same RS have similar performance, and their corresponding curves mostly overlap. FIG. 12B shows channel estimation performance with received power imbalance and orthogonal/non-orthogonal SRSs.

The following for cross-SRS interference with potential power imbalance is observed. For non-orthogonal SRSs, significant performance degradation due to interference, especially for the weaker signal of the two SRS. For orthogonal SRSs, if the SRSs are orthogonal, such as by CDM, the performance of both SRSs are generally good, the weaker signal is a bit worse (about x dB degradation if it is x dB weaker), and the stronger signal is a bit better (about x dB better if it is x dB stronger).

Additional details and descriptions relating to and/or expanding upon the above-described disclosures are provided below.

This disclosure provides the numerical study of cross-SRS interference and SRS performance.

SRSs Multiplexed within a CJT Transmission Area

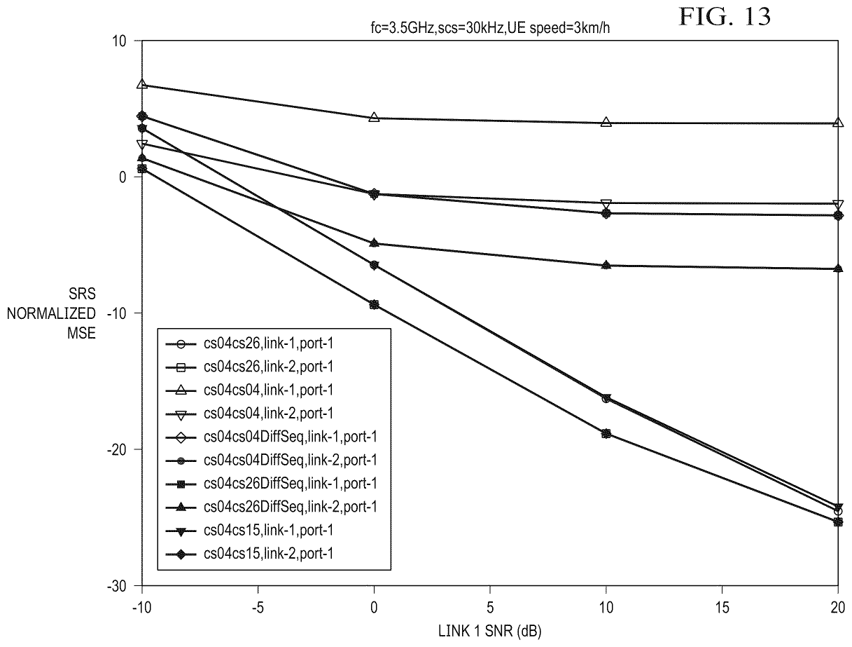

SRS interference from a UE inside a CJT transmission area, if exists, can have relatively high receive power at a CJT TRP. FIG. 13 shows SRS performance with the same SRS sequence (with cyclic shift spacing of 1 or 2) or with different SRS sequences (with cyclic shift spacing of 0 or 2). The 5^{th} and the 6th curves listed and the 7^{th} and 8^{th} curves listed are almost completely overlapping with each other. In FIG. 13, 2 UEs multiplexed on the same time-frequency resources are simulated, each with 2 ports (though one port is plotted as both ports have similar performance, unless otherwise mentioned). ‘cs04^{cs}26’ stands for UE1 configured with CS [0,4] and UE2 configured with CS [2,6]. Comb 2, 30 ns delay spread, and same SRS sequence are assumed unless otherwise specified.

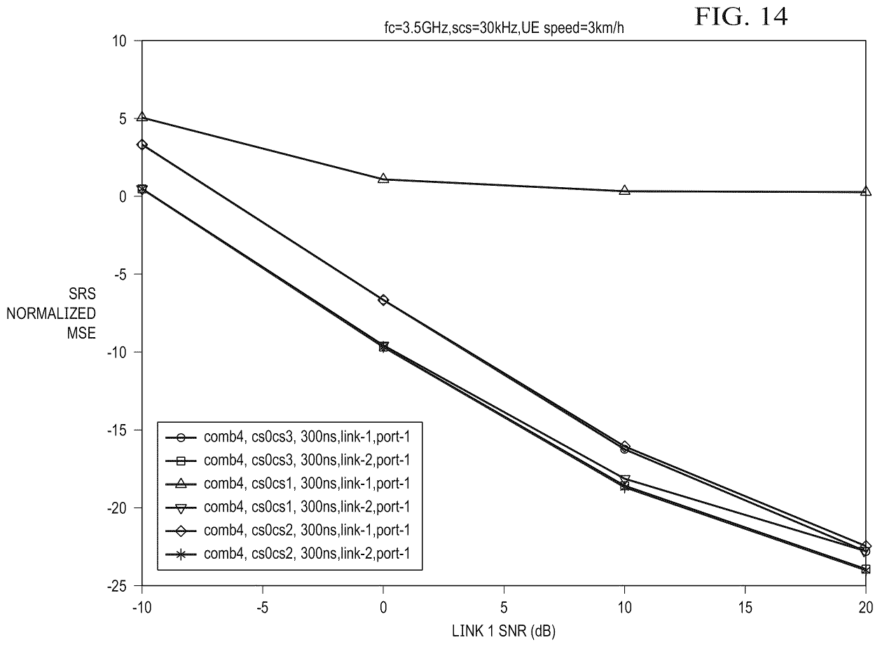

FIG. 14 shows SRS performance of CDMed SRS ports with CDL-C 300 ns channels and cyclic shift spacing of 1, 2, or 3.

If the SRSs have significant overlap in time/frequency/delay-domain, such as configured on the same REs with the same SRS sequence and cyclic shift(s), the SRSs suffer from significant performance loss. This also includes the case of the same SRS sequence, long delay spread, and small cyclic shift spacing, e.g., with 300 ns RMS delay spread but configured with CS 0 and CS1 for comb 4. Configured with CS 0 and CS 2 can avoid this issue. The worst performance occurs when two SRSs have complete overlap/collision. This implies for CDMed SRSs, it shall be prevented that, when cyclic shift hopping/randomization is enabled, they will not happen to use the same cyclic shift on an OFDM symbol.

For SRSs with different SRS sequences, the interference can still be quite high.

SRSs with little overlap in time/frequency/delay-domain have good channel estimation performance.

When the overlap in time/frequency/delay-domain is small, hopping/randomization can further improve the performance.

SRS Interference from Outside a CJT Transmission Area

SRS interference from a UE outside a CJT transmission area generally cannot be coordinated, but they usually have relatively lower receive power at a CJT TRP, e.g., at least 6 dB lower than the desired SRS receive power. Though weak, the interference can still be detrimental to channel estimation performance if the SRSs happen to collide in time/frequency/code/delay-domain, such as happen to be configured on the same REs with the same SRS sequence and cyclic shift.

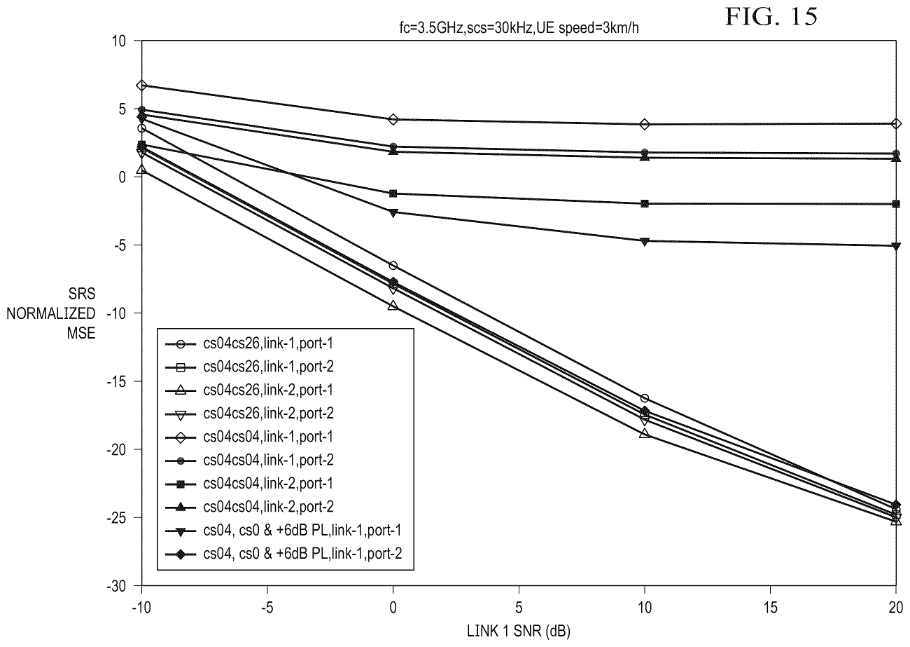

FIG. 15 shows SRS performance of orthogonal ports, full-collision ports, and partial collision with a weaker interfering port (the last two curves listed, port 1 is fully colliding with the weaker interfering port, port 2 has no interference).

This disclosure provides a numerical study for SRS cyclic shift hopping below.

SRSs Multiplexed within a CJT Transmission Area

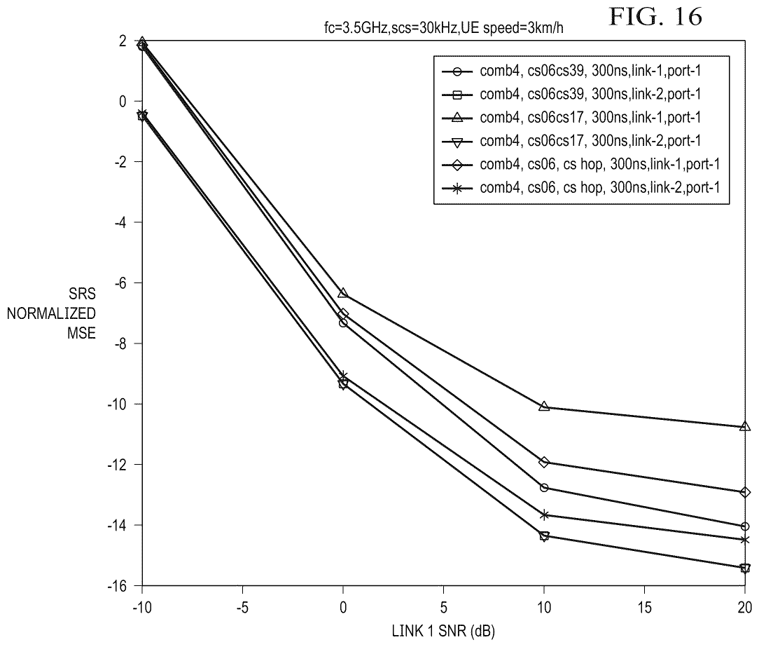

For CDMed SRS ports, when a port is associated with long delay spread, it causes some interference to another port. Without cyclic shift hopping, the interference may be quite persistent. To achieve interference randomization, cyclic shift hopping can be utilized for CDMed SRS ports. FIG. 16 illustrates SRS performance of cyclic shift hopping for CDMed SRS ports with CDL-C 300 ns channels. FIG. 16 shows the interference randomization impact on very long delay spread cases due to cyclic shift hopping (only 1 port per UE is shown for simplicity here). With cyclic shift hopping, the performance of different UEs becomes more even, which is desirable.

SRS Interference from Outside a CJT Transmission Area

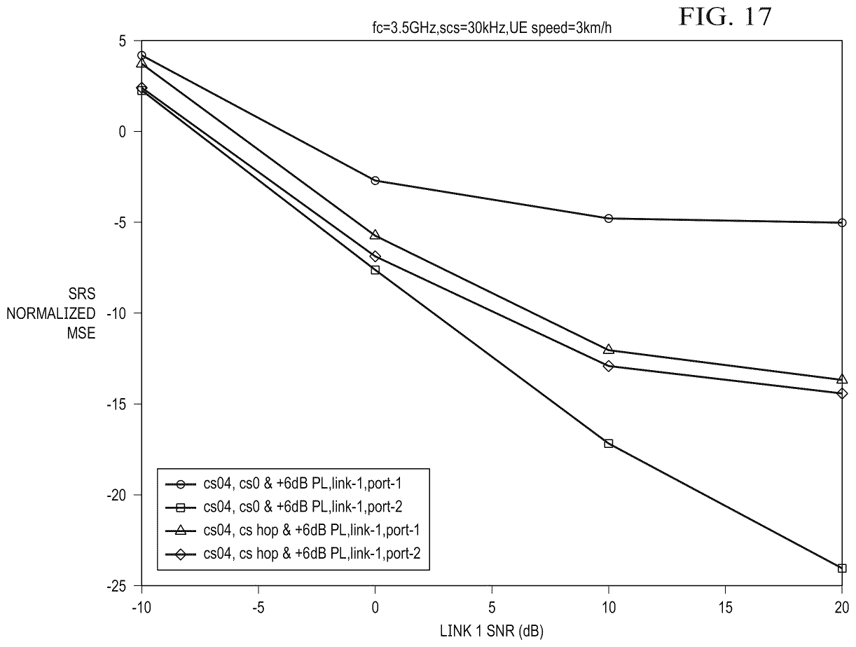

As mentioned above, it may happen that some SRS from outside a CJT transmission area is configured on the same REs with the same SRS sequence and cyclic shift as an SRS of a CJT UE. Though the interference power is weak, it causes considerable channel estimation performance degradation. FIG. 17 shows SRS performance with cyclic shift hopping of weaker interfering ports. In FIG. 17, UE1's first port on CS 0 is hit by a weak SRS on CS 0 but its second port on CS 4 is not, which renders poor performance of the second port. If cyclic hopping is enabled, the effect of interference randomization can be seen.

This disclosure provides a numerical study for SRS fractional cyclic shift and maximum number of SRS cyclic shifts below.

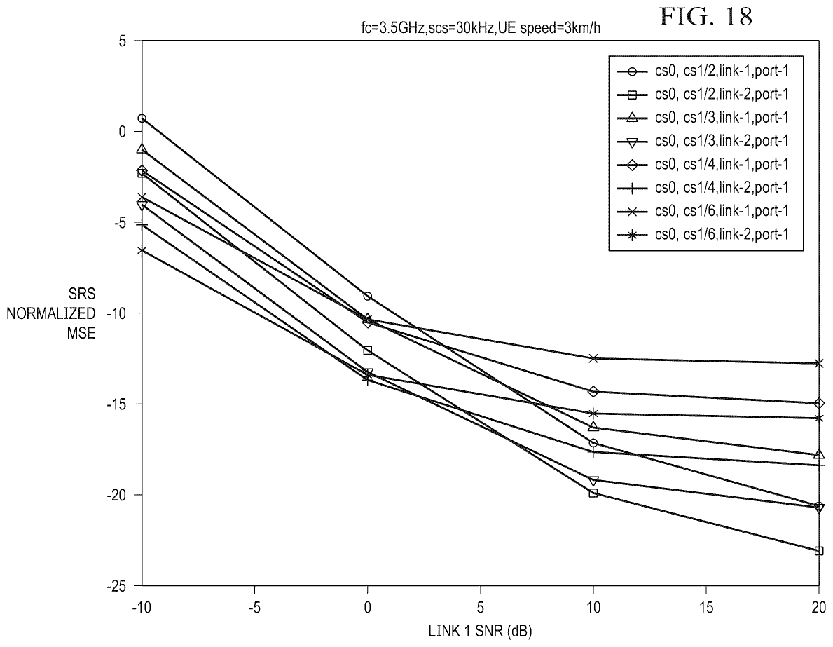

For comb 4 and comb 8, the total number of possible SRS ports multiplexed via cyclic shifts and comb offsets is 48, which may not be suitable for channels with long delay spread, such as TDL-C 300 ns channels. However, for channels with short delay spread, such as TDL-C 300 ns channels, it is possible to multiplex 48 ports in an orthogonal way. For even shorter channels, even more ports could be possible. How far apart 2 ports should be configured depends on the delay spread of the channel impulse response of the potential interfering port. Fractional cyclic shifts can be configured accordingly to maximize the SRS capacity. FIG. 18 shows the performance evaluations of one UE with CS 0 and the other UE with CS 1/f, where f=2, 3, 4, 6, and for CDL-C channels with 30 ns rooted mean square delay spread. Although the CS spacing between the ports is as narrow as ⅙ of normal CS spacing, the MSE performance is still generally acceptable. In case when all the fractional and integer CS values are equally spaced, effectively the curves correspond to increased maximum number of cyclic shifts (denoted as D), where D=16, 24, 32, and 48, respectively.

FIG. 18 Performance evaluations of one UE with CS 0 and the other UE with CS 1/f.

This disclosure provides SRS resource configuration and SRS resource set configuration (updated from TS 38.331 v17.1.0) below.

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-Port Index | ENUMERATED {n0, n1 } |
| OPTIONAL, -- Need R | |
| transmissionComb | CHOICE { |
| n2 | SEQUENCE { |
| combOffset-n2 | INTEGER (0..1), |
| combOffsetHopping-n2 | ENUMERATED {enabled} |
| OPTIONAL, | |

combOffsetHoppingWithRepetition-n2 ENUMERATED {Per-symbol, per-R-

| | |
|---|---|
| Repetition} | OPTIONAL, |

| | |
|---|---|
| combOffsetHoppingSubset-n2 | SEQUENCE |
| (SIZE(1..maxNrofSRSHoppingSubset-1)) | |
| | OF INTEGER (0..1) |
| OPTIONAL, | |
| cyclicShift-n2 | INTEGER (0..7) |
| cyclicShiftHopping-n2 | ENUMERATED {enabled} |
| OPTIONAL, | |

cyclicShiftHoppingFinerGranularity-n2 INTEGER (2..4),

| | |
|---|---|
| OPTIONAL, | |
| cyclicShiftHoppingSubset-n2 | SEQUENCE (SIZE(1..8)) |
| | OF INTEGER (0..7) |
| OPTIONAL, | |
| }, | |
| n4 | SEQUENCE { |
| combOffset-n4 | INTEGER (0..3), |
| combOffsetHopping-n4 | ENUMERATED {enabled} |
| OPTIONAL, | |

combOffsetHoppingWithRepetition-n4 ENUMERATED {Per-symbol, per-R-

| | |
|---|---|
| Repetition} | OPTIONAL, |

| | |
|---|---|
| combOffsetHoppingSubset-n4 | SEQUENCE |
| (SIZE(1..maxNrofSRSHoppingSubset-1)) | |
| | OF INTEGER (0..3) |
| OPTIONAL, | |
| cyclicShift-n4 | INTEGER (0..11) |
| cyclicShiftHopping-n4 | ENUMERATED {enabled} |
| OPTIONAL, | |

cyclicShiftHoppingFinerGranularity-n4 INTEGER (2),

| | |
|---|---|
| OPTIONAL, | |
| cyclicShiftHoppingSubset-n4 | SEQUENCE (SIZE (1..12)) |
| | OF INTEGER (0..11) |
| OPTIONAL, | |
| } | |
| }, | |
| hoppingId | INTEGER (0..1023) OPTIONAL, |
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |
| tdm | ENUMERATED {enabled} |
| OPTIONAL | |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { neither, groupHopping, |
| sequenceHopping }, | |
| resourceType | CHOICE { |
| aperiodic | SEQUENCE { |
| ... | |
| }, | |
| semi-persistent | SEQUENCE { |
| periodicityAndOffset-sp | SRS- |
| PeriodicityAndOffset, | |
| ... | |
| }, | |
| periodic | SEQUENCE { |
| periodicityAndOffset-p | SRS- |
| PeriodicityAndOffset, | |
| ... | |
| } | |
| }, | |
| sequence Id | INTEGER (0..1023), |
| spatialRelationInfo | SRS-SpatialRelationInfo |
| OPTIONAL, -- Need R | |
| ..., | |
| [[ | |
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |
| } | |
| OPTIONAL -- Need R | |
| ]], | |
| [[ | |
| spatialRelationInfo-PDC-r17 | SetupRelease { SpatialRelationInfo- |

| | |
|---|---|
| PDC-r17 } | OPTIONAL, -- Need M |

| | |
|---|---|
| resourceMapping-r17 | SEQUENCE { |
| nrofSymbols-r17 | ENUMERATED {n8, n10, n12, n14}, |
| repetitionFactor-r17 | ENUMERATED {n1, n2, n4, n5, n6, |
| n7, n8, n10, n12, n14} | |
| }, | |
| partialFreqSounding-r17 | SEQUENCE { |
| startRBIndexFScaling-r17 | CHOICE { |

```
          startRBIndexAndFreqScalingFactor2-r17 INTEGER (0..1),
          startRBIndexAndFreqScalingFactor4-r17 INTEGER (0..3)
```

| }, | | |
|---|---|---|
| enableStartRBHopping-r17 | | ENUMERATED {enable} |
| OPTIONAL, -- Need R | | |
| } | | |
| OPTIONAL, -- Need R | | |
| transmissionComb-n8-r17 | | SEQUENCE { |
| startPosition-r17 | | INTEGER (0..13), |
| combOffset-n8-r17 | | INTEGER (0..7), |
| combOffsetHopping-n8 | | ENUMERATED {enabled} |
| OPTIONAL, | | |
| combOffsetHoppingWithRepetition-n8 | | ENUMERATED { Per-symbol, per-R- |
| Repetition} | OPTIONAL, | |

| | |
|---|---|
| combOffsetHoppingSubset-n8 | SEQUENCE |
| (SIZE(1..maxNrofSRSHoppingSubset-1)) | |
| | OF INTEGER (0..7) |
| OPTIONAL, | |
| cyclicShift-n8-r17 | INTEGER (0..5) |
| cyclicShiftHopping-n8 | ENUMERATED {enabled} |
| OPTIONAL, | |
| cyclicShiftHoppingFinerGranularity-n8 | INTEGER (2), |
| OPTIONAL, | |
| cyclicShiftHoppingSubset-n8 | SEQUENCE (SIZE(1..6)) |
| | OF INTEGER (0..5) |
| OPTIONAL, | |
| } | |
| OPTIONAL -- Need R | |
| ]] | |
| } | |

Depending on the design, SEQUENCE (SIZE(1 . . . maxNrofSRSHoppingSubset−1)) may be changed length K_{TC} or n_{SRS}^{cs,max}, e.g., to SEQUENCE (SIZE(1 . . . 8)) for comb offset hopping with comb 8, etc.

| | |
|---|---|
| SRS-ResourceSet ::= | SEQUENCE { |

| | |
|---|---|
| srs-ResourceSetId | SRS-ResourceSetId, |
| srs-Resource IdList | SEQUENCE (SIZE (1..maxNrofSRS- |

ResourcesPerSet)) OF SRS-ResourceId OPTIONAL, -- Cond Setup

| | |
|---|---|
| resourceType | CHOICE { |
| aperiodic | SEQUENCE { |
| aperiodicSRS-ResourceTrigger | INTEGER (1..maxNrofSRS- |
| TriggerStates-1), | |
| csi-RS | NZP-CSI-RS-ResourceId |
| OPTIONAL, -- Cond NonCodebook | |
| slotOffset | INTEGER (1..32) |
| OPTIONAL, -- Need S | |
| ..., | |
| [[ | |
| aperiodicSRS-ResourceTriggerList | SEQUENCE |
| (SIZE(1..maxNrofSRS-TriggerStates-2)) | |
| | OF INTEGER |

(1..maxNrofSRS-TriggerStates-1) OPTIONAL -- Need M

| ]] | | |
|---|---|---|
| }, | | |
| semi-persistent | | SEQUENCE { |
| associatedCSI-RS | | NZP-CSI-RS-ResourceId |
| OPTIONAL, -- Cond NonCodebook | | |
| ... | | |
| }, | | |
| periodic | | SEQUENCE { |
| associatedCSI-RS | | NZP-CSI-RS-ResourceId |
| OPTIONAL, -- Cond NonCodebook | | |
| ... | | |
| } | | |
| }, | | |
| usage | | ENUMERATED {beamManagement, |
| codebook, nonCodebook, antennaSwitching}, | | |
| alpha | | Alpha |
| OPTIONAL, -- Need S | | |
| p0 | | INTEGER (-202..24) |
| OPTIONAL, -- Cond Setup | | |
| pathlossReferenceRS | | PathlossReferenceRS-Config |
| OPTIONAL, -- Need M | | |
| srs-PowerControlAdjustmentStates | | ENUMERATED { sameAsFci2, |
| separateClosedLoop} | OPTIONAL, -- Need S | |
| ..., | | |

| | |
|---|---|
| [[ | |
| pathloss ReferenceRSList-r16 | SetupRelease { |
| PathlossReferenceRSList-r16} | OPTIONAL -- Need M |
| ]], | |
| [[ | |
| usagePDC-r17 | ENUMERATED {true} |
| OPTIONAL, -- Need R | |
| availableSlotOffsetList-r17 | SEQUENCE (SIZE(1..4)) OF |

| | |
|---|---|
| AvailableSlotOffset-r17 | OPTIONAL, -- Need R |

| | |
|---|---|
| followUnifiedTCIstateSRS-r17 | ENUMERATED {enabled} |
| OPTIONAL -- Need R | |
| ]] | |
| } | |

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a selecting unit or module, a determining unit or module, or an assigning unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

What is claimed is:

1. A user equipment (UE), comprising:
at least one processor; and
a non-transitory computer readable storage medium storing programming, the programming including instructions that, when executed by the at least one processor, cause the UE to perform operations including:
receiving, from a network device, a configuration of a sounding reference signals (SRS) resource with 8 antenna ports, a transmission comb configuration for the SRS resource, and a cyclic shift (CS) configuration for the SRS resource, the transmission comb configuration indicating a comb value K, K being one of 2, 4, or 8, the transmission comb configuration further indicating a configured comb offset (k), k being an integer between 0 and K−1, the CS configuration indicating CS positions;
mapping each port of the 8 antenna ports to corresponding resource elements (REs) in the frequency domain and a corresponding CS, the corresponding REs for each port being on every K-th RE with an offset corresponding to each port based on the configured comb offset (k), the corresponding REs being within an SRS transmission bandwidth; and
transmitting, to the network device, SRSs using the 8 antenna ports based on the mapping.

2. The UE of claim 1,
wherein the corresponding REs are in an orthogonal frequency division multiplexing (OFDM) symbol, or
wherein the SRS resource is for usage set to ‘codebook’ or ‘antennaSwitching’.

3. The UE of claim 1, wherein when the comb value K is 2, the mapping, by the UE, each port of the 8 antenna ports to the corresponding REs comprises:
mapping the 8 antenna ports to every K-th RE with a same offset equal to the configured comb offset (k) for all 8 antenna ports, or
mapping a first antenna port, a third antenna port, a fifth antenna port, and a seventh antenna port of the 8 antenna ports to every K-th RE with the configured comb offset (k), and a second antenna port, a fourth antenna port, a sixth antenna port, and an eighth antenna port of the 8 antenna ports to every K-th RE with a comb offset (k+1) modulo K.

4. The UE of claim 1, the mapping comprising:
when the comb value K is 4:
mapping a first antenna port, a third antenna port, a fifth antenna port, and a seventh antenna port of the 8 antenna ports to every K-th RE with the configured comb offset (k), and a second antenna port, a fourth antenna port, a sixth antenna port, and an eighth antenna port of the 8 antenna ports to every K-th RE with a comb offset (k+2) modulo K.

5. The UE of claim 1, the mapping comprising:
when the comb value K is 8:
mapping a first antenna port and a fifth antenna port of the 8 antenna ports to every K-th RE with the configured comb offset (k), a second antenna port and a sixth antenna port of the 8 antenna ports to every K-th RE with a first comb offset (k+2) modulo K, a third antenna port and a seventh antenna port of the 8 antenna ports to every K-th RE with a second comb offset (k+4)modulo K, and a fourth antenna port and an eighth antenna port of the 8 antenna ports to every K-th RE with a third comb offset (k+6)modulo K.

6. A user equipment (UE), comprising:
at least one processor; and
a non-transitory computer readable storage medium storing programming, the programming including instructions that, when executed by the at least one processor, cause the UE to perform operations including:
receiving, from a network device, a configuration of a sounding reference signals (SRS) resource with 8 antenna ports and with a time division multiplexing (TDM) parameter, a transmission comb configuration for the SRS resource, and a cyclic shift (CS) configuration for the SRS resource, the transmission comb configuration indicating a comb value K, K being one of 2, 4, or 8, the transmission comb configuration further indicating a comb offset k, k being an integer between 0 and K−1, the CS configuration indicating CS positions, wherein the SRS resource is mapped to a number m of consecutive orthogonal frequency division multiplexing (OFDM) symbols within a same slot, m being greater than or equal to 1;
mapping each OFDM symbol of the consecutive OFDM symbols to a corresponding subset of the 8 antenna ports based on m and s, where s is determined based on the TDM parameter and is a number of subsets of the 8 antenna ports; and
transmitting, to the network device, SRSs using the 8 antenna ports based on the mapping.

7. The UE of claim 6, the mapping comprising:
mapping, by the UE, an i-th subset of 8/s antenna ports of the 8 antenna ports to every s-th OFDM symbol within the consecutive OFDM symbols starting from an i-th OFDM symbol of the consecutive OFDM symbols, where i is from 1 to s.

8. The UE of claim 6, wherein SRS transmissions on the consecutive OFDM symbols are mapped with a same comb offset allocation and same CS positions.

9. The UE of claim 6, wherein SRS transmissions on the consecutive OFDM symbols are mapped with a same physical resource block (PRB) allocation.

10. The UE of claim 6, SRS transmissions on the consecutive OFDM symbols being periodic, semi-persistent, or aperiodic, and the SRS transmissions being based on an SRS counter, the SRS counter being counted based on s*R, wherein R is a configured repetition factor for the SRS resource.

11. The UE of claim 6,
m being a multiple of s, or
m being one of 2, 4, 8, 10, 12, or 14, and s being 2.

12. A network device, comprising:
at least one processor; and
a non-transitory computer readable storage medium storing programming, the programming including instructions that, when executed by the at least one processor, cause the network device to perform operations including:
transmitting, to a user equipment (UE), a configuration of a sounding reference signals (SRS) resource with 8 antenna ports, a transmission comb configuration for the SRS resource, and a cyclic shift (CS) configuration for the SRS resource, the transmission comb configuration indicating a comb value K, K being one of 2, 4, or 8, the transmission comb configuration further indicating a configured comb offset (k), k being an integer between 0 and K−1, the CS configuration indicating CS positions,
wherein each port of the 8 antenna ports is mapped to corresponding resource elements (REs) in the frequency domain and a corresponding CS, the corresponding REs for each port being on every K-th RE with an offset corresponding to each port based on the configured comb offset (k), the corresponding REs being within an SRS transmission bandwidth; and
receiving, from the UE, SRSs corresponding to the configuration.

13. The network device of claim 12,
wherein the corresponding REs are in an orthogonal frequency division multiplexing (OFDM) symbol, or
wherein the SRS resource is for usage set to ‘codebook’ or ‘antennaSwitching’.

14. The network device of claim 12, wherein, when the comb value K is 2:
the 8 antenna ports are mapped to every K-th RE with a same offset equal to the configured comb offset (k) for all 8 antenna ports, or
a first antenna port, a third antenna port, a fifth antenna port, and a seventh antenna port of the 8 antenna ports are mapped to every K-th RE with the configured comb offset (k), and a second antenna port, a fourth antenna port, a sixth antenna port, and an eighth antenna port of the 8 antenna ports are mapped to every K-th RE with a comb offset (k+1)modulo K.

15. The network device of claim 12, wherein, when the comb value K is 4:
a first antenna port, a third antenna port, a fifth antenna port, and a seventh antenna port of the 8 antenna ports are mapped to every K-th RE with the configured comb offset (k), and a second antenna port, a fourth antenna port, a sixth antenna port, and an eighth antenna port of the 8 antenna ports are mapped to every K-th RE with a comb offset (k+2)modulo K.

16. The network device of claim 12, wherein, when the comb value K is 8:
a first antenna port and a fifth antenna port of the 8 antenna ports are mapped to every K-th RE with the configured comb offset (k), a second antenna port and a sixth antenna port of the 8 antenna ports are mapped to every K-th RE with a first comb offset (k+2)modulo K, a third antenna port and a seventh antenna port of the 8 antenna ports are mapped to every K-th RE with a second comb offset (k+4)modulo K, and a fourth antenna port and an eighth antenna port of the 8 antenna ports are mapped to every K-th RE with a third comb offset (k+6)modulo K.

17. A network device, comprising:
at least one processor; and
a non-transitory computer readable storage medium storing programming, the programming including instructions that, when executed by the at least one processor, cause the network device to perform operations including:
transmitting, to a user equipment (UE), a configuration of a sounding reference signals (SRS) resource with 8 antenna ports and with a time division multiplexing (TDM) parameter, a transmission comb configuration for the SRS resource, and a cyclic shift (CS) configuration for the SRS resource, the transmission comb configuration indicating a comb value K, K being one of 2, 4, or 8, the transmission comb configuration further indicating a comb offset k, k being an integer between 0 and K−1, the CS configuration indicating CS positions, wherein the SRS resource is mapped to a number m of consecutive orthogonal frequency division multiplexing (OFDM) symbols within a same slot, m being greater than or equal to 1,
wherein each OFDM symbol of the consecutive OFDM symbols is mapped to a corresponding subset of the 8 antenna ports based on m and s, where s is determined based on the TDM parameter and is a number of subsets of the 8 antenna ports; and
receiving, from the UE, SRSs corresponding to the configuration.

18. The network device of claim 17, wherein an i-th subset of 8/s antenna ports of the 8 antenna ports is mapped to every s-th OFDM symbol within the consecutive OFDM symbols starting from an i-th OFDM symbol of the consecutive OFDM symbols, where i is from 1 to s.

19. The network device of claim 17, wherein SRS transmissions on the consecutive OFDM symbols are mapped with a same comb offset allocation and same CS positions.

20. The network device of claim 17, wherein SRS transmissions on the consecutive OFDM symbols are mapped with a same physical resource block (PRB) allocation.

21. The network device of claim 17, SRS transmissions on the consecutive OFDM symbols being periodic, semi-persistent, or aperiodic, and the SRS transmissions being based on an SRS counter determined by s*R, wherein R is a configured repetition factor for the SRS resource.

22. The network device of claim 17,
m being a multiple of s, or
m being one of 2, 4, 8, 10, 12, or 14, and s being 2.
